(19) United States
(12) Patent Application Publication
(10) Pub. No.: US 2006/0293926 A1
(43) Pub. Date: Dec. 28, 2006

(54) Method and apparatus for reserve measurement

(76) Inventor: Costandy K Khury, Las Vega, NV (US)

Correspondence Address: KEVIN W. GRIERSON;WILLCOX & SAVAGE, P.C., ONE COMMERCIAL PLACE, SUITE 1800, NORFOLK, VA, 23510, US

(21) Appl. No.: 10/546,235

(22) PCT Filed: Feb. 18, 2004
(86) PCT No.: PCT/US04/04762

§ 371 Date: May 5, 2006

(30) Foreign Application Priority Data
Feb. 18, 2003 (US) 60488058

(51) Int. Cl. G06Q 40/00; G06F 9/44

(52) U.S. Cl. 705/4; 705/35; 705/7

(57) ABSTRACT

The present invention describes a method and apparatus for constructing a historically based frequency distribution of unknown ultimate outcomes in a data set, the method comprising the acts of: (A) collecting relevant data about a series of known cohorts, where a new group of the data emerges at regular time intervals, measuring a characteristic of each group of the data at regular time intervals, and entering each said characteristic into a data set having at least two dimensions; (B) determining a number of frequency intervals N to be used to construct said distribution of unknown ultimate outcomes; (C) for each period I, constructing an aggregate distribution by: (a) calculating period-to-period ratios of the data characteristics; (b) identifying a range of ratio outcomes for cohort I; (c) constructing subintervals for cohort I; and (d) calculating all possible ratio outcomes for cohort I; and (D) constructing a convolution distribution of outcomes for all said possible ratio cohorts combined, by: (a) selecting outcomes for any two cohorts A and B; (b) constructing a new range of outcomes for the convolution distribution of cohorts A and B; (c) constructing new subintervals for the convolution distribution of cohorts A and B; (d) calculating the combined outcomes for the two cohorts A and B to provide a resulting convolution distribution; and (e) combining the resulting convolution distribution with the distributions of outcomes for each remaining cohort by repeating each of the preceding acts D.(a) through D.(d) for each pair of cohorts.

### TECHNICAL FIELD

The invention relates generally to methods for the determination of historically based benchmarks against which estimates of future outcomes may be compared, thus developing a measure of the reasonableness of such estimates. More particularly, the invention develops historically based benchmarks against which estimates of property & casualty insurance loss reserves may be compared, thus developing a measure of the reasonableness of such loss reserve estimates.

### BACKGROUND ART

In the property & casualty insurance (hereinafter “insurance”) industry, maintenance of proper loss and loss expense reserves (hereinafter “loss reserves”) is
(a) Legally required,
(b) A vital element in the determination of the financial condition of an insurance company, and
(c) A major determinant of the current income and associated income statements.

On one hand, over the years, a large variety of methodologies have been developed for the determination of estimates of loss reserves. On the other hand, there has been a virtual vacuum in the area of identification of historical benchmarks against which such loss reserve estimates may be compared, thereby providing a means for the determination of the reasonableness of such loss reserve estimates.

The process of estimating insurance company reserves involves four primary elements: raw data, assumptions, methods of estimation, and judgment of the loss reserve specialist (e.g., an actuary). Thus the various estimates that a loss reserve specialist makes necessarily rely on the judgment of the loss reserve specialist in the selection of assumptions and methods and ultimately in making the final reserve selection. While the application of judgment is an indispensable element in the process of arriving at loss reserve estimates, the manner of assessing the reasonableness of such estimates (via the identification of historically based benchmarks) remains a largely unexplored subject. It would be useful to have objective historically based benchmarks against which loss reserve estimates may be compared.

One direct method for developing such objective historically based benchmarks involves the use of historical ratios generated by comparing consecutive valuations of various cohorts of losses (e.g., losses incurred during a particular year or other time period) as they develop from one time period to another. To identify a historically based benchmark for loss reserve estimates, one can calculate period to period ratios for known consecutive valuations of cohorts of losses and use combinations of such ratios to project outcomes for all the cohorts for which future valuations have yet to emerge. The collection of all such outcomes forms an empirical frequency distribution of all the possible outcomes with all the statistical measures associated with a frequency distribution (such as mean, standard deviation, variance, and mode.) These statistical measures provide useful tools for assessing the reasonableness of loss reserve estimates.

Unfortunately, while this direct method can identify every possible outcome based on the application of historical valuation-to-valuation ratios (i.e., possible “actual” outcomes), in practice the number of possible outcomes becomes unwieldy for even fairly small data sets. For larger data sets (i.e., involving more than ten cohorts), the process of calculating all possible outcomes becomes impractical, because of the dramatic increase in the amount of computing power necessary to calculate all possible outcomes.

An indirect solution exists. Instead of using calculated outcomes, individual outcomes for any one cohort can be slotted as they are calculated for each cohort (such as all losses incurred in a specific time period) into a set of N intervals, with N sufficiently large such that the difference between any calculated outcome and its surrogate (the midpoint of the appropriate interval) is not more than any given degree of tolerance, ε. For our purposes ε is expressed as a percent tolerance. In other words, a calculated outcome is never more than ε% from its surrogate. Once the N intervals are set for each cohort for each line of business, there will be N distinct outcomes for each accident year for each line of business (each outcome being represented by the midpoint of an interval), and each distinct outcome having an associated frequency (The frequency associated with a specific midpoint is equal to the number of times a true calculated possible outcome is slotted in that interval). These individual distributions (one for each cohort, and each consisting of N distinct outcomes, with each distinct outcome having an associated frequency) are then combined to produce yet another distribution that combines all cohorts (accident years) and all lines of business. This convolution distribution is the underlying distribution that is implied by the given data arrays. It may be used to calculate a wide assortment of probabilities for various reserving propositions; and thus enable the development of a substantial measure of the reasonableness of any given loss reserve estimate.

### DISCLOSURE OF INVENTION

### BRIEF DESCRIPTION OF DRAWINGS

The accompanying drawings illustrate a complete exemplary embodiment of the invention according to the best modes so far devised for the practical application of the principles thereof, and in which:

FIG. 1 illustrates an exemplary manner in which a subinterval is constructed so as to observe the error tolerance.

FIG. 2 illustrates an exemplary manner in which the sum of two subintervals, each of which meets the error criterion, also meets the error criterion.

FIG. 3A shows a graph of an exemplary convolution distribution for two sample data sets (shown as Tables A and B).

FIG. 3B shows the graph of an exemplary basic distribution produced for Table A.

FIG. 3C shows the graph of an exemplary basic distribution produced for Table B.

FIG. 4 shows a flow chart for an exemplary process according to the invention.

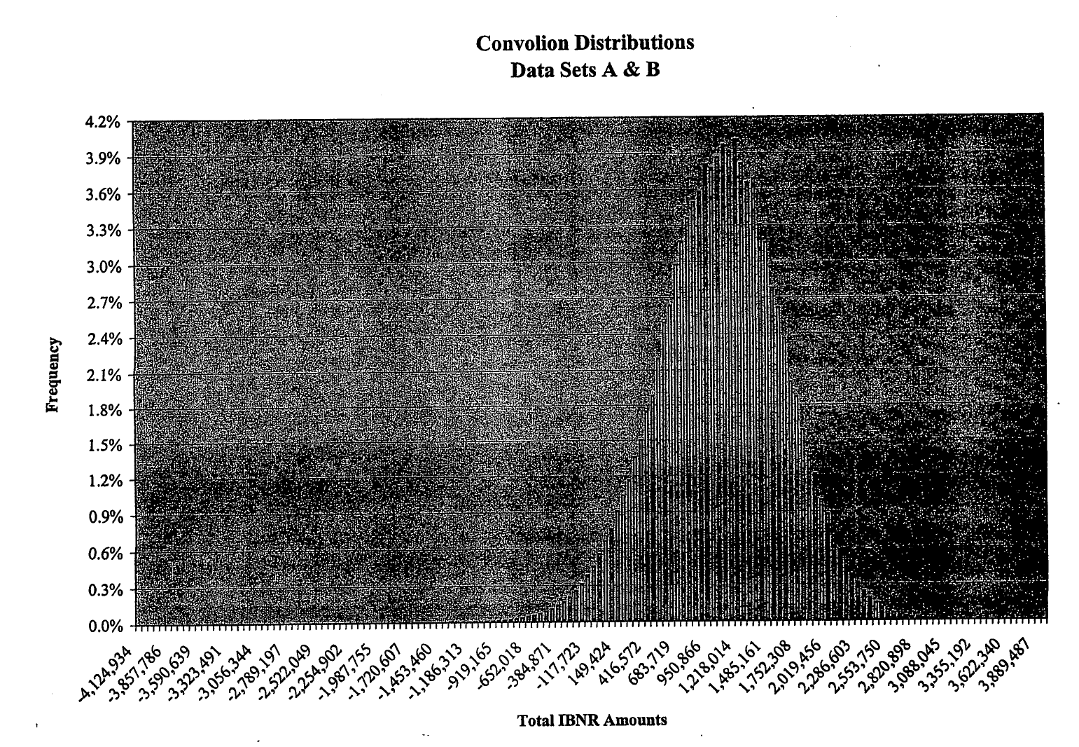

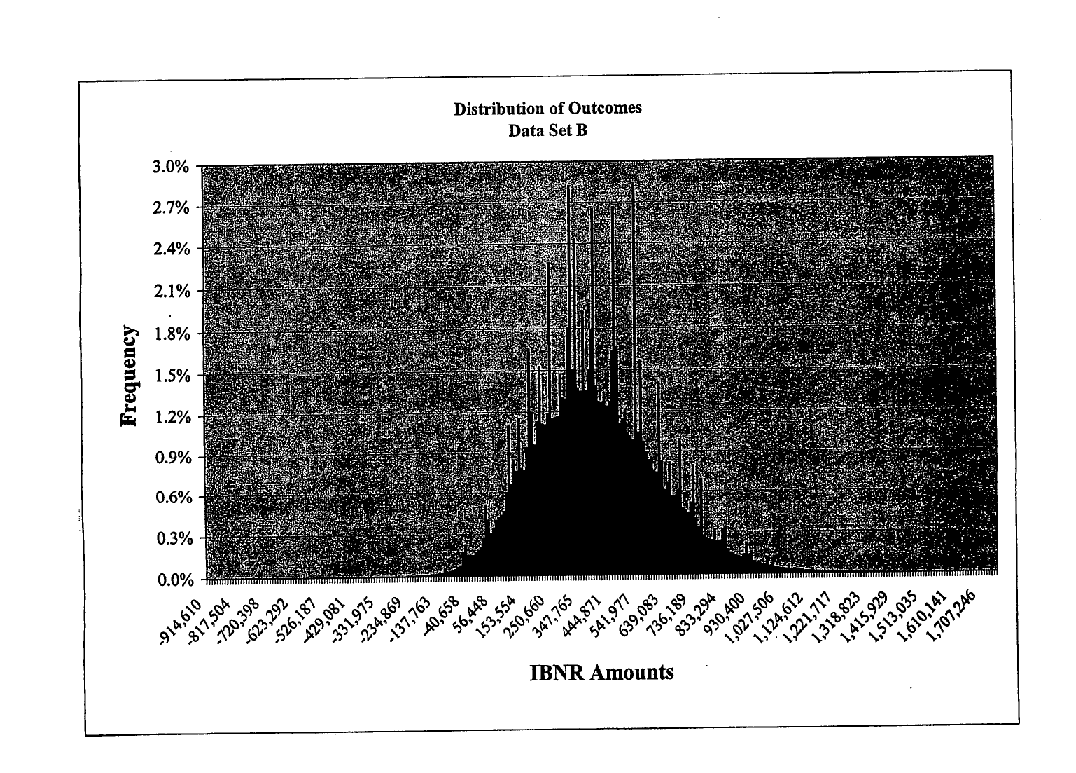

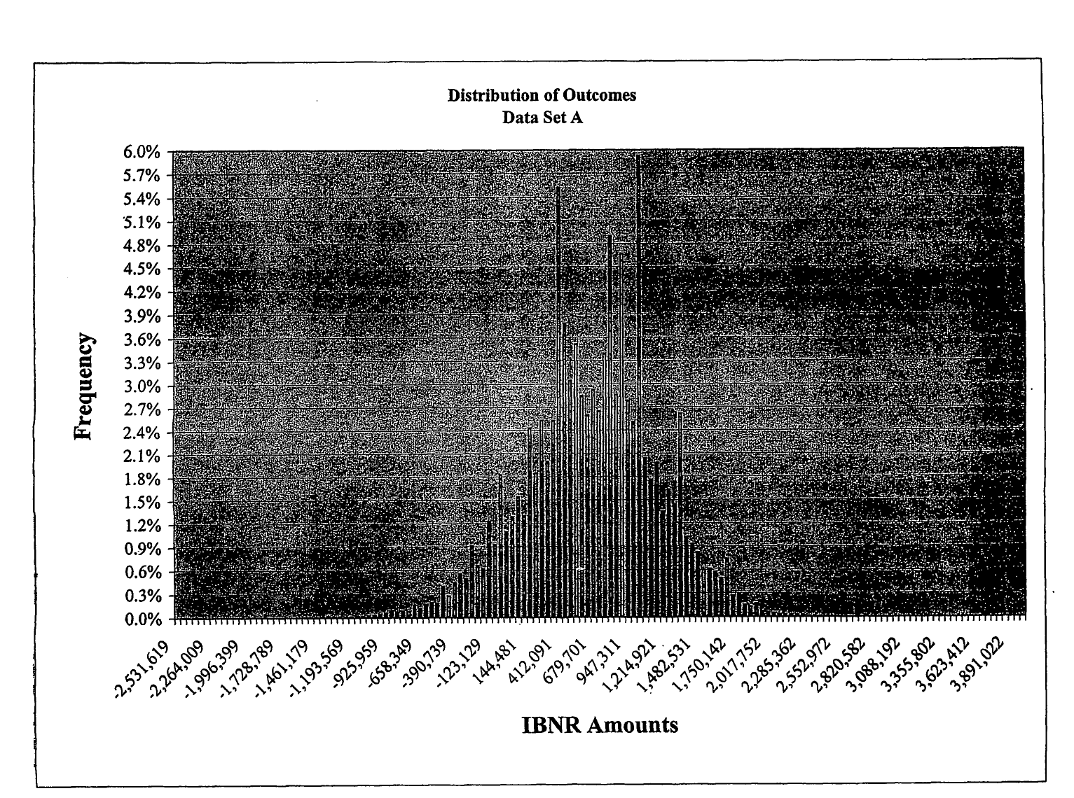

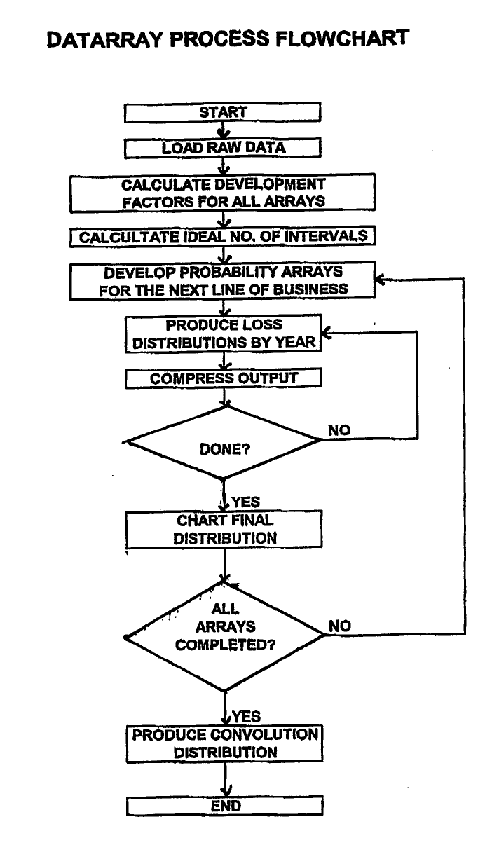

TABLE A. Sample Data Set A.

TABLE B. Sample Data Set B.

TABLE C. Shows tabular distribution of outcomes associated with Table A.

TABLE D. Shows tabular distribution of outcomes associated with Table B.

TABLE E. Shows tabular distribution of outcomes that represent the convolution of distributions shown in Tables C and D.

APPENDIX A. This is the basic program that produces Tables C and D for Data Sets A and B.

APPENDIX B. This is the convolution program that takes Tables C and D and combines them into Table E and Drawing 3A.

### BEST MODE(S) FOR CARRYING OUT THE INVENTION

In a preferred embodiment, a process for calculating distribution outcomes is provided. This process can be implemented, for example, by a computer program, by electronic hardware specifically designed to execute the process or software implementing the process, by a microprocessor storing firmware instructions designed to cause computer hardware to carry out the process, or by any other combination or hybrid of hardware and software. The process can also be embodied in a computer readable medium that can be executed by computer hardware or software to implement the disclosed process.

### Assumptions

A. It is assumed that data will be provided for a number of lines of business K. Thus K=1, 2, 3, . . . , k, . . . , K−2,K−1,K.

B. It is assumed that each line of business has a historical database for I accident years. Thus I=1, 2, 3, . . . i, . . . , I−2, I−1, I. The most mature (oldest) year is designated year 1.

C. It is assumed that each accident year is developed through J periods of development. Thus J=1, 2, 3, . . . , j, . . . , J−2, J−1, J.

D. It is assumed that I≧J (i.e. that no accident year develops longer than the total number of years in the historical database). This assumption allows one to cut off the loss development after a number of years have passed, as is done in Schedule P filed by insurance companies with the state regulatory authorities. (Schedule P is a series of exhibits required to be included in the Statutory Financial Statements of insurance companies in which, for each line of business and for all lines combined, each accident year is valued at annual intervals for a maximum of ten years of development. In other words, the tracking of valuation of individual accident years is abandoned after ten years on the premise that the vast majority of loss values have emerged by that time.)

### Calculation of N

First, the user determines the number of intervals N needed such that each calculated outcome is no more than a given percent tolerance ε from its slotted value at the midpoint of an interval.

1. The degree of tolerance, ε, is determined by the user.

2. The user also makes use of the ultimate valuation for accident years 1 through J as of the end of J years of development. Such valuations after J years have passed are routinely provided by insurance companies, on an annual basis, to the regulatory authorities. In other words, the process makes use of the historical factors utilized by the insurance company for the purpose of making an ultimate estimate for a cohort of claims after the required ten years of tracking has expired.

3. Each valuation point is designated by given V_{i,j,k}, where i is the accident year, j is the year of development, and k is the line of business. Thus V_{2,3,6} represents the value associated with accident year No. 2, at the end of development period No. 3, for line of business No. 6.

4. Finally, a loss development factor is defined as the ratio of the valuation at time j+1 to the value at time j, or L_{i,j,k}=V_{i,j+1,k}/V_{i,j,k}.

Thus, the data needed to drive the process would appear in an array similar to the following (this example shows only line of business No. 1—and other arrays would be provided for the remaining lines of business):

| AY | 1 | 2 | 3 | . . . | j | . . . | J − 2 | J − 1 | J | ∞ |
|---|---|---|---|---|---|---|---|---|---|---|
| 1 | V_{1,1,1} | V_{1,2,1} | V_{1,3,1} | . . . | V_{1,j,1} | . . . | V_{1,J-2,1} | V_{1,J-1,1} | V_{1,J,1} | V_{1,∞,1} |
| 2 | V_{2,1,1} | V_{2,2,1} | V_{2,3,1} | . . . | V_{2,j,1} | . . . | V_{2,J-2,1} | V_{2,J-1,1} | V_{2,J,1} | V_{2,∞,1} |
| 3 | V_{3,1,1} | V_{3,2,1} | V_{3,3,1} | . . . | V_{3,j,1} | . . . | V_{3,J-2,1} | V_{3,J-1,1} | V_{3,J,1} | V_{3,∞,1} |
| . . . | . . . | . . . | . . . | . . . | . . . | . . . | . . . | . . . | . . . | . . . |
| i | V_{i,1,1} | V_{i,2,1} | V_{i,3,1} | . . . | V_{i,j,1} | . . . | V_{i,J-2,1} | V_{i,J-1,1} | V_{i,J,1} | V_{i,∞,1} |
| . . . | . . . | . . . | . . . | . . . | . . . | . . . | . . . | . . . | . . . | . . . |
| J | V_{J,1,1} | V_{J,2,1} | V_{J,3,1} | . . . | V_{J,j,1} | . . . | V_{J,J-2,1} | V_{J,J-1,1} | V_{J,J,1} | V_{J,∞,1} |
| . . . | . . . | . . . | . . . | | | | | | | |
| I − 2 | V_{I-2,1,1} | V_{I-2,2,1} | V_{I-2,3,1} | | | | | | | |
| I − 1 | V_{I-1,1,1} | V_{I-1,2,1} | | | | | | | | |
| I | V_{I,1,1} | | | | | | | | | |

A. Constructing N for accident year I for line of business No. 1, or constructing N_{I,1}.

Constructing the maximum and minimum loss development factors for each development period. For each development period, all loss development factors are identified, and then the maximum (Max) and minimum (Min) loss factors are identified for each such set. For example, for year i, the set of loss development factors through two years of development consists of all Loss Development Factors of the form L_{i,1,1}, or {L_{1,1,1}; L_{2,1,1}; . . . ; L_{i,1,1}; . . . ; L_{I-2,1,1}; L_{I-1,1,1}}. The Max and Min of this set is denoted by: Max {L_{i,1,1}} and Min {L_{i,1,1}}, both taken over the index i, respectively; i=1, 2, 3, . . . , I−1. This process is repeated for each development period. This results in a set of maximums and minimums of the form Max {L_{i,j,1}} and Min {L_{i,j,1}}, with each development period yielding a max and a min loss development factor.

Constructing the maximum and minimum values for the cumulative loss development factors. Having identified the maximum and minimum loss development factor for each development period, now the max and min cumulative loss development factors for accident year I are constructed by multiplying together all the max and all the min loss development factors. For example:

Max cumulative loss development factor=II (Max {L_{i,j,1}}), with the “Max function” ranging over i and the “II function” ranging over j.

Min cumulative loss development factor=II (Min {L_{i,j,1}}), with the “Min function” ranging over i and the “II function” ranging over j.

Thus, the difference between the maximum and minimum values of all outcomes for all products of loss development factors for year I is given by the quantity:
[II (Max {L_{i,j,1}})−II (Min {L_{i,j,1}})].

Any specific ultimate outcome for year I must fall somewhere along the closed interval defined by:
[II (Min {L_{i,j,1}}), II (Max {L_{i,j,1}})].

Constructing the subintervals. The goal is to determine the number N_{I,1}, a number of subintervals for year I, such that (a) if the interval containing the full range of outcomes is divided into these subintervals, and (b) any calculated value that falls in that subinterval is replaced with the midpoint of that subinterval, then (c) the true (computed) value cannot be more that ε away from the midpoint of that subinterval.

The target number is denoted by N_{I,1}. The interval
[II (Min {L_{i,j,1}}), II (Max {L_{i,j,1}})]
is divided into (N_{I,1}−1) equal subintervals. The width of any one of the new subintervals is given by:
[II (Max {L_{i,j,1}})−II (Min {L_{i,j,1}})]/(N_{I,1}−1)
and the radius of each subinterval is defined as one-half that number, or:
[II (Max {L_{i,j,1}})−II (Min {L_{imj,1}})]/2(N_{I,1}−1).

In practice, the subinterval can be open or closed on either end, to suit the particular application. For convenience, the subinterval defined here is an open/closed subinterval, with the leftmost point being excluded from the subinterval and the rightmost point being included in the subinterval. The leftmost point of the fall range [that is, II (Min {L_{i,j,1}})] is designated as the midpoint of the first subinterval. Then the full leftmost subinterval is given by:
[II (Min {L_{i,j,1}})−[(II (Max {L_{i,j,1}})−II (Min {L_{i,j,1}})]/2(N_{I,1}−1)], II (Min {L_{i,j,1}})+[[II (Max {L_{i,j,1}})−II (Min {L_{i,j,1}})]/2(N_{I,1}−1) ]].

The rightmost subinterval is similarly defined and is given by:
[II (Max {L_{i,j,1}})−[[II (Max {L_{i,j,1}})−II (Min {L_{i,j,1}})]/2(N_{I,1}−1)], II (Max {L_{i,j,1}})+[[II (Max {L_{i,j,1}})−II (Min {L_{i,j,1}})]/2(N_{I,1}−1)]].

This particular construction restores the odd subinterval that was subtracted from N_{I,1} to arrive at the width of a subinterval.

Meeting the tolerance criterion, solving for N_{I,1}. The number of subintervals, N_{I,1}, that will assure tolerance criterion ε is met are now calculated.

Once a true value has been placed in its appropriate subinterval, it cannot be more than the radius of the subinterval away from its proposed surrogate (the midpoint of that subinterval). Thus the maximum error is the radius of the subinterval constructed above:
[II(Max {L_{i,j,1}})−II(Min {L_{i,j,1}})]/2(N_{I,1}−1).

Thus the true error (the distance from the true value to the midpoint of the associated subinterval) is always less than or equal to the maximum error (the radius of the subinterval as given above. So instead of dealing with the true error, a more stringent requirement is imposed, that the ratio of the radius of the subinterval to the midpoint of the subinterval be less than ε. In other words:
{[II(Max {L_{i,j,1}})−II(Min {L_{i,j,1}})]/2(N_{I,1}−1)}/Midpoint of subinterval<ε.

Now note that:
{[II (Max {L_{i,j,1}})−II (Min {L_{i,j,1}})]/2(N_{I,1}−1)}/Midpoint of subinterval≦{[II (Max {L_{i,j,1}})−II (Min {L_{i,j,1}})]/2(N_{I,1}−1)}/II(Min{L_{i,j,1}})
since the “midpoint of the subinterval” is at least equal to or greater than II (Min {L_{i,j,1}}).

Thus the tolerance condition is met if N_{I,1} is selected such that:
{[II (Max {L_{i,j,1}})−II (Min {L_{i,j,1}})]/2(N_{I,1}−1)}/II(Min {L_{i,j,1}})<ε.

Solving for N_{I,1} one obtains:
N_{i,1}>1+(½ε)[II (Max {L_{i,j,1}})−II (Min {L_{i,j,1}})]/II (Min {L_{i,j,1}}).

The value N_{I,1} is therefore sufficient so that when each true, computed value is replaced with the midpoint of the appropriate subinterval, the true value is never more than ε away from its surrogate, the midpoint of the subinterval.

B. Constructing N for line of business 1, or N_{I}.

Having constructed N_{I,1}, the process is repeated as often as necessary to construct a corresponding N value for each accident year to be projected to ultimate, thus yielding an entire set of N values for line of business No. 1:
N_{I,1}; N_{I-1}; N_{I-2,1}; N_{I-3,1}; . . . ; N_{J+2,1}; N_{J+1}.

For each of these N values, the true value is never more than ε away from the midpoint of the corresponding subinterval for each accident year, from accident year J+1 to accident year I. The maximum of all these N_{i,1} values is selected to ensure that this condition (of the error being less than ε) is met for every single accident year individually. Thus, instead of a set of N_{i,1} values, Max {N_{i,1}} is used, with i ranging from J+1 to I. This value is designated N₁, meaning the N value associated with line of business No. 1.

C. Constructing N for all lines of business.

Once N₁, N₂, N₃, . . . , N_{K}, have been constructed, the maximum of these N values, Max {Nᵢ, i=1,2,3, . . . , k, . . . , K}, is selected, so that maximum N is sufficient to satisfy the ε criterion for every single line of business.

Although this exemplary embodiment employs the above method for the calculation of N, N may also be a number chosen arbitrarily by the user, or may be based upon other considerations, such as, for example, the maximum number of intervals that could be calculated within a given amount of time by the computer used by the user to execute the program, or some given number that is high enough that ε is sufficiently low for the user's purposes regardless of the particular characteristics of the dataset to be evaluated (for example, if the N that provides a given error level ε is virtually always between 500 and 600, a user could select N=1000 rather than calculate N for each dataset). In the event that N is determined to meet some other criteria, it is still necessary to provide the historical loss data for each accident year for each line of business. Note also that when N is determined by other criteria, there is no assurance that the error tolerance ε is met. The process described below requires that the original data array has been provided regardless of whether or not it is used to determine N.

### Construction of the Convolution Distribution

Once N is determined, and N and the valuations described above have been provided, for example, entered as a value in a computer program, the process proceeds as follows:

A. Constructing the aggregate loss distribution for one year, and for this illustration accident year I.

The process consists of the following actions:

1. Identifying the range of outcomes for accident year I. Using the Max/Min functions described above, the Max/Min cumulative loss development factors are calculated, and those are multiplied by the latest valuation available for the accident year I. Thus the Max/Min ultimate values for accident year I are determined.

2. Constructing the subintervals for accident year I. Given the Max/Min ultimate values for accident year I, the N subintervals described above are identified.

3. Calculating all the different outcomes for accident year I. As discussed above, the product of each combination of loss development factors and the latest valuation for accident year I is calculated. As each outcome is calculated, the interval in which it belongs is determined and the outcome is replaced with the midpoint of that interval, and the frequency of outcomes appearing in that interval is increased by 1. The process continues until all combinations are calculated and all possible outcomes have been determined for accident year I. All results are slotted and their frequency is calculated.

This process creates an aggregate loss (frequency) distribution for accident year I.

B. Constructing the aggregate loss distribution for each of the remaining accident years.

The process described in Section A above for accident year I is then repeated for each of the remaining accident years. This results in a set of individual aggregate loss distributions, one for each accident year, and each consisting of N intervals, with each interval having an associated frequency.

C. Creating the convolution distribution for all accident years combined within one line of business.

This process consists of the following actions:

1. Selecting two accident years from the set of all open accident years. Select any two accident years, preferably starting with the two most mature years.

2. Creating the new range of outcomes for the convolution distribution of the two accident years. This task is accomplished by calculating (a) the sum of the two greatest midpoints of the two component distributions and (b) the sum of the two smallest midpoints of the component distributions. These calculations result in a new Max/Min for the two accident years combined.

3. Creating the new subintervals for the convolution distribution of the two selected accident years. Once again, divide the new interval into N subintervals as described above.

4. Calculating the combined outcomes for the two accident years. Every outcome from the first component distribution is then added to every outcome of the second component distribution, and the results are slotted in the new N subintervals constructed in the prior step. The frequencies for each two subintervals thus added are multiplied and tagged as belonging with the combined subinterval. This process yields the first convolution distribution—the one belonging to the two selected accident years.

5. Creating the ultimate convolution distribution for all accident years for a line of business. Actions 1-4 are then repeated; combining the first convolution distribution derived in step 4 immediately above with the distribution of outcomes of another accident year. This process yields a second convolution distribution representing the combined distribution for the three selected accident years. The process is repeated until all accident year outcomes have been combined.

The result is a single aggregate (convolution) loss distribution for a line of business.

D. Creating the convolution distribution for all lines of business combined.

This process consists of Steps 1-5 as described in the immediately preceding section except that the component distributions are those belonging to lines of business. The end result is an aggregate (convolution) loss distribution for all lines of business combined, for the given insurance company.

The above described method may be implemented by instructions stored on a “computer readable medium.” The term “computer readable medium” as described herein refers to any medium that participates in providing instructions to a computer processor for execution. Such a medium may take many forms, including, but not limited to, non-volatile media, volatile media, and transmission media Non-volatile media include, for example, optical or magnetic disks. Volatile media include dynamic memory, such as the random access memory (RAM) found in personal computers. Transmission media may include coaxial cables, copper wire, and fiber optics. Transmission media may also take the form of acoustic or light (electromagnetic) waves, such as those generated during radio frequency (RF) and infrared (IR) data communications. Common forms of computer readable media include, for example, a floppy disk, a hard disk, magnetic tape, CD-ROM, DVD-ROM, punch cards, paper tape, any other physical medium with patters of holes, RAM, PROM, EPROM, FLASHEPROM, other memory chips or cartridges, a carrier wave, or any other medium from which a computer can read instructions.

The present invention has been described in sufficient detail to teach its practice by one of ordinary skill in the art. However, the above description and drawings of exemplary embodiments are only illustrative of preferred embodiments that achieve the objects, features and advantages of the present invention, and it is not intended that the present invention be limited thereto. Any modification of the present invention that comes within the spirit and scope of the following claims is considered part of the present invention.

### INDUSTRIAL APPLICABILITY

The present invention has utility, for example, in the property and casualty insurance industry, to assist in satisfying legal requirements in the field, and to efficiently determine estmates of loss reserves necessary to conduct business.

### ANNEX 1

### Demonstration of Validity of N as Calculated

A. Demonstrating that the ε condition remains satisfied when the cumulative loss development factors are applied to a base number (the given, and latest, value).

All work thus far has been performed for just the cumulative loss development factors. In reality, when one projects ultimate values, one takes the cumulative loss development factor and multiplies it by the latest reported value. When all the calculations carried out above are carried out with this last step included (i.e., multiplying the latest value by the cumulative loss development factor), it will be readily seen that the latest reported amount simply cancels out at all points of the calculation. For example, if we take the final formula for N_{I,1} developed above, we have:
N_{I,1}>1+(½ε)[II (Max {L_{i,j,1}})−II (Min {L_{i,j,1}})]/II(Min {L_{i,j,1}}).

And if each cumulative loss development factor is multiplied by the relevant latest reported value, V_{I,1,1}, we would have:
N_{I,1}>1+(½ε) [(V_{I,1,1}) II (Max {L_{i,j,1}})−(V_{I,1,1}) II (Min {L_{i,j,1}})]/(V_{I,1,1}) II(Min {L_{i,j,1}}).

And V_{I,1,1} cancels out from all parts of the major fraction. And the same is true for all other accident years.

B. Demonstrating that the ε condition remains satisfied when accidentyears are combined (i.e., added) in order to arrive at the aggregate loss distribution for all accident years combined, all within line of business No.1.

Observation. Given two sets of intervals, each set consisting of n subintervals of identical width, one set spanning the interval (a−Δ₁, a+(2n−1)Δ₁), where Δ₁ is the radius of a subinterval, that has the midpoints of the component intervals placed at a+2iΔ₁, with i ranging from 0 to n−1, and the other set spanning (b−Δ₂, b+2n−1)Δ₂), where Δ₂ is the radius of a subinterval, that has the midpoints of the respective intervals placed atb+2iΔ₂, with i ranging from 0 to n−1, one can then construct a new set of subintervals consisting of the “sum” of the two original sets of intervals, spanning ((a+b)−(Δ₁+Δ₂), (a+b)+(2n−1)(Δ₁+Δ₂)), each having a with of (Δ₁+Δ₂).

The midpoints of the new set of subintervals would be located at (a+b),(a+b)+2(Δ₁+Δ₂), (a+b)+4(Δ₁+Δ₂), . . . , (a+b)+2(n−1)(Δ₁+Δ₂). And thus the radius of the new subintervals (i.e., Δ₁+Δ₂) would be equal to the sum of the radii of the two component subintervals.

With this background, let us now consider two sets of subintervals, with each set consisting of n subintervals, with the subintervals having radii of Δ₁ and Δ₂, for the two sets, respectively, with the midpoints of the respective sets of subintervals given as follows:
Set A: a, a+2Δ₁, a+4Δ₁, a+6Δ₁, a+8Δ₁, a+10Δ₁, . . . , a+2(n−1)Δ₁
Set B: b, b+2Δ₂, b+4Δ₂, b+6Δ₂, b+8Δ₂, b+10Δ₂, . . . , b+2(n−1)Δ₂

Let us now assume that Set A is the set of subintervals produced for Cohort A, consisting of a group of losses (e.g., the losses incurred during a specific accident year) and that Set B is the set of subintervals produced for Cohort B, consisting of another group of losses (e.g., the losses incurred during another specific accident year) By our construction thus far, we know that any true calculated value of ultimate outcomes produced for Cohort A has been replaced by one of the midpoints associated with Set A. We constructed these subintervals such that the error generated by substituting a true calculated value with a midpoint of a subinterval is not greater than ε. Put yet differently, the difference between any true calculated value Vₐ and the nearest midpoint of the subintervals in Set A is not more than Δ₁. Therefore, the ratio of Δ₁ to the leftmost point of all the subintervals in Set A, that is (a−Δ₁), is less than ε. In formula form this is given by:
Δ₁/(a−Δ₁)<ε

Similarly, for Set B, we can reach the conclusion that a true calculated value V_{b} meets the following parallel construction noted above for Set A.:
Δ₂/(b−Δ₂)<ε

Given that if one had infinite computing power, one would never resort to substituting midpoints of subintervals for true calculated values, it is appropriate at this point to inquire about the amount of error that one generates by adding two surrogates (midpoints) for Vₐ and V_{b}, when both Vₐ and V_{b} individually meet the error tolerance criterion ε. Thus the question becomes: what can be said about
(Δ₁+Δ₂)/[(a−Δ₁)+(b−Δ₂)]
in relation to the original error tolerance ε?

The tolerance condition Δ₁/(a−Δ₁)<ε implies that Δ₁<(a−Δ₁)ε.

Similarly, the tolerance condition Δ₂/(b−Δ₂)<ε implies that Δ₂<(b−Δ₂)ε. Adding the two inequalities yields:
(Δ₁+Δ₂)<[(a−Δ₁)ε]+[(b−Δ₂)ε]
or:
(Δ₁+Δ₂)<[(a−Δ₁)+[(b−Δ₂)]ε

Dividing both sides of the inequality by [(a−Δ₁)+(b−Δ₂)] yields:
(Δ₁+Δ₂)/[(a−Δ₁)+(b−Δ₂)]<ε

Thus when adding one accident year's approximation to another's, when each approximation meets the ε condition, it is demonstrated that the sum of the two approximations also meets the ε condition. And, this kind of demonstration can continue to be extended, one cohort at a time, until all the cohorts in a data array have been accounted for.

C. Demonstrating that the ε condition remains satisfied when aggregate distributions for two lines of business are added together.

Using the identical logic as that used above in Section B, it is possible to demonstrate that when two distributions of outcomes, each of which meeting the ε criterion, will continue to meet the ε criterion when the convolution distribution is constructed by adding the respective outcomes from each of the two distributions.

### DRAWING NO. 1

### Illustration of the manner in which a Subinterval is Constructed such that the Error Tolerance is Met

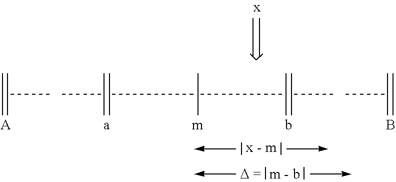

The line segment (a,b) represents a typical subinterval, having a midpoint at M (=½(a+b)), such that a calculated point, such as x, may be slotted in this subinterval, and x is ultimately replaced by m.

The interval (A,B) is the segment bounded by A, the smallest midpoint of all subintervals, and B, the largest midpoint of all subintervals. Thus the midpoints of all subintervals are evenly spaced within this larger interval.

The point corresponding to x designates a typical calculated outcome. In this illustration it is selected to between the midpoint M and the endpoint b.

The true error that is generated by replacing x with m is given by the amount |x−m|.

The maximum error that is possible is denoted by Δ=|m−b|.

Requiring that the replacement of x by m does not generate an error greater than ε means requiring that the error is less than the ratio of |x−m|/m.

In the construction advanced by this invention we assure this condition is met by going through the following transformation:
ε=|x−m|/m≦|m−b|/m≦|m−b|/A (1)

Thus dividing (A,B) into sufficiently large number of subintervals such that the condition in (1) is met assures that the subinterval construction preserves the accuracy requirement.

### DRAWING NO. 2

### Illustration of the manner in which the sum of two Intervals, each of which meets the Error Criterion, also meets the Error Criterion

Given a subinterval from the set of subintervals produced for Cohort I such that the subinterval construction meets the error criterion ε:

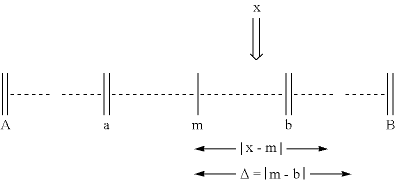

And given a subinterval from the set of subintervals produced for Cohort II such that the subinterval construction meets the error criterion ε:

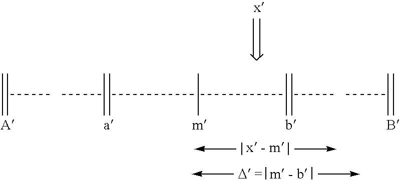

Then the construction of the combination of these two subinterval into a new subinterval (thus forming a convolution subinterval) yields the following:

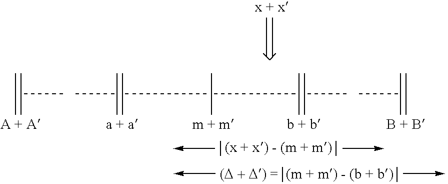

The error that would be generated if x+x′ was replaced with m+m′ is given by:
|(x+x′)−(m+m′)|

And we wish for this amount to be less than the specified tolerance ε.

Thus we construct the following sequence of successively more stringent constraints:
|(x+x′)−(m+m′)≦|(b+b′)−(m+m′)|/(m+m′)≦|(b+b′)−(m+m′)|/(a+a′)| (2)

We already have, by construction, the conditions that
|b−m|/a<ε|and |b′−m′|/a′<ε.

Or, equivalently,
|b−m|<aε|and |b′−m′|<a′ε.

Adding both sides of the inequalities yields:
|b−m|+|b′−m′|<aε+a′ε=(a+a′)ε.

Dividing both sides by (a+a′) yields the desired condition as shown in (2) above.

SAMPLE DATASET A
Calculation of N for Set A

| | |
|---|---|
| Given: Error tolerance not more than 1/10 of 1% | Calculate N so that the 1/10 at 1% condition is met |

| | Raw Data Valued After Indicated Number of Years | | | | | | | | | | |
|---|---|---|---|---|---|---|---|---|---|---|---|
| Year | 1 | 2 | 3 | 4 | 5 | 6 | 7 | 8 | 9 | 10 | Ultimate |
| 1988 | 1985974 | 2287598 | 2354278 | 2371587 | 2357456 | 2355474 | 2350474 | 2348454 | 2348442 | 2348442 | 2348442 |
| 1989 | 2049857 | 2384957 | 2484954 | 2501458 | 2501047 | 2564584 | 2560028 | 2554898 | 2554861 | 2554861 | 2554544 |
| 1990 | 2154154 | 2557450 | 2615487 | 2340582 | 2340005 | 2348591 | 2345888 | 2344482 | 2344824 | 2344824 | 2344824 |
| 1991 | 2356475 | 2758745 | 2805745 | 2826475 | 2846587 | 2849856 | 2848858 | 2848954 | 2847861 | 2854675 | 2847861 |
| 1992 | 2,495,542 | 2,831,272 | 2,867,221 | 2,891,206 | 2,967,773 | 2,973,418 | 2,911,341 | 2,858,341 | 2,858,341 | 2,858,341 | 2,858,341 |
| 1993 | 2,872,429 | 3,518,051 | 3,609,053 | 3,602,762 | 3,553,539 | 3,541,706 | 3,469,945 | 3,477,817 | 3,477,817 | | |
| 1994 | 3,428,730 | 4,078,597 | 4,446,098 | 4,445,673 | 4,448,621 | 4,384,024 | 4,367,977 | 4,376,253 | | | |
| 1995 | 2,839,386 | 3,680,283 | 3,781,846 | 3,691,879 | 3,671,901 | 3,620,821 | 3,605,404 | | | | |
| 1996 | 2,685,892 | 3,380,806 | 3,289,680 | 3,219,952 | 3,196,238 | 3,211,821 | | | | | |
| 1997 | 3,039,815 | 3,425,947 | 3,293,515 | 3,298,908 | 3,271,413 | | | | | | |
| 1998 | 3,132,568 | 3,760,691 | 3,771,564 | 3,810,472 | | | | | | | |
| 1999 | 4,402,008 | 5,574,428 | 5,853,402 | | | | | | | | |
| 2000 | 4,795,261 | 5,613,134 | | | | | | | | | |
| 2001 | 4,498,797 | | | | | | | | | | |

| Year | 1-2 | 2-3 | 3-4 | 4-5 | 5-6 | 6-7 | 7-8 | 8-9 | 9-10 | 10-Ult. |
|---|---|---|---|---|---|---|---|---|---|---|
| | Period-to-period Link Ratios | | | | | | | | | |
| 1988 | 1.151877 | 1.029148 | 1.007352 | 0.994042 | 0.999159 | 0.997877 | 0.999141 | 0.99999 | 1.00000 | 1.00000 |
| 1989 | 1.163475 | 1.041928 | 1.006642 | 0.999836 | 1.025404 | 0.998223 | 0.997996 | 0.99999 | 1.00000 | 0.99988 |
| 1990 | 1.187218 | 1.022693 | 0.894893 | 0.999753 | 1.003669 | 0.998849 | 0.999401 | 1.00015 | 1.00000 | 1.00000 |
| 1991 | 1.170708 | 1.017037 | 1.007388 | 1.007116 | 1.001148 | 0.999650 | 1.000034 | 0.99962 | 1.00239 | 0.99761 |
| 1992 | 1.134532 | 1.012697 | 1.008365 | 1.026483 | 1.001902 | 0.979123 | 0.981795 | 1.00000 | 1.00000 | |
| 1993 | 1.224765 | 1.025867 | 0.998257 | 0.986337 | 0.996670 | 0.979738 | 1.002269 | 1.00000 | | |
| 1994 | 1.189536 | 1.090105 | 0.999904 | 1.000663 | 0.985479 | 0.996340 | 1.001895 | | | |
| 1995 | 1.296155 | 1.027597 | 0.976211 | 0.994589 | 0.986089 | 0.995742 | | | | |
| 1996 | 1.258727 | 0.973046 | 0.978804 | 0.992635 | 1.004875 | | | | | |
| 1997 | 1.127025 | 0.961344 | 1.001637 | 0.991665 | | | | | | |
| 1998 | 1.200514 | 1.002891 | 1.010316 | | | | | | | |
| 1999 | 1.266338 | 1.050045 | | | | | | | | |
| 2000 | 1.170559 | | | | | | | | | |
| | Max/Min Link Ratios | | | | | | | | | |
| Max | 1.296155 | 1.090105 | 1.010316 | 1.026483 | 1.025404 | 0.999650 | 1.002269 | 1.000146 | 1.002393 | 1.000000 |
| Min | 1.127025 | 0.961344 | 0.894893 | 0.986337 | 0.985479 | 0.979123 | 0.981795 | 0.999616 | 1.000000 | 0.997613 |
| | Cumulative Products at Max/Min Link Ratios | | | | | | | | | |
| Max | 1.5092538 | 1.1644089 | 1.0681623 | 1.0572555 | 1.0299789 | 1.0044614 | 1.0048133 | 1.0025389 | 1.0023927 | 1.000000 |
| Min | 0.903463 | 0.8016354 | 0.8338691 | 0.9318083 | 0.9447155 | 0.9586356 | 0.9790761 | 0.9972303 | 0.997613 | 0.997613 |

| | |
|---|---|
| N > 1 + 1/(2 × 0.001) × [(1.50925) − (0.90346)]/(0.90346) = 336.261 | Use N = 337 or greater. |

SAMPLE DATASET B
Calculation of N for Set B

| Given: Error toelrance ofnot | | | | | | | Calcualte N so that the 1/10 of | | | | |
|---|---|---|---|---|---|---|---|---|---|---|---|
| more than 1/10 of 1% | | | | | | | 1% condition is met | | | | |
| | Raw Data Valued After Indicated Number of Years | | | | | | | | | | |
| Year | 1 | 2 | 3 | 4 | 5 | 6 | 7 | 8 | 9 | 10 | Ultimate |
| 1988 | 325641 | 388932 | 380245 | 375214 | 385467 | 377826 | 377826 | 377024 | 380458 | 381748 | 381748 |
| 1989 | 294758 | 355458 | 360452 | 380245 | 390245 | 401587 | 401587 | 401587 | 401587 | 401587 | 401587 |
| 1990 | 350245 | 435142 | 429587 | 461523 | 462536 | 465826 | 475826 | 475826 | 485745 | 485745 | 485745 |
| 1991 | 359848 | 429788 | 409548 | 440526 | 440526 | 440526 | 444856 | 444856 | 444856 | 444900 | 444856 |
| 1992 | 604287 | 660562 | 722626 | 810537 | 810537 | 845218 | 975537 | 960537 | 948037 | 948037 | 948037 |
| 1993 | 282176 | 288093 | 314016 | 307709 | 307709 | 307709 | 301209 | 301209 | 301209 | | |
| 1994 | 414267 | 502671 | 575367 | 618027 | 634806 | 606766 | 597266 | 587266 | | | |
| 1995 | 347207 | 345260 | 389196 | 389574 | 370421 | 367421 | 367421 | | | | |
| 1996 | 407584 | 425858 | 498245 | 572172 | 643572 | 643572 | | | | | |
| 1997 | 298564 | 356895 | 349158 | 345658 | 330958 | | | | | | |
| 1998 | 674607 | 697101 | 705185 | 690264 | | | | | | | |
| 1999 | 342252 | 414275 | 442215 | | | | | | | | |
| 2000 | 1149836 | 1277286 | | | | | | | | | |
| 2001 | 596578 | | | | | | | | | | |

| Year | 1-2 | 2-3 | 3-4 | 4-5 | 5-6 | 6-7 | 7-8 | 8-9 | 9-10 | 10-Ult |
|---|---|---|---|---|---|---|---|---|---|---|
| | Period-to-period Link Ratios | | | | | | | | | |
| 1988 | 1.19436 | 0.97766 | 0.98677 | 1.02733 | 0.98018 | 1.00000 | 0.99788 | 1.00911 | 1.00339 | 1.00000 |
| 1989 | 1.20593 | 1.01405 | 1.05491 | 1.02630 | 1.02906 | 1.00000 | 1.00000 | 1.00000 | 1.00000 | 1.00000 |
| 1990 | 1.24239 | 0.98723 | 1.07434 | 1.00219 | 1.00711 | 1.02147 | 1.00000 | 1.02085 | 1.00000 | 1.00000 |
| 1991 | 1.19436 | 0.95291 | 1.07564 | 1.00000 | 1.00000 | 1.00983 | 1.00000 | 1.00000 | 1.00010 | 0.99990 |
| 1992 | 1.09313 | 1.09396 | 1.12165 | 1.00000 | 1.04279 | 1.15418 | 0.98462 | 0.98699 | 1.00000 | |
| 1993 | 1.02097 | 1.08998 | 0.97992 | 1.00000 | 1.00000 | 0.97888 | 1.00000 | 1.00000 | | |
| 1994 | 1.21340 | 1.14462 | 1.07414 | 1.02715 | 0.95583 | 0.98434 | 0.98326 | | | |
| 1995 | 0.99439 | 1.12725 | 1.00097 | 0.95084 | 0.99190 | 1.00000 | | | | |
| 1996 | 1.04483 | 1.16998 | 1.14837 | 1.12479 | 1.00000 | | | | | |
| 1997 | 1.19537 | 0.97832 | 0.98998 | 0.95747 | | | | | | |
| 1998 | 1.03334 | 1.01160 | 0.97884 | | | | | | | |
| 1999 | 1.21044 | 1.06744 | | | | | | | | |
| 2000 | 1.11084 | | | | | | | | | |
| | Max/Min Link Ratios | | | | | | | | | |
| Max | 1.24239 | 1.16998 | 1.14837 | 1.12479 | 1.04279 | 1.15418 | 1.00000 | 1.02085 | 1.00339 | 1.00000 |
| Min | 0.99439 | 0.95291 | 0.97884 | 0.95084 | 0.95583 | 0.97888 | 0.98326 | 0.98699 | 1.00000 | 0.99990 |
| | Cumulative Products of Max/Min Link Ratios | | | | | | | | | |
| Max | 2.31469 | 1.86309 | 1.59241 | 1.38667 | 1.23282 | 1.18224 | 1.02431 | 1.02431 | 1.00339 | 1.00000 |
| Min | 0.80070 | 0.80521 | 0.84501 | 0.86327 | 0.90791 | 0.94987 | 0.97037 | 0.98689 | 0.99990 | 0.99990 |

| | |
|---|---|
| N > (1/(2 × 0.001) × [(4.01166) − (0.72452)]/(0.72452) = 945.427 | Use N > 946 |

Hence N should be anything greater than 946 (the max of 337 for set A and 946 for Set B) for two sets combined

Sample Data Set A
Table of Outcome Intervals

| | |
|---|---|
| Outcome Intervals | Outcome Intervals |

| From | To | As % Of All Outcomes |
|---|---|---|
| −40,599,147 | −40,554,547 | 0.0000000000000% |
| −40,554,545 | −40,509,945 | 0.0000000000000% |
| −40,509,944 | −40,465,344 | 0.0000000000000% |
| −40,465,342 | −40,420,742 | 0.0000000000000% |
| −40,420,740 | −40,376,140 | 0.0000000000000% |
| −40,376,139 | −40,331,539 | 0.0000000000000% |
| −40,331,537 | −40,286,937 | 0.0000000000000% |
| −40,286,935 | −40,242,335 | 0.0000000000000% |
| −40,242,334 | −40,197,734 | 0.0000000000000% |
| −40,197,732 | −40,153,132 | 0.0000000000000% |
| −40,153,130 | −40,108,530 | 0.0000000000000% |
| −40,108,529 | −40,063,929 | 0.0000000000000% |
| −40,063,927 | −40,019,327 | 0.0000000000000% |
| −40,019,325 | −39,974,725 | 0.0000000000000% |
| −39,974,724 | −39,930,124 | 0.0000000000000% |
| −39,930,122 | −39,885,522 | 0.0000000000000% |
| −39,885,520 | −39,840,920 | 0.0000000000000% |
| −39,840,919 | −39,796,319 | 0.0000000000000% |
| −39,796,317 | −39,751,717 | 0.0000000000000% |
| −39,751,715 | −39,707,115 | 0.0000000000000% |
| −39,707,114 | −39,662,514 | 0.0000000000000% |
| −39,662,512 | −39,617,912 | 0.0000000000000% |
| −39,617,910 | −39,573,310 | 0.0000000000000% |
| −39,573,309 | −39,528,709 | 0.0000000000000% |
| −39,528,707 | −39,484,107 | 0.0000000000000% |
| −39,484,105 | −39,439,505 | 0.0000000000000% |
| −39,439,504 | −39,394,904 | 0.0000000000000% |
| −39,394,902 | −39,350,302 | 0.0000000000000% |
| −39,350,300 | −39,305,700 | 0.0000000000000% |
| −39,305,699 | −39,261,099 | 0.0000000000000% |
| −39,261,097 | −39,216,497 | 0.0000000000000% |
| −39,216,495 | −39,171,895 | 0.0000000000000% |
| −39,171,894 | −39,127,294 | 0.0000000000000% |
| −39,127,292 | −39,082,692 | 0.0000000000000% |
| −39,082,690 | −39,038,090 | 0.0000000000000% |
| −39,038,088 | −38,993,488 | 0.0000000000000% |
| −38,993,487 | −38,948,887 | 0.0000000000000% |
| −38,948,885 | −38,904,285 | 0.0000000000000% |
| −38,904,283 | −38,859,683 | 0.0000000000000% |
| −38,859,682 | −38,815,082 | 0.0000000000000% |
| −38,815,080 | −38,770,480 | 0.0000000000000% |
| −38,770,478 | −38,725,878 | 0.0000000000000% |
| −38,725,877 | −38,681,277 | 0.0000000000000% |
| −38,681,275 | −38,636,675 | 0.0000000000000% |
| −38,636,673 | −38,592,073 | 0.0000000000000% |
| −38,592,072 | −38,547,472 | 0.0000000000000% |
| −38,547,470 | −38,502,870 | 0.0000000000000% |
| −38,502,868 | −38,458,268 | 0.0000000000000% |
| −38,458,267 | −38,413,667 | 0.0000000000000% |
| −38,413,665 | −38,369,065 | 0.0000000000000% |
| −38,369,063 | −38,324,463 | 0.0000000000000% |
| −38,324,462 | −38,279,862 | 0.0000000000000% |
| −38,279,860 | −38,235,260 | 0.0000000000000% |
| −38,235,258 | −38,190,658 | 0.0000000000000% |
| −38,190,657 | −38,146,057 | 0.0000000000000% |
| −38,146,055 | −38,101,455 | 0.0000000000000% |
| −38,101,453 | −38,056,853 | 0.0000000000000% |
| −38,056,852 | −38,012,252 | 0.0000000000000% |
| −38,012,250 | −37,967,650 | 0.0000000000000% |
| −37,967,648 | −37,923,048 | 0.0000000000000% |
| −37,923,047 | −37,878,447 | 0.0000000000000% |
| −37,878,445 | −37,833,845 | 0.0000000000000% |
| −37,833,843 | −37,789,243 | 0.0000000000000% |
| −37,789,242 | −37,744,642 | 0.0000000000000% |
| −37,744,640 | −37,700,040 | 0.0000000000000% |
| −37,700,038 | −37,655,438 | 0.0000000000000% |
| −37,655,437 | −37,610,837 | 0.0000000000000% |
| −37,610,835 | −37,566,235 | 0.0000000000000% |
| −37,566,233 | −37,521,633 | 0.0000000000000% |
| −37,521,632 | −37,477,032 | 0.0000000000000% |
| −37,477,030 | −37,432,430 | 0.0000000000000% |
| −37,432,428 | −37,387,828 | 0.0000000000000% |
| −37,387,827 | −37,343,227 | 0.0000000000000% |
| −37,343,225 | −37,298,625 | 0.0000000000000% |
| −37,298,623 | −37,254,023 | 0.0000000000000% |
| −37,254,022 | −37,209,422 | 0.0000000000000% |
| −37,209,420 | −37,164,820 | 0.0000000000000% |
| −37,164,818 | −37,120,218 | 0.0000000000000% |
| −37,120,217 | −37,075,617 | 0.0000000000000% |
| −37,075,615 | −37,031,015 | 0.0000000000000% |
| −37,031,013 | −36,986,413 | 0.0000000000000% |
| −36,986,411 | −36,941,811 | 0.0000000000000% |
| −36,941,810 | −36,897,210 | 0.0000000000000% |
| −36,897,208 | −36,852,608 | 0.0000000000000% |
| −36,852,606 | −36,808,006 | 0.0000000000000% |
| −36,808,005 | −36,763,405 | 0.0000000000000% |
| −36,763,403 | −36,718,803 | 0.0000000000000% |
| −36,718,801 | −36,674,201 | 0.0000000000000% |
| −36,674,200 | −36,629,600 | 0.0000000000000% |
| −36,629,598 | −36,584,998 | 0.0000000000000% |
| −36,584,996 | −36,540,396 | 0.0000000000000% |
| −36,540,395 | −36,495,795 | 0.0000000000000% |
| −36,495,793 | −36,451,193 | 0.0000000000000% |
| −36,451,191 | −36,406,591 | 0.0000000000000% |
| −36,406,590 | −36,361,990 | 0.0000000000000% |
| −36,361,988 | −36,317,388 | 0.0000000000000% |
| −36,317,386 | −36,272,786 | 0.0000000000000% |
| −36,272,785 | −36,228,185 | 0.0000000000000% |
| −36,228,183 | −36,183,583 | 0.0000000000000% |
| −36,183,581 | −36,138,981 | 0.0000000000000% |
| −36,138,980 | −36,094,380 | 0.0000000000000% |
| −36,094,378 | −36,049,778 | 0.0000000000000% |
| −36,049,776 | −36,005,176 | 0.0000000000000% |
| −36,005,175 | −35,960,575 | 0.0000000000000% |
| −35,960,573 | −35,915,973 | 0.0000000000000% |
| −35,915,971 | −35,871,371 | 0.0000000000000% |
| −35,871,370 | −35,826,770 | 0.0000000000000% |
| −35,826,768 | −35,782,168 | 0.0000000000000% |
| −35,782,166 | −35,737,566 | 0.0000000000000% |
| −35,737,565 | −35,692,965 | 0.0000000000000% |
| −35,692,963 | −35,648,363 | 0.0000000000000% |
| −35,648,361 | −35,603,761 | 0.0000000000000% |
| −35,603,760 | −35,559,160 | 0.0000000000000% |
| −35,559,158 | −35,514,558 | 0.0000000000000% |
| −35,514,556 | −35,469,956 | 0.0000000000000% |
| −35,469,955 | −35,425,355 | 0.0000000000000% |
| −35,425,353 | −35,380,753 | 0.0000000000000% |
| −35,380,751 | −35,336,151 | 0.0000000000000% |
| −35,336,150 | −35,291,550 | 0.0000000000000% |
| −35,291,548 | −35,246,948 | 0.0000000000000% |
| −35,246,946 | −35,202,346 | 0.0000000000000% |
| −35,202,345 | −35,157,745 | 0.0000000000000% |
| −35,157,743 | −35,113,143 | 0.0000000000000% |
| −35,113,141 | −35,068,541 | 0.0000000000000% |
| −35,068,540 | −35,023,940 | 0.0000000000000% |
| −35,023,938 | −34,979,338 | 0.0000000000000% |
| −34,979,336 | −34,934,736 | 0.0000000000000% |
| −34,934,734 | −34,890,134 | 0.0000000000000% |
| −34,890,133 | −34,845,533 | 0.0000000000000% |
| −34,845,531 | −34,800,931 | 0.0000000000000% |
| −34,800,929 | −34,756,329 | 0.0000000000000% |
| −34,756,328 | −34,711,728 | 0.0000000000000% |
| −34,711,726 | −34,667,126 | 0.0000000000000% |
| −34,667,124 | −34,622,524 | 0.0000000000000% |
| −34,622,523 | −34,577,923 | 0.0000000000000% |
| −34,577,921 | −34,533,321 | 0.0000000000000% |
| −34,533,319 | −34,488,719 | 0.0000000000000% |
| −34,488,718 | −34,444,118 | 0.0000000000000% |
| −34,444,116 | −34,399,516 | 0.0000000000000% |
| −34,399,514 | −34,354,914 | 0.0000000000000% |
| −34,354,913 | −34,310,313 | 0.0000000000000% |
| −34,310,311 | −34,265,711 | 0.0000000000000% |
| −34,265,709 | −34,221,109 | 0.0000000000000% |
| −34,221,108 | −34,176,508 | 0.0000000000000% |
| −34,176,506 | −34,131,906 | 0.0000000000000% |
| −34,131,904 | −34,087,304 | 0.0000000000000% |
| −34,087,303 | −34,042,703 | 0.0000000000000% |
| −34,042,701 | −33,998,101 | 0.0000000000000% |
| −33,998,099 | −33,953,499 | 0.0000000000000% |
| −33,953,498 | −33,908,898 | 0.0000000000000% |
| −33,908,896 | −33,864,296 | 0.0000000000000% |
| −33,864,294 | −33,819,694 | 0.0000000000000% |
| −33,819,693 | −33,775,093 | 0.0000000000000% |
| −33,775,091 | −33,730,491 | 0.0000000000000% |
| −33,730,489 | −33,685,889 | 0.0000000000000% |
| −33,685,888 | −33,641,288 | 0.0000000000000% |
| −33,641,286 | −33,596,686 | 0.0000000000000% |
| −33,596,684 | −33,552,084 | 0.0000000000000% |
| −33,552,083 | −33,507,483 | 0.0000000000000% |
| −33,507,481 | −33,462,881 | 0.0000000000000% |
| −33,462,879 | −33,418,279 | 0.0000000000000% |
| −33,418,278 | −33,373,678 | 0.0000000000000% |
| −33,373,676 | −33,329,076 | 0.0000000000000% |
| −33,329,074 | −33,284,474 | 0.0000000000000% |
| −33,284,473 | −33,239,873 | 0.0000000000000% |
| −33,239,871 | −33,195,271 | 0.0000000000000% |
| −33,195,269 | −33,150,669 | 0.0000000000000% |
| −33,150,668 | −33,106,068 | 0.0000000000000% |
| −33,106,066 | −33,061,466 | 0.0000000000000% |
| −33,061,464 | −33,016,864 | 0.0000000000000% |
| −33,016,863 | −32,972,263 | 0.0000000000000% |
| −32,972,261 | −32,927,661 | 0.0000000000000% |
| −32,927,659 | −32,883,059 | 0.0000000000000% |
| −32,883,057 | −32,838,457 | 0.0000000000000% |
| −32,838,456 | −32,793,856 | 0.0000000000000% |
| −32,793,854 | −32,749,254 | 0.0000000000000% |
| −32,749,252 | −32,704,652 | 0.0000000000000% |
| −32,704,651 | −32,660,051 | 0.0000000000000% |
| −32,660,049 | −32,615,449 | 0.0000000000000% |
| −32,615,447 | −32,570,847 | 0.0000000000000% |
| −32,570,846 | −32,526,246 | 0.0000000000000% |
| −32,526,244 | −32,481,644 | 0.0000000000000% |
| −32,481,642 | −32,437,042 | 0.0000000000000% |
| −32,437,041 | −32,392,441 | 0.0000000000000% |
| −32,392,439 | −32,347,839 | 0.0000000000000% |
| −32,347,837 | −32,303,237 | 0.0000000000000% |
| −32,303,236 | −32,258,636 | 0.0000000000000% |
| −32,258,634 | −32,214,034 | 0.0000000000000% |
| −32,214,032 | −32,169,432 | 0.0000000000000% |
| −32,169,431 | −32,124,831 | 0.0000000000000% |
| −32,124,829 | −32,080,229 | 0.0000000000000% |
| −32,080,227 | −32,035,627 | 0.0000000000000% |
| −32,035,626 | −31,991,026 | 0.0000000000000% |
| −31,991,024 | −31,946,424 | 0.0000000000000% |
| −31,946,422 | −31,901,822 | 0.0000000000000% |
| −31,901,821 | −31,857,221 | 0.0000000000000% |
| −31,857,219 | −31,812,619 | 0.0000000000000% |
| −31,812,617 | −31,768,017 | 0.0000000000000% |
| −31,768,016 | −31,723,416 | 0.0000000000000% |
| −31,723,414 | −31,678,814 | 0.0000000000000% |
| −31,678,812 | −31,634,212 | 0.0000000000000% |
| −31,634,211 | −31,589,611 | 0.0000000000000% |
| −31,589,609 | −31,545,009 | 0.0000000000000% |
| −31,545,007 | −31,500,407 | 0.0000000000000% |
| −31,500,406 | −31,455,806 | 0.0000000000000% |
| −31,455,804 | −31,411,204 | 0.0000000000000% |
| −31,411,202 | −31,366,602 | 0.0000000000000% |
| −31,366,601 | −31,322,001 | 0.0000000000000% |
| −31,321,999 | −31,277,399 | 0.0000000000000% |
| −31,277,397 | −31,232,797 | 0.0000000000000% |
| −31,232,796 | −31,188,196 | 0.0000000000000% |
| −31,188,194 | −31,143,594 | 0.0000000000000% |
| −31,143,592 | −31,098,992 | 0.0000000000000% |
| −31,098,991 | −31,054,391 | 0.0000000000000% |
| −31,054,389 | −31,009,789 | 0.0000000000000% |
| −31,009,787 | −30,965,187 | 0.0000000000000% |
| −30,965,186 | −30,920,586 | 0.0000000000000% |
| −30,920,584 | −30,875,984 | 0.0000000000000% |
| −30,875,982 | −30,831,382 | 0.0000000000000% |
| −30,831,380 | −30,786,780 | 0.0000000000000% |
| −30,786,779 | −30,742,179 | 0.0000000000000% |
| −30,742,177 | −30,697,577 | 0.0000000000000% |
| −30,697,575 | −30,652,975 | 0.0000000000000% |
| −30,652,974 | −30,608,374 | 0.0000000000000% |
| −30,608,372 | −30,563,772 | 0.0000000000000% |
| −30,563,770 | −30,519,170 | 0.0000000000000% |
| −30,519,169 | −30,474,569 | 0.0000000000000% |
| −30,474,567 | −30,429,967 | 0.0000000000000% |
| −30,429,965 | −30,385,365 | 0.0000000000000% |
| −30,385,364 | −30,340,764 | 0.0000000000000% |
| −30,340,762 | −30,296,162 | 0.0000000000000% |
| −30,296,160 | −30,251,560 | 0.0000000000000% |
| −30,251,559 | −30,206,959 | 0.0000000000000% |
| −30,206,957 | −30,162,357 | 0.0000000000000% |
| −30,162,355 | −30,117,755 | 0.0000000000000% |
| −30,117,754 | −30,073,154 | 0.0000000000000% |
| −30,073,152 | −30,028,552 | 0.0000000000000% |
| −30,028,550 | −29,983,950 | 0.0000000000000% |
| −29,983,949 | −29,939,349 | 0.0000000000000% |
| −29,939,347 | −29,894,747 | 0.0000000000000% |
| −29,894,745 | −29,850,145 | 0.0000000000000% |
| −29,850,144 | −29,805,544 | 0.0000000000000% |
| −29,805,542 | −29,760,942 | 0.0000000000000% |
| −29,760,940 | −29,716,340 | 0.0000000000000% |
| −29,716,339 | −29,671,739 | 0.0000000000000% |
| −29,671,737 | −29,627,137 | 0.0000000000000% |
| −29,627,135 | −29,582,535 | 0.0000000000000% |
| −29,582,534 | −29,537,934 | 0.0000000000000% |
| −29,537,932 | −29,493,332 | 0.0000000000000% |
| −29,493,330 | −29,448,730 | 0.0000000000000% |
| −29,448,729 | −29,404,129 | 0.0000000000000% |
| −29,404,127 | −29,359,527 | 0.0000000000000% |
| −29,359,525 | −29,314,925 | 0.0000000000000% |
| −29,314,924 | −29,270,324 | 0.0000000000000% |
| −29,270,322 | −29,225,722 | 0.0000000000000% |
| −29,225,720 | −29,181,120 | 0.0000000000000% |
| −29,181,119 | −29,136,519 | 0.0000000000000% |
| −29,136,517 | −29,091,917 | 0.0000000000000% |
| −29,091,915 | −29,047,315 | 0.0000000000000% |
| −29,047,314 | −29,002,714 | 0.0000000000000% |
| −29,002,712 | −28,958,112 | 0.0000000000000% |
| −28,958,110 | −28,913,510 | 0.0000000000000% |
| −28,913,509 | −28,868,909 | 0.0000000000000% |
| −28,868,907 | −28,824,307 | 0.0000000000000% |
| −28,824,305 | −28,779,705 | 0.0000000000000% |
| −28,779,703 | −28,735,103 | 0.0000000000000% |
| −28,735,102 | −28,690,502 | 0.0000000000000% |
| −28,690,500 | −28,645,900 | 0.0000000000000% |
| −28,645,898 | −28,601,298 | 0.0000000000000% |
| −28,601,297 | −28,556,697 | 0.0000000000000% |
| −28,556,695 | −28,512,095 | 0.0000000000000% |
| −28,512,093 | −28,467,493 | 0.0000000000000% |
| −28,467,492 | −28,422,892 | 0.0000000000000% |
| −28,422,890 | −28,378,290 | 0.0000000000000% |
| −28,378,288 | −28,333,688 | 0.0000000000000% |
| −28,333,687 | −28,289,087 | 0.0000000000000% |
| −28,289,085 | −28,244,485 | 0.0000000000000% |
| −28,244,483 | −28,199,883 | 0.0000000000000% |
| −28,199,882 | −28,155,282 | 0.0000000000000% |
| −28,155,280 | −28,110,680 | 0.0000000000000% |
| −28,110,678 | −28,066,078 | 0.0000000000000% |
| −28,066,077 | −28,021,477 | 0.0000000000000% |
| −28,021,475 | −27,976,875 | 0.0000000000000% |
| −27,976,873 | −27,932,273 | 0.0000000000000% |
| −27,932,272 | −27,887,672 | 0.0000000000000% |
| −27,887,670 | −27,843,070 | 0.0000000000000% |
| −27,843,068 | −27,798,468 | 0.0000000000000% |
| −27,798,467 | −27,753,867 | 0.0000000000000% |
| −27,753,865 | −27,709,265 | 0.0000000000000% |
| −27,709,263 | −27,664,663 | 0.0000000000000% |
| −27,664,662 | −27,620,062 | 0.0000000000000% |
| −27,620,060 | −27,575,460 | 0.0000000000000% |
| −27,575,458 | −27,530,858 | 0.0000000000000% |
| −27,530,857 | −27,486,257 | 0.0000000000000% |
| −27,486,255 | −27,441,655 | 0.0000000000000% |
| −27,441,653 | −27,397,053 | 0.0000000000000% |
| −27,397,052 | −27,352,452 | 0.0000000000000% |
| −27,352,450 | −27,307,850 | 0.0000000000000% |
| −27,307,848 | −27,263,248 | 0.0000000000000% |
| −27,263,247 | −27,218,647 | 0.0000000000000% |
| −27,218,645 | −27,174,045 | 0.0000000000000% |
| −27,174,043 | −27,129,443 | 0.0000000000000% |
| −27,129,442 | −27,084,842 | 0.0000000000000% |
| −27,084,840 | −27,040,240 | 0.0000000000000% |
| −27,040,238 | −26,995,638 | 0.0000000000000% |
| −26,995,637 | −26,951,037 | 0.0000000000000% |
| −26,951,035 | −26,906,435 | 0.0000000000000% |
| −26,906,433 | −26,861,833 | 0.0000000000000% |
| −26,861,832 | −26,817,232 | 0.0000000000000% |
| −26,817,230 | −26,772,630 | 0.0000000000000% |
| −26,772,628 | −26,728,028 | 0.0000000000000% |
| −26,728,026 | −26,683,426 | 0.0000000000000% |
| −26,683,425 | −26,638,825 | 0.0000000000000% |
| −26,638,823 | −26,594,223 | 0.0000000000000% |
| −26,594,221 | −26,549,621 | 0.0000000000000% |
| −26,549,620 | −26,505,020 | 0.0000000000000% |
| −26,505,018 | −26,460,418 | 0.0000000000000% |
| −26,460,416 | −26,415,816 | 0.0000000000000% |
| −26,415,815 | −26,371,215 | 0.0000000000000% |
| −26,371,213 | −26,326,613 | 0.0000000000000% |
| −26,326,611 | −26,282,011 | 0.0000000000000% |
| −26,282,010 | −26,237,410 | 0.0000000000000% |
| −26,237,408 | −26,192,808 | 0.0000000000000% |
| −26,192,806 | −26,148,206 | 0.0000000000000% |
| −26,148,205 | −26,103,605 | 0.0000000000000% |
| −26,103,603 | −26,059,003 | 0.0000000000000% |
| −26,059,001 | −26,014,401 | 0.0000000000000% |
| −26,014,400 | −25,969,800 | 0.0000000000000% |
| −25,969,798 | −25,925,198 | 0.0000000000000% |
| −25,925,196 | −25,880,596 | 0.0000000000000% |
| −25,880,595 | −25,835,995 | 0.0000000000000% |
| −25,835,993 | −25,791,393 | 0.0000000000000% |
| −25,791,391 | −25,746,791 | 0.0000000000000% |
| −25,746,790 | −25,702,190 | 0.0000000000000% |
| −25,702,188 | −25,657,588 | 0.0000000000000% |
| −25,657,586 | −25,612,986 | 0.0000000000000% |
| −25,612,985 | −25,568,385 | 0.0000000000000% |
| −25,568,383 | −25,523,783 | 0.0000000000000% |
| −25,523,781 | −25,479,181 | 0.0000000000000% |
| −25,479,180 | −25,434,580 | 0.0000000000000% |
| −25,434,578 | −25,389,978 | 0.0000000000000% |
| −25,389,976 | −25,345,376 | 0.0000000000000% |
| −25,345,375 | −25,300,775 | 0.0000000000000% |
| −25,300,773 | −25,256,173 | 0.0000000000000% |
| −25,256,171 | −25,211,571 | 0.0000000000000% |
| −25,211,570 | −25,166,970 | 0.0000000000000% |
| −25,166,968 | −25,122,368 | 0.0000000000000% |
| −25,122,366 | −25,077,766 | 0.0000000000000% |
| −25,077,765 | −25,033,165 | 0.0000000000000% |
| −25,033,163 | −24,988,563 | 0.0000000000000% |
| −24,988,561 | −24,943,961 | 0.0000000000000% |
| −24,943,960 | −24,899,360 | 0.0000000000000% |
| −24,899,358 | −24,854,758 | 0.0000000000000% |
| −24,854,756 | −24,810,156 | 0.0000000000000% |
| −24,810,154 | −24,765,554 | 0.0000000000000% |
| −24,765,553 | −24,720,953 | 0.0000000000000% |
| −24,720,951 | −24,676,351 | 0.0000000000000% |
| −24,676,349 | −24,631,749 | 0.0000000000000% |
| −24,631,748 | −24,587,148 | 0.0000000000000% |
| −24,587,146 | −24,542,546 | 0.0000000000000% |
| −24,542,544 | −24,497,944 | 0.0000000000000% |
| −24,497,943 | −24,453,343 | 0.0000000000000% |
| −24,453,341 | −24,408,741 | 0.0000000000000% |
| −24,408,739 | −24,364,139 | 0.0000000000000% |
| −24,364,138 | −24,319,538 | 0.0000000000000% |
| −24,319,536 | −24,274,936 | 0.0000000000000% |
| −24,274,934 | −24,230,334 | 0.0000000000000% |
| −24,230,333 | −24,185,733 | 0.0000000000000% |
| −24,185,731 | −24,141,131 | 0.0000000000000% |
| −24,141,129 | −24,096,529 | 0.0000000000000% |
| −24,096,528 | −24,051,928 | 0.0000000000000% |
| −24,051,926 | −24,007,326 | 0.0000000000000% |
| −24,007,324 | −23,962,724 | 0.0000000000000% |
| −23,962,723 | −23,918,123 | 0.0000000000000% |
| −23,918,121 | −23,873,521 | 0.0000000000000% |
| −23,873,519 | −23,828,919 | 0.0000000000000% |
| −23,828,918 | −23,784,318 | 0.0000000000000% |
| −23,784,316 | −23,739,716 | 0.0000000000000% |
| −23,739,714 | −23,695,114 | 0.0000000000000% |
| −23,695,113 | −23,650,513 | 0.0000000000000% |
| −23,650,511 | −23,605,911 | 0.0000000000000% |
| −23,605,909 | −23,561,309 | 0.0000000000000% |
| −23,561,308 | −23,516,708 | 0.0000000000000% |
| −23,516,706 | −23,472,106 | 0.0000000000000% |
| −23,472,104 | −23,427,504 | 0.0000000000000% |
| −23,427,503 | −23,382,903 | 0.0000000000000% |
| −23,382,901 | −23,338,301 | 0.0000000000000% |
| −23,338,299 | −23,293,699 | 0.0000000000000% |
| −23,293,698 | −23,249,098 | 0.0000000000000% |
| −23,249,096 | −23,204,496 | 0.0000000000000% |
| −23,204,494 | −23,159,894 | 0.0000000000000% |
| −23,159,893 | −23,115,293 | 0.0000000000000% |
| −23,115,291 | −23,070,691 | 0.0000000000000% |
| −23,070,689 | −23,026,089 | 0.0000000000000% |
| −23,026,088 | −22,981,488 | 0.0000000000000% |
| −22,981,486 | −22,936,886 | 0.0000000000000% |
| −22,936,884 | −22,892,284 | 0.0000000000000% |
| −22,892,283 | −22,847,683 | 0.0000000000000% |
| −22,847,681 | −22,803,081 | 0.0000000000000% |
| −22,803,079 | −22,758,479 | 0.0000000000000% |
| −22,758,477 | −22,713,877 | 0.0000000000000% |
| −22,713,876 | −22,669,276 | 0.0000000000000% |
| −22,669,274 | −22,624,674 | 0.0000000000000% |
| −22,624,672 | −22,580,072 | 0.0000000000000% |
| −22,580,071 | −22,535,471 | 0.0000000000000% |
| −22,535,469 | −22,490,869 | 0.0000000000000% |
| −22,490,867 | −22,446,267 | 0.0000000000000% |
| −22,446,266 | −22,401,666 | 0.0000000000000% |
| −22,401,664 | −22,357,064 | 0.0000000000000% |
| −22,357,062 | −22,312,462 | 0.0000000000000% |
| −22,312,461 | −22,267,861 | 0.0000000000000% |
| −22,267,859 | −22,223,259 | 0.0000000000000% |
| −22,223,257 | −22,178,657 | 0.0000000000000% |
| −22,178,656 | −22,134,056 | 0.0000000000000% |
| −22,134,054 | −22,089,454 | 0.0000000000000% |
| −22,089,452 | −22,044,852 | 0.0000000000000% |
| −22,044,851 | −22,000,251 | 0.0000000000000% |
| −22,000,249 | −21,955,649 | 0.0000000000000% |
| −21,955,647 | −21,911,047 | 0.0000000000000% |
| −21,911,046 | −21,866,446 | 0.0000000000000% |
| −21,866,444 | −21,821,844 | 0.0000000000000% |
| −21,821,842 | −21,777,242 | 0.0000000000000% |
| −21,777,241 | −21,732,641 | 0.0000000000000% |
| −21,732,639 | −21,688,039 | 0.0000000000000% |
| −21,688,037 | −21,643,437 | 0.0000000000000% |
| −21,643,436 | −21,598,836 | 0.0000000000000% |
| −21,598,834 | −21,554,234 | 0.0000000000000% |
| −21,554,232 | −21,509,632 | 0.0000000000000% |
| −21,509,631 | −21,465,031 | 0.0000000000000% |
| −21,465,029 | −21,420,429 | 0.0000000000000% |
| −21,420,427 | −21,375,827 | 0.0000000000000% |
| −21,375,826 | −21,331,226 | 0.0000000000000% |
| −21,331,224 | −21,286,624 | 0.0000000000000% |
| −21,286,622 | −21,242,022 | 0.0000000000000% |
| −21,242,021 | −21,197,421 | 0.0000000000000% |
| −21,197,419 | −21,152,819 | 0.0000000000000% |
| −21,152,817 | −21,108,217 | 0.0000000000000% |
| −21,108,216 | −21,063,616 | 0.0000000000000% |
| −21,063,614 | −21,019,014 | 0.0000000000000% |
| −21,019,012 | −20,974,412 | 0.0000000000000% |
| −20,974,411 | −20,929,811 | 0.0000000000000% |
| −20,929,809 | −20,885,209 | 0.0000000000000% |
| −20,885,207 | −20,840,607 | 0.0000000000000% |
| −20,840,606 | −20,796,006 | 0.0000000000000% |
| −20,796,004 | −20,751,404 | 0.0000000000000% |
| −20,751,402 | −20,706,802 | 0.0000000000000% |
| −20,706,800 | −20,662,200 | 0.0000000000000% |
| −20,662,199 | −20,617,599 | 0.0000000000000% |
| −20,617,597 | −20,572,997 | 0.0000000000000% |
| −20,572,995 | −20,528,395 | 0.0000000000000% |
| −20,528,394 | −20,483,794 | 0.0000000000000% |
| −20,483,792 | −20,439,192 | 0.0000000000000% |
| −20,439,190 | −20,394,590 | 0.0000000000000% |
| −20,394,589 | −20,349,989 | 0.0000000000000% |
| −20,349,987 | −20,305,387 | 0.0000000000000% |
| −20,305,385 | −20,260,785 | 0.0000000000000% |
| −20,260,784 | −20,216,184 | 0.0000000000000% |
| −20,216,182 | −20,171,582 | 0.0000000000000% |
| −20,171,580 | −20,126,980 | 0.0000000000000% |
| −20,126,979 | −20,082,379 | 0.0000000000000% |
| −20,082,377 | −20,037,777 | 0.0000000000000% |
| −20,037,775 | −19,993,175 | 0.0000000000000% |
| −19,993,174 | −19,948,574 | 0.0000000000000% |
| −19,948,572 | −19,903,972 | 0.0000000000000% |
| −19,903,970 | −19,859,370 | 0.0000000000000% |
| −19,859,369 | −19,814,769 | 0.0000000000000% |
| −19,814,767 | −19,770,167 | 0.0000000000000% |
| −19,770,165 | −19,725,565 | 0.0000000000000% |
| −19,725,564 | −19,680,964 | 0.0000000000000% |
| −19,680,962 | −19,636,362 | 0.0000000000000% |
| −19,636,360 | −19,591,760 | 0.0000000000000% |
| −19,591,759 | −19,547,159 | 0.0000000000000% |
| −19,547,157 | −19,502,557 | 0.0000000000000% |
| −19,502,555 | −19,457,955 | 0.0000000000000% |
| −19,457,954 | −19,413,354 | 0.0000000000000% |
| −19,413,352 | −19,368,752 | 0.0000000000000% |
| −19,368,750 | −19,324,150 | 0.0000000000000% |
| −19,324,149 | −19,279,549 | 0.0000000000000% |
| −19,279,547 | −19,234,947 | 0.0000000000000% |
| −19,234,945 | −19,190,345 | 0.0000000000000% |
| −19,190,344 | −19,145,744 | 0.0000000000000% |
| −19,145,742 | −19,101,142 | 0.0000000000000% |
| −19,101,140 | −19,056,540 | 0.0000000000000% |
| −19,056,539 | −19,011,939 | 0.0000000000000% |
| −19,011,937 | −18,967,337 | 0.0000000000000% |
| −18,967,335 | −18,922,735 | 0.0000000000000% |
| −18,922,734 | −18,878,134 | 0.0000000000000% |
| −18,878,132 | −18,833,532 | 0.0000000000000% |
| −18,833,530 | −18,788,930 | 0.0000000000000% |
| −18,788,929 | −18,744,329 | 0.0000000000000% |
| −18,744,327 | −18,699,727 | 0.0000000000000% |
| −18,699,725 | −18,655,125 | 0.0000000000000% |
| −18,655,123 | −18,610,523 | 0.0000000000000% |
| −18,610,522 | −18,565,922 | 0.0000000000000% |
| −18,565,920 | −18,521,320 | 0.0000000000000% |
| −18,521,318 | −18,476,718 | 0.0000000000000% |
| −18,476,717 | −18,432,117 | 0.0000000000000% |
| −18,432,115 | −18,387,515 | 0.0000000000000% |
| −18,387,513 | −18,342,913 | 0.0000000000000% |
| −18,342,912 | −18,298,312 | 0.0000000000000% |
| −18,298,310 | −18,253,710 | 0.0000000000000% |
| −18,253,708 | −18,209,108 | 0.0000000000000% |
| −18,209,107 | −18,164,507 | 0.0000000000000% |
| −18,164,505 | −18,119,905 | 0.0000000000000% |
| −18,119,903 | −18,075,303 | 0.0000000000000% |
| −18,075,302 | −18,030,702 | 0.0000000000000% |
| −18,030,700 | −17,986,100 | 0.0000000000000% |
| −17,986,098 | −17,941,498 | 0.0000000000000% |
| −17,941,497 | −17,896,897 | 0.0000000000000% |
| −17,896,895 | −17,852,295 | 0.0000000000000% |
| −17,852,293 | −17,807,693 | 0.0000000000000% |
| −17,807,692 | −17,763,092 | 0.0000000000000% |
| −17,763,090 | −17,718,490 | 0.0000000000000% |
| −17,718,488 | −17,673,888 | 0.0000000000000% |
| −17,673,887 | −17,629,287 | 0.0000000000000% |
| −17,629,285 | −17,584,685 | 0.0000000000000% |
| −17,584,683 | −17,540,083 | 0.0000000000000% |
| −17,540,082 | −17,495,482 | 0.0000000000000% |
| −17,495,480 | −17,450,880 | 0.0000000000000% |
| −17,450,878 | −17,406,278 | 0.0000000000000% |
| −17,406,277 | −17,361,677 | 0.0000000000000% |
| −17,361,675 | −17,317,075 | 0.0000000000000% |
| −17,317,073 | −17,272,473 | 0.0000000000000% |
| −17,272,472 | −17,227,872 | 0.0000000000000% |
| −17,227,870 | −17,183,270 | 0.0000000000000% |
| −17,183,268 | −17,138,668 | 0.0000000000000% |
| −17,138,667 | −17,094,067 | 0.0000000000000% |
| −17,094,065 | −17,049,465 | 0.0000000000000% |
| −17,049,463 | −17,004,863 | 0.0000000000000% |
| −17,004,862 | −16,960,262 | 0.0000000000000% |
| −16,960,260 | −16,915,660 | 0.0000000000000% |
| −16,915,658 | −16,871,058 | 0.0000000000000% |
| −16,871,057 | −16,826,457 | 0.0000000000000% |
| −16,826,455 | −16,781,855 | 0.0000000000000% |
| −16,781,853 | −16,737,253 | 0.0000000000000% |
| −16,737,252 | −16,692,652 | 0.0000000000000% |
| −16,692,650 | −16,648,050 | 0.0000000000000% |
| −16,648,048 | −16,603,448 | 0.0000000000000% |
| −16,603,446 | −16,558,846 | 0.0000000000000% |
| −16,558,845 | −16,514,245 | 0.0000000000000% |
| −16,514,243 | −16,469,643 | 0.0000000000000% |
| −16,469,641 | −16,425,041 | 0.0000000000000% |
| −16,425,040 | −16,380,440 | 0.0000000000000% |
| −16,380,438 | −16,335,838 | 0.0000000000000% |
| −16,335,836 | −16,291,236 | 0.0000000000000% |
| −16,291,235 | −16,246,635 | 0.0000000000000% |
| −16,246,633 | −16,202,033 | 0.0000000000000% |
| −16,202,031 | −16,157,431 | 0.0000000000000% |
| −16,157,430 | −16,112,830 | 0.0000000000000% |
| −16,112,828 | −16,068,228 | 0.0000000000000% |
| −16,068,226 | −16,023,626 | 0.0000000000000% |
| −16,023,625 | −15,979,025 | 0.0000000000000% |
| −15,979,023 | −15,934,423 | 0.0000000000000% |
| −15,934,421 | −15,889,821 | 0.0000000000000% |
| −15,889,820 | −15,845,220 | 0.0000000000000% |
| −15,845,218 | −15,800,618 | 0.0000000000000% |
| −15,800,616 | −15,756,016 | 0.0000000000000% |
| −15,756,015 | −15,711,415 | 0.0000000000000% |
| −15,711,413 | −15,666,813 | 0.0000000000000% |
| −15,666,811 | −15,622,211 | 0.0000000000000% |
| −15,622,210 | −15,577,610 | 0.0000000000000% |
| −15,577,608 | −15,533,008 | 0.0000000000000% |
| −15,533,006 | −15,488,406 | 0.0000000000000% |
| −15,488,405 | −15,443,805 | 0.0000000000000% |
| −15,443,803 | −15,399,203 | 0.0000000000000% |
| −15,399,201 | −15,354,601 | 0.0000000000000% |
| −15,354,600 | −15,310,000 | 0.0000000000000% |
| −15,309,998 | −15,265,398 | 0.0000000000000% |
| −15,265,396 | −15,220,796 | 0.0000000000000% |
| −15,220,795 | −15,176,195 | 0.0000000000000% |
| −15,176,193 | −15,131,593 | 0.0000000000000% |
| −15,131,591 | −15,086,991 | 0.0000000000000% |
| −15,086,990 | −15,042,390 | 0.0000000000000% |
| −15,042,388 | −14,997,788 | 0.0000000000000% |
| −14,997,786 | −14,953,186 | 0.0000000000000% |
| −14,953,185 | −14,908,585 | 0.0000000000000% |
| −14,908,583 | −14,863,983 | 0.0000000000000% |
| −14,863,981 | −14,819,381 | 0.0000000000000% |
| −14,819,380 | −14,774,780 | 0.0000000000000% |
| −14,774,778 | −14,730,178 | 0.0000000000000% |
| −14,730,176 | −14,685,576 | 0.0000000000000% |
| −14,685,575 | −14,640,975 | 0.0000000000000% |
| −14,640,973 | −14,596,373 | 0.0000000000000% |
| −14,596,371 | −14,551,771 | 0.0000000000000% |
| −14,551,769 | −14,507,169 | 0.0000000000000% |
| −14,507,168 | −14,462,568 | 0.0000000000000% |
| −14,462,566 | −14,417,966 | 0.0000000000000% |
| −14,417,964 | −14,373,364 | 0.0000000000000% |
| −14,373,363 | −14,328,763 | 0.0000000000000% |
| −14,328,761 | −14,284,161 | 0.0000000000000% |
| −14,284,159 | −14,239,559 | 0.0000000000000% |
| −14,239,558 | −14,194,958 | 0.0000000000000% |
| −14,194,956 | −14,150,356 | 0.0000000000000% |
| −14,150,354 | −14,105,754 | 0.0000000000000% |
| −14,105,753 | −14,061,153 | 0.0000000000000% |
| −14,061,151 | −14,016,551 | 0.0000000000000% |
| −14,016,549 | −13,971,949 | 0.0000000000000% |
| −13,971,948 | −13,927,348 | 0.0000000000000% |
| −13,927,346 | −13,882,746 | 0.0000000000000% |
| −13,882,744 | −13,838,144 | 0.0000000000000% |
| −13,838,143 | −13,793,543 | 0.0000000000000% |
| −13,793,541 | −13,748,941 | 0.0000000000000% |
| −13,748,939 | −13,704,339 | 0.0000000000000% |
| −13,704,338 | −13,659,738 | 0.0000000000000% |
| −13,659,736 | −13,615,136 | 0.0000000000000% |
| −13,615,134 | −13,570,534 | 0.0000000000000% |
| −13,570,533 | −13,525,933 | 0.0000000000000% |
| −13,525,931 | −13,481,331 | 0.0000000000000% |
| −13,481,329 | −13,436,729 | 0.0000000000000% |
| −13,436,728 | −13,392,128 | 0.0000000000000% |
| −13,392,126 | −13,347,526 | 0.0000000000000% |
| −13,347,524 | −13,302,924 | 0.0000000000000% |
| −13,302,923 | −13,258,323 | 0.0000000000000% |
| −13,258,321 | −13,213,721 | 0.0000000000000% |
| −13,213,719 | −13,169,119 | 0.0000000000000% |
| −13,169,118 | −13,124,518 | 0.0000000000000% |
| −13,124,516 | −13,079,916 | 0.0000000000000% |
| −13,079,914 | −13,035,314 | 0.0000000000000% |
| −13,035,313 | −12,990,713 | 0.0000000000000% |
| −12,990,711 | −12,946,111 | 0.0000000000000% |
| −12,946,109 | −12,901,509 | 0.0000000000000% |
| −12,901,508 | −12,856,908 | 0.0000000000000% |
| −12,856,906 | −12,812,306 | 0.0000000000000% |
| −12,812,304 | −12,767,704 | 0.0000000000000% |
| −12,767,703 | −12,723,103 | 0.0000000000000% |
| −12,723,101 | −12,678,501 | 0.0000000000000% |
| −12,678,499 | −12,633,899 | 0.0000000000000% |
| −12,633,898 | −12,589,298 | 0.0000000000000% |
| −12,589,296 | −12,544,696 | 0.0000000000000% |
| −12,544,694 | −12,500,094 | 0.0000000000000% |
| −12,500,092 | −12,455,492 | 0.0000000000000% |
| −12,455,491 | −12,410,891 | 0.0000000000000% |
| −12,410,889 | −12,366,289 | 0.0000000000000% |
| −12,366,287 | −12,321,687 | 0.0000000000000% |
| −12,321,686 | −12,277,086 | 0.0000000000000% |
| −12,277,084 | −12,232,484 | 0.0000000000000% |
| −12,232,482 | −12,187,882 | 0.0000000000000% |
| −12,187,881 | −12,143,281 | 0.0000000000000% |
| −12,143,279 | −12,098,679 | 0.0000000000000% |
| −12,098,677 | −12,054,077 | 0.0000000000000% |
| −12,054,076 | −12,009,476 | 0.0000000000000% |
| −12,009,474 | −11,964,874 | 0.0000000000000% |
| −11,964,872 | −11,920,272 | 0.0000000000000% |
| −11,920,271 | −11,875,671 | 0.0000000000000% |
| −11,875,669 | −11,831,069 | 0.0000000000000% |
| −11,831,067 | −11,786,467 | 0.0000000000000% |
| −11,786,466 | −11,741,866 | 0.0000000000000% |
| −11,741,864 | −11,697,264 | 0.0000000000000% |
| −11,697,262 | −11,652,662 | 0.0000000000000% |
| −11,652,661 | −11,608,061 | 0.0000000000000% |
| −11,608,059 | −11,563,459 | 0.0000000000000% |
| −11,563,457 | −11,518,857 | 0.0000000000000% |
| −11,518,856 | −11,474,256 | 0.0000000000000% |
| −11,474,254 | −11,429,654 | 0.0000000000000% |
| −11,429,652 | −11,385,052 | 0.0000000000000% |
| −11,385,051 | −11,340,451 | 0.0000000000000% |
| −11,340,449 | −11,295,849 | 0.0000000000000% |
| −11,295,847 | −11,251,247 | 0.0000000000000% |
| −11,251,246 | −11,206,646 | 0.0000000000000% |
| −11,206,644 | −11,162,044 | 0.0000000000000% |
| −11,162,042 | −11,117,442 | 0.0000000000000% |
| −11,117,441 | −11,072,841 | 0.0000000000000% |
| −11,072,839 | −11,028,239 | 0.0000000000000% |
| −11,028,237 | −10,983,637 | 0.0000000000000% |
| −10,983,636 | −10,939,036 | 0.0000000000000% |
| −10,939,034 | −10,894,434 | 0.0000000000000% |
| −10,894,432 | −10,849,832 | 0.0000000000000% |
| −10,849,831 | −10,805,231 | 0.0000000000000% |
| −10,805,229 | −10,760,629 | 0.0000000000000% |
| −10,760,627 | −10,716,027 | 0.0000000000000% |
| −10,716,026 | −10,671,426 | 0.0000000000000% |
| −10,671,424 | −10,626,824 | 0.0000000000000% |
| −10,626,822 | −10,582,222 | 0.0000000000000% |
| −10,582,221 | −10,537,621 | 0.0000000000000% |
| −10,537,619 | −10,493,019 | 0.0000000000000% |
| −10,493,017 | −10,448,417 | 0.0000000000000% |
| −10,448,415 | −10,403,815 | 0.0000000000000% |
| −10,403,814 | −10,359,214 | 0.0000000000000% |
| −10,359,212 | −10,314,612 | 0.0000000000000% |
| −10,314,610 | −10,270,010 | 0.0000000000000% |
| −10,270,009 | −10,225,409 | 0.0000000000000% |
| −10,225,407 | −10,180,807 | 0.0000000000000% |
| −10,180,805 | −10,136,205 | 0.0000000000000% |
| −10,136,204 | −10,091,604 | 0.0000000000000% |
| −10,091,602 | −10,047,002 | 0.0000000000000% |
| −10,047,000 | −10,002,400 | 0.0000000000000% |
| −10,002,399 | −9,957,799 | 0.0000000000000% |
| −9,957,797 | −9,913,197 | 0.0000000000000% |
| −9,913,195 | −9,868,595 | 0.0000000000000% |
| −9,868,594 | −9,823,994 | 0.0000000000000% |
| −9,823,992 | −9,779,392 | 0.0000000000000% |
| −9,779,390 | −9,734,790 | 0.0000000000000% |
| −9,734,789 | −9,690,189 | 0.0000000000000% |
| −9,690,187 | −9,645,587 | 0.0000000000000% |
| −9,645,585 | −9,600,985 | 0.0000000000000% |
| −9,600,984 | −9,556,384 | 0.0000000000000% |
| −9,556,382 | −9,511,782 | 0.0000000000000% |
| −9,511,780 | −9,467,180 | 0.0000000000000% |
| −9,467,179 | −9,422,579 | 0.0000000000000% |
| −9,422,577 | −9,377,977 | 0.0000000000000% |
| −9,377,975 | −9,333,375 | 0.0000000000000% |
| −9,333,374 | −9,288,774 | 0.0000000000000% |
| −9,288,772 | −9,244,172 | 0.0000000000000% |
| −9,244,170 | −9,199,570 | 0.0000000000000% |
| −9,199,569 | −9,154,969 | 0.0000000000000% |
| −9,154,967 | −9,110,367 | 0.0000000000000% |
| −9,110,365 | −9,065,765 | 0.0000000000000% |
| −9,065,764 | −9,021,164 | 0.0000000000000% |
| −9,021,162 | −8,976,562 | 0.0000000000000% |
| −8,976,560 | −8,931,960 | 0.0000000000000% |
| −8,931,959 | −8,887,359 | 0.0000000000000% |
| −8,887,357 | −8,842,757 | 0.0000000000000% |
| −8,842,755 | −8,798,155 | 0.0000000000000% |
| −8,798,154 | −8,753,554 | 0.0000000000000% |
| −8,753,552 | −8,708,952 | 0.0000000000000% |
| −8,708,950 | −8,664,350 | 0.0000000000000% |
| −8,664,349 | −8,619,749 | 0.0000000000000% |
| −8,619,747 | −8,575,147 | 0.0000000000000% |
| −8,575,145 | −8,530,545 | 0.0000000000000% |
| −8,530,544 | −8,485,944 | 0.0000000000000% |
| −8,485,942 | −8,441,342 | 0.0000000000000% |
| −8,441,340 | −8,396,740 | 0.0000000000000% |
| −8,396,738 | −8,352,138 | 0.0000000000000% |
| −8,352,137 | −8,307,537 | 0.0000000000000% |
| −8,307,535 | −8,262,935 | 0.0000000000000% |
| −8,262,933 | −8,218,333 | 0.0000000000000% |
| −8,218,332 | −8,173,732 | 0.0000000000000% |
| −8,173,730 | −8,129,130 | 0.0000000000000% |
| −8,129,128 | −8,084,528 | 0.0000000000000% |
| −8,084,527 | −8,039,927 | 0.0000000000000% |
| −8,039,925 | −7,995,325 | 0.0000000000000% |
| −7,995,323 | −7,950,723 | 0.0000000000000% |
| −7,950,722 | −7,906,122 | 0.0000000000000% |
| −7,906,120 | −7,861,520 | 0.0000000000000% |
| −7,861,518 | −7,816,918 | 0.0000000000000% |
| −7,816,917 | −7,772,317 | 0.0000000000000% |
| −7,772,315 | −7,727,715 | 0.0000000000000% |
| −7,727,713 | −7,683,113 | 0.0000000000000% |
| −7,683,112 | −7,638,512 | 0.0000000000000% |
| −7,638,510 | −7,593,910 | 0.0000000000000% |
| −7,593,908 | −7,549,308 | 0.0000000000000% |
| −7,549,307 | −7,504,707 | 0.0000000000000% |
| −7,504,705 | −7,460,105 | 0.0000000000000% |
| −7,460,103 | −7,415,503 | 0.0000000000000% |
| −7,415,502 | −7,370,902 | 0.0000000000000% |
| −7,370,900 | −7,326,300 | 0.0000000000000% |
| −7,326,298 | −7,281,698 | 0.0000000000000% |
| −7,281,697 | −7,237,097 | 0.0000000000000% |
| −7,237,095 | −7,192,495 | 0.0000000000000% |
| −7,192,493 | −7,147,893 | 0.0000000000000% |
| −7,147,892 | −7,103,292 | 0.0000000000000% |
| −7,103,290 | −7,058,690 | 0.0000000000000% |
| −7,058,688 | −7,014,088 | 0.0000000000000% |
| −7,014,087 | −6,969,487 | 0.0000000000000% |
| −6,969,485 | −6,924,885 | 0.0000000000000% |
| −6,924,883 | −6,880,283 | 0.0000000000000% |
| −6,880,282 | −6,835,682 | 0.0000000000000% |
| −6,835,680 | −6,791,080 | 0.0000000000000% |
| −6,791,078 | −6,746,478 | 0.0000000000000% |
| −6,746,477 | −6,701,877 | 0.0000000000000% |
| −6,701,875 | −6,657,275 | 0.0000000000000% |
| −6,657,273 | −6,612,673 | 0.0000000000000% |
| −6,612,672 | −6,568,072 | 0.0000000000000% |
| −6,568,070 | −6,523,470 | 0.0000000000000% |
| −6,523,468 | −6,478,868 | 0.0000000000000% |
| −6,478,867 | −6,434,267 | 0.0000000000000% |
| −6,434,265 | −6,389,665 | 0.0000000000000% |
| −6,389,663 | −6,345,063 | 0.0000000000000% |
| −6,345,061 | −6,300,461 | 0.0000000000000% |
| −6,300,460 | −6,255,860 | 0.0000000000000% |
| −6,255,858 | −6,211,258 | 0.0000000000000% |
| −6,211,256 | −6,166,656 | 0.0000000000000% |
| −6,166,655 | −6,122,055 | 0.0000000000000% |
| −6,122,053 | −6,077,453 | 0.0000000000000% |
| −6,077,451 | −6,032,851 | 0.0000000000000% |
| −6,032,850 | −5,988,250 | 0.0000000000000% |
| −5,988,248 | −5,943,648 | 0.0000000000000% |
| −5,943,646 | −5,899,046 | 0.0000000000000% |
| −5,899,045 | −5,854,445 | 0.0000000000000% |
| −5,854,443 | −5,809,843 | 0.0000000000000% |
| −5,809,841 | −5,765,241 | 0.0000000000000% |
| −5,765,240 | −5,720,640 | 0.0000000000000% |
| −5,720,638 | −5,676,038 | 0.0000000000000% |
| −5,676,036 | −5,631,436 | 0.0000000000000% |
| −5,631,435 | −5,586,835 | 0.0000000000000% |
| −5,586,833 | −5,542,233 | 0.0000000000000% |
| −5,542,231 | −5,497,631 | 0.0000000000000% |
| −5,497,630 | −5,453,030 | 0.0000000000000% |
| −5,453,028 | −5,408,428 | 0.0000000000000% |
| −5,408,426 | −5,363,826 | 0.0000000000000% |
| −5,363,825 | −5,319,225 | 0.0000000000000% |
| −5,319,223 | −5,274,623 | 0.0000000000000% |
| −5,274,621 | −5,230,021 | 0.0000000000000% |
| −5,230,020 | −5,185,420 | 0.0000000000000% |
| −5,185,418 | −5,140,818 | 0.0000000000000% |
| −5,140,816 | −5,096,216 | 0.0000000000000% |
| −5,096,215 | −5,051,615 | 0.0000000000000% |
| −5,051,613 | −5,007,013 | 0.0000000000000% |
| −5,007,011 | −4,962,411 | 0.0000000000000% |
| −4,962,410 | −4,917,810 | 0.0000000000000% |
| −4,917,808 | −4,873,208 | 0.0000000000000% |
| −4,873,206 | −4,828,606 | 0.0000000000000% |
| −4,828,605 | −4,784,005 | 0.0000000000000% |
| −4,784,003 | −4,739,403 | 0.0000000000000% |
| −4,739,401 | −4,694,801 | 0.0000000000000% |
| −4,694,800 | −4,650,200 | 0.0000000000000% |
| −4,650,198 | −4,605,598 | 0.0000000000000% |
| −4,605,596 | −4,560,996 | 0.0000000000000% |
| −4,560,995 | −4,516,395 | 0.0000000000000% |
| −4,516,393 | −4,471,793 | 0.0000000000000% |
| −4,471,791 | −4,427,191 | 0.0000000000000% |
| −4,427,190 | −4,382,590 | 0.0000000000000% |
| −4,382,588 | −4,337,988 | 0.0000000000000% |
| −4,337,986 | −4,293,386 | 0.0000000000000% |
| −4,293,384 | −4,248,784 | 0.0000000000000% |
| −4,248,783 | −4,204,183 | 0.0000000000000% |
| −4,204,181 | −4,159,581 | 0.0000000000000% |
| −4,159,579 | −4,114,979 | 0.0000000000000% |
| −4,114,978 | −4,070,378 | 0.0000000000000% |
| −4,070,376 | −4,025,776 | 0.0000000000000% |
| −4,025,774 | −3,981,174 | 0.0000000000000% |
| −3,981,173 | −3,936,573 | 0.0000000000000% |
| −3,936,571 | −3,891,971 | 0.0000000000000% |
| −3,891,969 | −3,847,369 | 0.0000000000000% |
| −3,847,368 | −3,802,768 | 0.0000000000000% |
| −3,802,766 | −3,758,166 | 0.0000000000000% |
| −3,758,164 | −3,713,564 | 0.0000000000000% |
| −3,713,563 | −3,668,963 | 0.0000000000000% |
| −3,668,961 | −3,624,361 | 0.0000000000000% |
| −3,624,359 | −3,579,759 | 0.0000000000000% |
| −3,579,758 | −3,535,158 | 0.0000000000000% |
| −3,535,156 | −3,490,556 | 0.0000000000000% |
| −3,490,554 | −3,445,954 | 0.0000000000000% |
| −3,445,953 | −3,401,353 | 0.0000000000000% |
| −3,401,351 | −3,356,751 | 0.0000000000000% |
| −3,356,749 | −3,312,149 | 0.0000000000000% |
| −3,312,148 | −3,267,548 | 0.0000000000000% |
| −3,267,546 | −3,222,946 | 0.0000000000000% |
| −3,222,944 | −3,178,344 | 0.0000000000000% |
| −3,178,343 | −3,133,743 | 0.0000000000000% |
| −3,133,741 | −3,089,141 | 0.0000000000000% |
| −3,089,139 | −3,044,539 | 0.0000000000000% |
| −3,044,538 | −2,999,938 | 0.0000000000000% |
| −2,999,936 | −2,955,336 | 0.0000000000000% |
| −2,955,334 | −2,910,734 | 0.0000000000000% |
| −2,910,733 | −2,866,133 | 0.0000000000000% |
| −2,866,131 | −2,821,531 | 0.0000000000000% |
| −2,821,529 | −2,776,929 | 0.0000000000002% |
| −2,776,928 | −2,732,328 | 0.0000000000018% |
| −2,732,326 | −2,687,726 | 0.0000000000065% |
| −2,687,724 | −2,643,124 | 0.0000000000219% |
| −2,643,123 | −2,598,523 | 0.0000000001017% |
| −2,598,521 | −2,553,921 | 0.0000000003655% |
| −2,553,919 | −2,509,319 | 0.0000000009832% |
| −2,509,318 | −2,464,718 | 0.0000000027553% |
| −2,464,716 | −2,420,116 | 0.0000000094423% |
| −2,420,114 | −2,375,514 | 0.0000000255127% |
| −2,375,513 | −2,330,913 | 0.0000000583709% |
| −2,330,911 | −2,286,311 | 0.0000002203282% |
| −2,286,309 | −2,241,709 | 0.0000006592008% |
| −2,241,707 | −2,197,107 | 0.0000028514222% |
| −2,197,106 | −2,152,506 | 0.0000049230940% |
| −2,152,504 | −2,107,904 | 0.0000083704808% |
| −2,107,902 | −2,063,302 | 0.0000147843515% |
| −2,063,301 | −2,018,701 | 0.0000260338175% |
| −2,018,699 | −1,974,099 | 0.0000433902708% |
| −1,974,097 | −1,929,497 | 0.0000751494837% |
| −1,929,496 | −1,884,896 | 0.0001174352047% |
| −1,884,894 | −1,840,294 | 0.0002107401227% |
| −1,840,292 | −1,795,692 | 0.0003543454910% |
| −1,795,691 | −1,751,091 | 0.0005322695270% |
| −1,751,089 | −1,706,489 | 0.0007929034140% |
| −1,706,487 | −1,661,887 | 0.0011260084372% |
| −1,661,886 | −1,617,286 | 0.0016093991532% |
| −1,617,284 | −1,572,684 | 0.0022344726019% |
| −1,572,682 | −1,528,082 | 0.0038838970629% |
| −1,528,081 | −1,483,481 | 0.0055739683663% |
| −1,483,479 | −1,438,879 | 0.0073772863670% |
| −1,438,877 | −1,394,277 | 0.0098943650295% |
| −1,394,276 | −1,349,676 | 0.0143006184707% |
| −1,349,674 | −1,305,074 | 0.0183460785112% |
| −1,305,072 | −1,260,472 | 0.0261547277456% |
| −1,260,471 | −1,215,871 | 0.0326197573591% |
| −1,215,869 | −1,171,269 | 0.0425953458723% |
| −1,171,267 | −1,126,667 | 0.0532791541028% |
| −1,126,666 | −1,082,066 | 0.0641757265385% |
| −1,082,064 | −1,037,464 | 0.0813017293983% |
| −1,037,462 | −992,862 | 0.1109959473059% |
| −992,861 | −948,261 | 0.1458629976310% |
| −948,259 | −903,659 | 0.1993542936404% |
| −903,657 | −859,057 | 0.2853471413593% |
| −859,056 | −814,456 | 0.3477874325450% |
| −814,454 | −769,854 | 0.4252378540761% |
| −769,852 | −725,252 | 0.5003644927948% |
| −725,251 | −680,651 | 0.6504013874467% |
| −680,649 | −636,049 | 0.7638748188683% |
| −636,047 | −591,447 | 0.9285882632017% |
| −591,446 | −546,846 | 1.1098746419447% |
| −546,844 | −502,244 | 1.2875854315004% |
| −502,242 | −457,642 | 1.6835910404878% |
| −457,641 | −413,041 | 1.9565302556069% |
| −413,039 | −368,439 | 2.3984238127086% |
| −368,437 | −323,837 | 2.9514412946921% |
| −323,836 | −279,236 | 3.4425865251655% |
| −279,234 | −234,634 | 4.3555633509304% |
| −234,632 | −190,032 | 5.0114075306107% |
| −190,030 | −145,430 | 5.6315527250100% |
| −145,429 | −100,829 | 6.8636834340708% |
| −100,827 | −56,227 | 7.7953930073120% |
| −56,225 | −11,625 | 9.6233601880087% |
| −11,624 | 32,976 | 10.7166168500693% |
| 32,978 | 77,578 | 11.9991742114335% |
| 77,580 | 122,180 | 13.5405065877200% |
| 122,181 | 166,781 | 14.8397231105370% |
| 166,783 | 211,383 | 17.2710387405954% |
| 211,385 | 255,985 | 19.1142832254999% |
| 255,986 | 300,586 | 21.6440319572670% |
| 300,588 | 345,188 | 23.6419140520004% |
| 345,190 | 389,790 | 26.1660237764730% |
| 389,791 | 434,391 | 31.6868857458459% |
| 434,393 | 478,993 | 35.4711252066020% |
| 478,995 | 523,595 | 38.5130187980694% |
| 523,596 | 568,196 | 42.0279682320189% |
| 568,198 | 612,798 | 44.8696515698134% |
| 612,800 | 657,400 | 47.4674173810816% |
| 657,401 | 702,001 | 50.3974553776583% |
| 702,003 | 746,603 | 53.0472292653786% |
| 746,605 | 791,205 | 56.4432553966435% |
| 791,206 | 835,806 | 61.3430697312952% |
| 835,808 | 880,408 | 64.2048100657864% |
| 880,410 | 925,010 | 68.8752103906634% |
| 925,011 | 969,611 | 71.6614636000836% |
| 969,613 | 1,014,213 | 74.1731669085254% |
| 1,014,215 | 1,058,815 | 80.1002653117845% |
| 1,058,816 | 1,103,416 | 82.1420889430752% |
| 1,103,418 | 1,148,018 | 83.9004417117022% |
| 1,148,020 | 1,192,620 | 85.8838267577670% |
| 1,192,621 | 1,237,221 | 87.2367841677128% |
| 1,237,223 | 1,281,823 | 88.8625917670604% |
| 1,281,825 | 1,326,425 | 90.3051654466377% |
| 1,326,426 | 1,371,026 | 92.9204530812783% |
| 1,371,028 | 1,415,628 | 93.9405468081542% |
| 1,415,630 | 1,460,230 | 94.8737949872860% |
| 1,460,231 | 1,504,831 | 95.6977286713466% |
| 1,504,833 | 1,549,433 | 96.3011026856639% |
| 1,549,435 | 1,594,035 | 96.9124001310548% |
| 1,594,036 | 1,638,636 | 97.4821645032653% |
| 1,638,638 | 1,683,238 | 97.9746466630464% |
| 1,683,240 | 1,727,840 | 98.7128389094456% |
| 1,727,842 | 1,772,442 | 98.9803293287885% |
| 1,772,443 | 1,817,043 | 99.2617630786270% |
| 1,817,045 | 1,861,645 | 99.4130412604105% |
| 1,861,647 | 1,906,247 | 99.5296821736390% |
| 1,906,248 | 1,950,848 | 99.6899419150264% |
| 1,950,850 | 1,995,450 | 99.7560034168711% |
| 1,995,452 | 2,040,052 | 99.8149077928228% |
| 2,040,053 | 2,084,653 | 99.8578823240910% |
| 2,084,655 | 2,129,255 | 99.8897335086087% |
| 2,129,257 | 2,173,857 | 99.9146184071978% |
| 2,173,858 | 2,218,458 | 99.9387428287191% |
| 2,218,460 | 2,263,060 | 99.9591714611863% |
| 2,263,062 | 2,307,662 | 99.9784510536780% |
| 2,307,663 | 2,352,263 | 99.9856071524159% |
| 2,352,265 | 2,396,865 | 99.9917753707933% |
| 2,396,867 | 2,441,467 | 99.9941766602103% |
| 2,441,468 | 2,486,068 | 99.9958998396849% |
| 2,486,070 | 2,530,670 | 99.9972771437751% |
| 2,530,672 | 2,575,272 | 99.9984679938238% |
| 2,575,273 | 2,619,873 | 99.9989904622893% |
| 2,619,875 | 2,664,475 | 99.9993766063641% |
| 2,664,477 | 2,709,077 | 99.9995756749421% |
| 2,709,078 | 2,753,678 | 99.9997905951318% |
| 2,753,680 | 2,798,280 | 99.9998693701572% |
| 2,798,282 | 2,842,882 | 99.9999342176618% |
| 2,842,883 | 2,887,483 | 99.9999677509958% |
| 2,887,485 | 2,932,085 | 99.9999817757014% |
| 2,932,087 | 2,976,687 | 99.9999893038224% |
| 2,976,688 | 3,021,288 | 99.9999957381375% |
| 3,021,290 | 3,065,890 | 99.9999977033306% |
| 3,065,892 | 3,110,492 | 99.9999989187910% |
| 3,110,493 | 3,155,093 | 99.9999996001808% |
| 3,155,095 | 3,199,695 | 99.9999998600271% |
| 3,199,697 | 3,244,297 | 99.9999999290552% |
| 3,244,298 | 3,288,898 | 99.9999999643476% |
| 3,288,900 | 3,333,500 | 99.9999999844579% |
| 3,333,502 | 3,378,102 | 99.9999999936512% |
| 3,378,103 | 3,422,703 | 99.9999999972243% |
| 3,422,705 | 3,467,305 | 99.9999999993124% |
| 3,467,307 | 3,511,907 | 99.9999999996973% |
| 3,511,908 | 3,556,508 | 99.9999999999067% |
| 3,556,510 | 3,601,110 | 99.9999999999658% |
| 3,601,112 | 3,645,712 | 99.9999999999881% |
| 3,645,713 | 3,690,313 | 99.9999999999996% |
| 3,690,315 | 3,734,915 | 100.0000000000000% |
| 3,734,917 | 3,779,517 | 100.0000000000000% |
| 3,779,519 | 3,824,119 | 100.0000000000000% |
| 3,824,120 | 3,868,720 | 100.0000000000000% |
| 3,868,722 | 3,913,322 | 100.0000000000000% |
| 3,913,324 | 3,957,924 | 100.0000000000000% |
| 3,957,925 | 4,002,525 | 100.0000000000000% |

Sample Data Set B
Table of Outcome Intervals

| | |
|---|---|
| Outcome Intervals | Outcomes Intervals |

| From | To | As % Of All Outcomes |
|---|---|---|
| −6,189,219 | −6,180,391 | 0.0000000000000% |
| −6,180,391 | −6,171,563 | 0.0000000000000% |
| −6,171,563 | −6,162,735 | 0.0000000000000% |
| −6,162,736 | −6,153,908 | 0.0000000000000% |
| −6,153,908 | −6,145,080 | 0.0000000000000% |
| −6,145,080 | −6,136,252 | 0.0000000000000% |
| −6,136,252 | −6,127,424 | 0.0000000000000% |
| −6,127,424 | −6,118,596 | 0.0000000000000% |
| −6,118,597 | −6,109,769 | 0.0000000000000% |
| −6,109,769 | −6,100,941 | 0.0000000000000% |
| −6,100,941 | −6,092,113 | 0.0000000000000% |
| −6,092,113 | −6,083,285 | 0.0000000000000% |
| −6,083,285 | −6,074,457 | 0.0000000000000% |
| −6,074,458 | −6,065,630 | 0.0000000000000% |
| −6,065,630 | −6,056,802 | 0.0000000000000% |
| −6,056,802 | −6,047,974 | 0.0000000000000% |
| −6,047,974 | −6,039,146 | 0.0000000000000% |
| −6,039,146 | −6,030,318 | 0.0000000000000% |
| −6,030,319 | −6,021,491 | 0.0000000000000% |
| −6,021,491 | −6,012,663 | 0.0000000000000% |
| −6,012,663 | −6,003,835 | 0.0000000000000% |
| −6,003,835 | −5,995,007 | 0.0000000000000% |
| −5,995,007 | −5,986,179 | 0.0000000000000% |
| −5,986,180 | −5,977,352 | 0.0000000000000% |
| −5,977,352 | −5,968,524 | 0.0000000000000% |
| −5,968,524 | −5,959,696 | 0.0000000000000% |
| −5,959,696 | −5,950,868 | 0.0000000000000% |
| −5,950,868 | −5,942,040 | 0.0000000000000% |
| −5,942,041 | −5,933,213 | 0.0000000000000% |
| −5,933,213 | −5,924,385 | 0.0000000000000% |
| −5,924,385 | −5,915,557 | 0.0000000000000% |
| −5,915,557 | −5,906,729 | 0.0000000000000% |
| −5,906,730 | −5,897,902 | 0.0000000000000% |
| −5,897,902 | −5,889,074 | 0.0000000000000% |
| −5,889,074 | −5,880,246 | 0.0000000000000% |
| −5,880,246 | −5,871,418 | 0.0000000000000% |
| −5,871,418 | −5,862,590 | 0.0000000000000% |
| −5,862,591 | −5,853,763 | 0.0000000000000% |
| −5,853,763 | −5,844,935 | 0.0000000000000% |
| −5,844,935 | −5,836,107 | 0.0000000000000% |
| −5,836,107 | −5,827,279 | 0.0000000000000% |
| −5,827,279 | −5,818,451 | 0.0000000000000% |
| −5,818,452 | −5,809,624 | 0.0000000000000% |
| −5,809,624 | −5,800,796 | 0.0000000000000% |
| −5,800,796 | −5,791,968 | 0.0000000000000% |
| −5,791,968 | −5,783,140 | 0.0000000000000% |
| −5,783,140 | −5,774,312 | 0.0000000000000% |
| −5,774,313 | −5,765,485 | 0.0000000000000% |
| −5,765,485 | −5,756,657 | 0.0000000000000% |
| −5,756,657 | −5,747,829 | 0.0000000000000% |
| −5,747,829 | −5,739,001 | 0.0000000000000% |
| −5,739,001 | −5,730,173 | 0.0000000000000% |
| −5,730,174 | −5,721,346 | 0.0000000000000% |
| −5,721,346 | −5,712,518 | 0.0000000000000% |
| −5,712,518 | −5,703,690 | 0.0000000000000% |
| −5,703,690 | −5,694,862 | 0.0000000000000% |
| −5,694,862 | −5,686,034 | 0.0000000000000% |
| −5,686,035 | −5,677,207 | 0.0000000000000% |
| −5,677,207 | −5,668,379 | 0.0000000000000% |
| −5,668,379 | −5,659,551 | 0.0000000000000% |
| −5,659,551 | −5,650,723 | 0.0000000000000% |
| −5,650,723 | −5,641,895 | 0.0000000000000% |
| −5,641,896 | −5,633,068 | 0.0000000000000% |
| −5,633,068 | −5,624,240 | 0.0000000000000% |
| −5,624,240 | −5,615,412 | 0.0000000000000% |
| −5,615,412 | −5,606,584 | 0.0000000000000% |
| −5,606,584 | −5,597,756 | 0.0000000000000% |
| −5,597,757 | −5,588,929 | 0.0000000000000% |
| −5,588,929 | −5,580,101 | 0.0000000000000% |
| −5,580,101 | −5,571,273 | 0.0000000000000% |
| −5,571,273 | −5,562,445 | 0.0000000000000% |
| −5,562,445 | −5,553,617 | 0.0000000000000% |
| −5,553,618 | −5,544,790 | 0.0000000000000% |
| −5,544,790 | −5,535,962 | 0.0000000000000% |
| −5,535,962 | −5,527,134 | 0.0000000000000% |
| −5,527,134 | −5,518,306 | 0.0000000000000% |
| −5,518,306 | −5,509,478 | 0.0000000000000% |
| −5,509,479 | −5,500,651 | 0.0000000000000% |
| −5,500,651 | −5,491,823 | 0.0000000000000% |
| −5,491,823 | −5,482,995 | 0.0000000000000% |
| −5,482,995 | −5,474,167 | 0.0000000000000% |
| −5,474,167 | −5,465,339 | 0.0000000000000% |
| −5,465,340 | −5,456,512 | 0.0000000000000% |
| −5,456,512 | −5,447,684 | 0.0000000000000% |
| −5,447,684 | −5,438,856 | 0.0000000000000% |
| −5,438,856 | −5,430,028 | 0.0000000000000% |
| −5,430,028 | −5,421,200 | 0.0000000000000% |
| −5,421,201 | −5,412,373 | 0.0000000000000% |
| −5,412,373 | −5,403,545 | 0.0000000000000% |
| −5,403,545 | −5,394,717 | 0.0000000000000% |
| −5,394,717 | −5,385,889 | 0.0000000000000% |
| −5,385,889 | −5,377,061 | 0.0000000000000% |
| −5,377,062 | −5,368,234 | 0.0000000000000% |
| −5,368,234 | −5,359,406 | 0.0000000000000% |
| −5,359,406 | −5,350,578 | 0.0000000000000% |
| −5,350,578 | −5,341,750 | 0.0000000000000% |
| −5,341,750 | −5,332,922 | 0.0000000000000% |
| −5,332,923 | −5,324,095 | 0.0000000000000% |
| −5,324,095 | −5,315,267 | 0.0000000000000% |
| −5,315,267 | −5,306,439 | 0.0000000000000% |
| −5,306,439 | −5,297,611 | 0.0000000000000% |
| −5,297,611 | −5,288,783 | 0.0000000000000% |
| −5,288,784 | −5,279,956 | 0.0000000000000% |
| −5,279,956 | −5,271,128 | 0.0000000000000% |
| −5,271,128 | −5,262,300 | 0.0000000000000% |
| −5,262,300 | −5,253,472 | 0.0000000000000% |
| −5,253,472 | −5,244,644 | 0.0000000000000% |
| −5,244,645 | −5,235,817 | 0.0000000000000% |
| −5,235,817 | −5,226,989 | 0.0000000000000% |
| −5,226,989 | −5,218,161 | 0.0000000000000% |
| −5,218,161 | −5,209,333 | 0.0000000000000% |
| −5,209,333 | −5,200,505 | 0.0000000000000% |
| −5,200,506 | −5,191,678 | 0.0000000000000% |
| −5,191,678 | −5,182,850 | 0.0000000000000% |
| −5,182,850 | −5,174,022 | 0.0000000000000% |
| −5,174,022 | −5,165,194 | 0.0000000000000% |
| −5,165,194 | −5,156,366 | 0.0000000000000% |
| −5,156,367 | −5,147,539 | 0.0000000000000% |
| −5,147,539 | −5,138,711 | 0.0000000000000% |
| −5,138,711 | −5,129,883 | 0.0000000000000% |
| −5,129,883 | −5,121,055 | 0.0000000000000% |
| −5,121,055 | −5,112,227 | 0.0000000000000% |
| −5,112,228 | −5,103,400 | 0.0000000000000% |
| −5,103,400 | −5,094,572 | 0.0000000000000% |
| −5,094,572 | −5,085,744 | 0.0000000000000% |
| −5,085,744 | −5,076,916 | 0.0000000000000% |
| −5,076,917 | −5,068,089 | 0.0000000000000% |
| −5,068,089 | −5,059,261 | 0.0000000000000% |
| −5,059,261 | −5,050,433 | 0.0000000000000% |
| −5,050,433 | −5,041,605 | 0.0000000000000% |
| −5,041,605 | −5,032,777 | 0.0000000000000% |
| −5,032,778 | −5,023,950 | 0.0000000000000% |
| −5,023,950 | −5,015,122 | 0.0000000000000% |
| −5,015,122 | −5,006,294 | 0.0000000000000% |
| −5,006,294 | −4,997,466 | 0.0000000000000% |
| −4,997,466 | −4,988,638 | 0.0000000000000% |
| −4,988,639 | −4,979,811 | 0.0000000000000% |
| −4,979,811 | −4,970,983 | 0.0000000000000% |
| −4,970,983 | −4,962,155 | 0.0000000000000% |
| −4,962,155 | −4,953,327 | 0.0000000000000% |
| −4,953,327 | −4,944,499 | 0.0000000000000% |
| −4,944,500 | −4,935,672 | 0.0000000000000% |
| −4,935,672 | −4,926,844 | 0.0000000000000% |
| −4,926,844 | −4,918,016 | 0.0000000000000% |
| −4,918,016 | −4,909,188 | 0.0000000000000% |
| −4,909,188 | −4,900,360 | 0.0000000000000% |
| −4,900,361 | −4,891,533 | 0.0000000000000% |
| −4,891,533 | −4,882,705 | 0.0000000000000% |
| −4,882,705 | −4,873,877 | 0.0000000000000% |
| −4,873,877 | −4,865,049 | 0.0000000000000% |
| −4,865,049 | −4,856,221 | 0.0000000000000% |
| −4,856,222 | −4,847,394 | 0.0000000000000% |
| −4,847,394 | −4,838,566 | 0.0000000000000% |
| −4,838,566 | −4,829,738 | 0.0000000000000% |
| −4,829,738 | −4,820,910 | 0.0000000000000% |
| −4,820,910 | −4,812,082 | 0.0000000000000% |
| −4,812,083 | −4,803,255 | 0.0000000000000% |
| −4,803,255 | −4,794,427 | 0.0000000000000% |
| −4,794,427 | −4,785,599 | 0.0000000000000% |
| −4,785,599 | −4,776,771 | 0.0000000000000% |
| −4,776,771 | −4,767,943 | 0.0000000000000% |
| −4,767,944 | −4,759,116 | 0.0000000000000% |
| −4,759,116 | −4,750,288 | 0.0000000000000% |
| −4,750,288 | −4,741,460 | 0.0000000000000% |
| −4,741,460 | −4,732,632 | 0.0000000000000% |
| −4,732,632 | −4,723,804 | 0.0000000000000% |
| −4,723,805 | −4,714,977 | 0.0000000000000% |
| −4,714,977 | −4,706,149 | 0.0000000000000% |
| −4,706,149 | −4,697,321 | 0.0000000000000% |
| −4,697,321 | −4,688,493 | 0.0000000000000% |
| −4,688,493 | −4,679,665 | 0.0000000000000% |
| −4,679,666 | −4,670,838 | 0.0000000000000% |
| −4,670,838 | −4,662,010 | 0.0000000000000% |
| −4,662,010 | −4,653,182 | 0.0000000000000% |
| −4,653,182 | −4,644,354 | 0.0000000000000% |
| −4,644,354 | −4,635,526 | 0.0000000000000% |
| −4,635,527 | −4,626,699 | 0.0000000000000% |
| −4,626,699 | −4,617,871 | 0.0000000000000% |
| −4,617,871 | −4,609,043 | 0.0000000000000% |
| −4,609,043 | −4,600,215 | 0.0000000000000% |
| −4,600,215 | −4,591,387 | 0.0000000000000% |
| −4,591,388 | −4,582,560 | 0.0000000000000% |
| −4,582,560 | −4,573,732 | 0.0000000000000% |
| −4,573,732 | −4,564,904 | 0.0000000000000% |
| −4,564,904 | −4,556,076 | 0.0000000000000% |
| −4,556,076 | −4,547,248 | 0.0000000000000% |
| −4,547,249 | −4,538,421 | 0.0000000000000% |
| −4,538,421 | −4,529,593 | 0.0000000000000% |
| −4,529,593 | −4,520,765 | 0.0000000000000% |
| −4,520,765 | −4,511,937 | 0.0000000000000% |
| −4,511,937 | −4,503,109 | 0.0000000000000% |
| −4,503,110 | −4,494,282 | 0.0000000000000% |
| −4,494,282 | −4,485,454 | 0.0000000000000% |
| −4,485,454 | −4,476,626 | 0.0000000000000% |
| −4,476,626 | −4,467,798 | 0.0000000000000% |
| −4,467,798 | −4,458,970 | 0.0000000000000% |
| −4,458,971 | −4,450,143 | 0.0000000000000% |
| −4,450,143 | −4,441,315 | 0.0000000000000% |
| −4,441,315 | −4,432,487 | 0.0000000000000% |
| −4,432,487 | −4,423,659 | 0.0000000000000% |
| −4,423,659 | −4,414,831 | 0.0000000000000% |
| −4,414,832 | −4,406,004 | 0.0000000000000% |
| −4,406,004 | −4,397,176 | 0.0000000000000% |
| −4,397,176 | −4,388,348 | 0.0000000000000% |
| −4,388,348 | −4,379,520 | 0.0000000000000% |
| −4,379,520 | −4,370,692 | 0.0000000000000% |
| −4,370,693 | −4,361,865 | 0.0000000000000% |
| −4,361,865 | −4,353,037 | 0.0000000000000% |
| −4,353,037 | −4,344,209 | 0.0000000000000% |
| −4,344,209 | −4,335,381 | 0.0000000000000% |
| −4,335,381 | −4,326,553 | 0.0000000000000% |
| −4,326,554 | −4,317,726 | 0.0000000000000% |
| −4,317,726 | −4,308,898 | 0.0000000000000% |
| −4,308,898 | −4,300,070 | 0.0000000000000% |
| −4,300,070 | −4,291,242 | 0.0000000000000% |
| −4,291,242 | −4,282,414 | 0.0000000000000% |
| −4,282,415 | −4,273,587 | 0.0000000000000% |
| −4,273,587 | −4,264,759 | 0.0000000000000% |
| −4,264,759 | −4,255,931 | 0.0000000000000% |
| −4,255,931 | −4,247,103 | 0.0000000000000% |
| −4,247,103 | −4,238,275 | 0.0000000000000% |
| −4,238,276 | −4,229,448 | 0.0000000000000% |
| −4,229,448 | −4,220,620 | 0.0000000000000% |
| −4,220,620 | −4,211,792 | 0.0000000000000% |
| −4,211,792 | −4,202,964 | 0.0000000000000% |
| −4,202,965 | −4,194,137 | 0.0000000000000% |
| −4,194,137 | −4,185,309 | 0.0000000000000% |
| −4,185,309 | −4,176,481 | 0.0000000000000% |
| −4,176,481 | −4,167,653 | 0.0000000000000% |
| −4,167,653 | −4,158,825 | 0.0000000000000% |
| −4,158,826 | −4,149,998 | 0.0000000000000% |
| −4,149,998 | −4,141,170 | 0.0000000000000% |
| −4,141,170 | −4,132,342 | 0.0000000000000% |
| −4,132,342 | −4,123,514 | 0.0000000000000% |
| −4,123,514 | −4,114,686 | 0.0000000000000% |
| −4,114,687 | −4,105,859 | 0.0000000000000% |
| −4,105,859 | −4,097,031 | 0.0000000000000% |
| −4,097,031 | −4,088,203 | 0.0000000000000% |
| −4,088,203 | −4,079,375 | 0.0000000000000% |
| −4,079,375 | −4,070,547 | 0.0000000000000% |
| −4,070,548 | −4,061,720 | 0.0000000000000% |
| −4,061,720 | −4,052,892 | 0.0000000000000% |
| −4,052,892 | −4,044,064 | 0.0000000000000% |
| −4,044,064 | −4,035,236 | 0.0000000000000% |
| −4,035,236 | −4,026,408 | 0.0000000000000% |
| −4,026,409 | −4,017,581 | 0.0000000000000% |
| −4,017,581 | −4,008,753 | 0.0000000000000% |
| −4,008,753 | −3,999,925 | 0.0000000000000% |
| −3,999,925 | −3,991,097 | 0.0000000000000% |
| −3,991,097 | −3,982,269 | 0.0000000000000% |
| −3,982,270 | −3,973,442 | 0.0000000000000% |
| −3,973,442 | −3,964,614 | 0.0000000000000% |
| −3,964,614 | −3,955,786 | 0.0000000000000% |
| −3,955,786 | −3,946,958 | 0.0000000000000% |
| −3,946,958 | −3,938,130 | 0.0000000000000% |
| −3,938,131 | −3,929,303 | 0.0000000000000% |
| −3,929,303 | −3,920,475 | 0.0000000000000% |
| −3,920,475 | −3,911,647 | 0.0000000000000% |
| −3,911,647 | −3,902,819 | 0.0000000000000% |
| −3,902,819 | −3,893,991 | 0.0000000000000% |
| −3,893,992 | −3,885,164 | 0.0000000000000% |
| −3,885,164 | −3,876,336 | 0.0000000000000% |
| −3,876,336 | −3,867,508 | 0.0000000000000% |
| −3,867,508 | −3,858,680 | 0.0000000000000% |
| −3,858,680 | −3,849,852 | 0.0000000000000% |
| −3,849,853 | −3,841,025 | 0.0000000000000% |
| −3,841,025 | −3,832,197 | 0.0000000000000% |
| −3,832,197 | −3,823,369 | 0.0000000000000% |
| −3,823,369 | −3,814,541 | 0.0000000000000% |
| −3,814,541 | −3,805,713 | 0.0000000000000% |
| −3,805,714 | −3,796,886 | 0.0000000000000% |
| −3,796,886 | −3,788,058 | 0.0000000000000% |
| −3,788,058 | −3,779,230 | 0.0000000000000% |
| −3,779,230 | −3,770,402 | 0.0000000000000% |
| −3,770,402 | −3,761,574 | 0.0000000000000% |
| −3,761,575 | −3,752,747 | 0.0000000000000% |
| −3,752,747 | −3,743,919 | 0.0000000000000% |
| −3,743,919 | −3,735,091 | 0.0000000000000% |
| −3,735,091 | −3,726,263 | 0.0000000000000% |
| −3,726,263 | −3,717,435 | 0.0000000000000% |
| −3,717,436 | −3,708,608 | 0.0000000000000% |
| −3,708,608 | −3,699,780 | 0.0000000000000% |
| −3,699,780 | −3,690,952 | 0.0000000000000% |
| −3,690,952 | −3,682,124 | 0.0000000000000% |
| −3,682,124 | −3,673,296 | 0.0000000000000% |
| −3,673,297 | −3,664,469 | 0.0000000000000% |
| −3,664,469 | −3,655,641 | 0.0000000000000% |
| −3,655,641 | −3,646,813 | 0.0000000000000% |
| −3,646,813 | −3,637,985 | 0.0000000000000% |
| −3,637,985 | −3,629,157 | 0.0000000000000% |
| −3,629,158 | −3,620,330 | 0.0000000000000% |
| −3,620,330 | −3,611,502 | 0.0000000000000% |
| −3,611,502 | −3,602,674 | 0.0000000000000% |
| −3,602,674 | −3,593,846 | 0.0000000000000% |
| −3,593,846 | −3,585,018 | 0.0000000000000% |
| −3,585,019 | −3,576,191 | 0.0000000000000% |
| −3,576,191 | −3,567,363 | 0.0000000000000% |
| −3,567,363 | −3,558,535 | 0.0000000000000% |
| −3,558,535 | −3,549,707 | 0.0000000000000% |
| −3,549,707 | −3,540,879 | 0.0000000000000% |
| −3,540,880 | −3,532,052 | 0.0000000000000% |
| −3,532,052 | −3,523,224 | 0.0000000000000% |
| −3,523,224 | −3,514,396 | 0.0000000000000% |
| −3,514,396 | −3,505,568 | 0.0000000000000% |
| −3,505,568 | −3,496,740 | 0.0000000000000% |
| −3,496,741 | −3,487,913 | 0.0000000000000% |
| −3,487,913 | −3,479,085 | 0.0000000000000% |
| −3,479,085 | −3,470,257 | 0.0000000000000% |
| −3,470,257 | −3,461,429 | 0.0000000000000% |
| −3,461,429 | −3,452,601 | 0.0000000000000% |
| −3,452,602 | −3,443,774 | 0.0000000000000% |
| −3,443,774 | −3,434,946 | 0.0000000000000% |
| −3,434,946 | −3,426,118 | 0.0000000000000% |
| −3,426,118 | −3,417,290 | 0.0000000000000% |
| −3,417,290 | −3,408,462 | 0.0000000000000% |
| −3,408,463 | −3,399,635 | 0.0000000000000% |
| −3,399,635 | −3,390,807 | 0.0000000000000% |
| −3,390,807 | −3,381,979 | 0.0000000000000% |
| −3,381,979 | −3,373,151 | 0.0000000000000% |
| −3,373,152 | −3,364,324 | 0.0000000000000% |
| −3,364,324 | −3,355,496 | 0.0000000000000% |
| −3,355,496 | −3,346,668 | 0.0000000000000% |
| −3,346,668 | −3,337,840 | 0.0000000000000% |
| −3,337,840 | −3,329,012 | 0.0000000000000% |
| −3,329,013 | −3,320,185 | 0.0000000000000% |
| −3,320,185 | −3,311,357 | 0.0000000000000% |
| −3,311,357 | −3,302,529 | 0.0000000000000% |
| −3,302,529 | −3,293,701 | 0.0000000000000% |
| −3,293,701 | −3,284,873 | 0.0000000000000% |
| −3,284,874 | −3,276,046 | 0.0000000000000% |
| −3,276,046 | −3,267,218 | 0.0000000000000% |
| −3,267,218 | −3,258,390 | 0.0000000000000% |
| −3,258,390 | −3,249,562 | 0.0000000000000% |
| −3,249,562 | −3,240,734 | 0.0000000000000% |
| −3,240,735 | −3,231,907 | 0.0000000000000% |
| −3,231,907 | −3,223,079 | 0.0000000000000% |
| −3,223,079 | −3,214,251 | 0.0000000000000% |
| −3,214,251 | −3,205,423 | 0.0000000000000% |
| −3,205,423 | −3,196,595 | 0.0000000000000% |
| −3,196,596 | −3,187,768 | 0.0000000000000% |
| −3,187,768 | −3,178,940 | 0.0000000000000% |
| −3,178,940 | −3,170,112 | 0.0000000000000% |
| −3,170,112 | −3,161,284 | 0.0000000000000% |
| −3,161,284 | −3,152,456 | 0.0000000000000% |
| −3,152,457 | −3,143,629 | 0.0000000000000% |
| −3,143,629 | −3,134,801 | 0.0000000000000% |
| −3,134,801 | −3,125,973 | 0.0000000000000% |
| −3,125,973 | −3,117,145 | 0.0000000000000% |
| −3,117,145 | −3,108,317 | 0.0000000000000% |
| −3,108,318 | −3,099,490 | 0.0000000000000% |
| −3,099,490 | −3,090,662 | 0.0000000000000% |
| −3,090,662 | −3,081,834 | 0.0000000000000% |
| −3,081,834 | −3,073,006 | 0.0000000000000% |
| −3,073,006 | −3,064,178 | 0.0000000000000% |
| −3,064,179 | −3,055,351 | 0.0000000000000% |
| −3,055,351 | −3,046,523 | 0.0000000000000% |
| −3,046,523 | −3,037,695 | 0.0000000000000% |
| −3,037,695 | −3,028,867 | 0.0000000000000% |
| −3,028,867 | −3,020,039 | 0.0000000000000% |
| −3,020,040 | −3,011,212 | 0.0000000000000% |
| −3,011,212 | −3,002,384 | 0.0000000000000% |
| −3,002,384 | −2,993,556 | 0.0000000000000% |
| −2,993,556 | −2,984,728 | 0.0000000000000% |
| −2,984,728 | −2,975,900 | 0.0000000000000% |
| −2,975,901 | −2,967,073 | 0.0000000000000% |
| −2,967,073 | −2,958,245 | 0.0000000000000% |
| −2,958,245 | −2,949,417 | 0.0000000000000% |
| −2,949,417 | −2,940,589 | 0.0000000000000% |
| −2,940,589 | −2,931,761 | 0.0000000000000% |
| −2,931,762 | −2,922,934 | 0.0000000000000% |
| −2,922,934 | −2,914,106 | 0.0000000000000% |
| −2,914,106 | −2,905,278 | 0.0000000000000% |
| −2,905,278 | −2,896,450 | 0.0000000000000% |
| −2,896,450 | −2,887,622 | 0.0000000000000% |
| −2,887,623 | −2,878,795 | 0.0000000000000% |
| −2,878,795 | −2,869,967 | 0.0000000000000% |
| −2,869,967 | −2,861,139 | 0.0000000000000% |
| −2,861,139 | −2,852,311 | 0.0000000000000% |
| −2,852,311 | −2,843,483 | 0.0000000000000% |
| −2,843,484 | −2,834,656 | 0.0000000000000% |
| −2,834,656 | −2,825,828 | 0.0000000000000% |
| −2,825,828 | −2,817,000 | 0.0000000000000% |
| −2,817,000 | −2,808,172 | 0.0000000000000% |
| −2,808,172 | −2,799,344 | 0.0000000000000% |
| −2,799,345 | −2,790,517 | 0.0000000000000% |
| −2,790,517 | −2,781,689 | 0.0000000000000% |
| −2,781,689 | −2,772,861 | 0.0000000000000% |
| −2,772,861 | −2,764,033 | 0.0000000000000% |
| −2,764,033 | −2,755,205 | 0.0000000000000% |
| −2,755,206 | −2,746,378 | 0.0000000000000% |
| −2,746,378 | −2,737,550 | 0.0000000000000% |
| −2,737,550 | −2,728,722 | 0.0000000000000% |
| −2,728,722 | −2,719,894 | 0.0000000000000% |
| −2,719,894 | −2,711,066 | 0.0000000000000% |
| −2,711,067 | −2,702,239 | 0.0000000000000% |
| −2,702,239 | −2,693,411 | 0.0000000000000% |
| −2,693,411 | −2,684,583 | 0.0000000000000% |
| −2,684,583 | −2,675,755 | 0.0000000000000% |
| −2,675,755 | −2,666,927 | 0.0000000000000% |
| −2,666,928 | −2,658,100 | 0.0000000000000% |
| −2,658,100 | −2,649,272 | 0.0000000000000% |
| −2,649,272 | −2,640,444 | 0.0000000000000% |
| −2,640,444 | −2,631,616 | 0.0000000000000% |
| −2,631,616 | −2,622,788 | 0.0000000000000% |
| −2,622,789 | −2,613,961 | 0.0000000000000% |
| −2,613,961 | −2,605,133 | 0.0000000000000% |
| −2,605,133 | −2,596,305 | 0.0000000000000% |
| −2,596,305 | −2,587,477 | 0.0000000000000% |
| −2,587,477 | −2,578,649 | 0.0000000000000% |
| −2,578,650 | −2,569,822 | 0.0000000000000% |
| −2,569,822 | −2,560,994 | 0.0000000000000% |
| −2,560,994 | −2,552,166 | 0.0000000000000% |
| −2,552,166 | −2,543,338 | 0.0000000000000% |
| −2,543,338 | −2,534,510 | 0.0000000000000% |
| −2,534,511 | −2,525,683 | 0.0000000000000% |
| −2,525,683 | −2,516,855 | 0.0000000000000% |
| −2,516,855 | −2,508,027 | 0.0000000000000% |
| −2,508,027 | −2,499,199 | 0.0000000000000% |
| −2,499,200 | −2,490,372 | 0.0000000000000% |
| −2,490,372 | −2,481,544 | 0.0000000000000% |
| −2,481,544 | −2,472,716 | 0.0000000000000% |
| −2,472,716 | −2,463,888 | 0.0000000000000% |
| −2,463,888 | −2,455,060 | 0.0000000000000% |
| −2,455,061 | −2,446,233 | 0.0000000000000% |
| −2,446,233 | −2,437,405 | 0.0000000000000% |
| −2,437,405 | −2,428,577 | 0.0000000000000% |
| −2,428,577 | −2,419,749 | 0.0000000000000% |
| −2,419,749 | −2,410,921 | 0.0000000000000% |
| −2,410,922 | −2,402,094 | 0.0000000000000% |
| −2,402,094 | −2,393,266 | 0.0000000000000% |
| −2,393,266 | −2,384,438 | 0.0000000000000% |
| −2,384,438 | −2,375,610 | 0.0000000000000% |
| −2,375,610 | −2,366,782 | 0.0000000000000% |
| −2,366,783 | −2,357,955 | 0.0000000000000% |
| −2,357,955 | −2,349,127 | 0.0000000000000% |
| −2,349,127 | −2,340,299 | 0.0000000000000% |
| −2,340,299 | −2,331,471 | 0.0000000000000% |
| −2,331,471 | −2,322,643 | 0.0000000000000% |
| −2,322,644 | −2,313,816 | 0.0000000000000% |
| −2,313,816 | −2,304,988 | 0.0000000000000% |
| −2,304,988 | −2,296,160 | 0.0000000000000% |
| −2,296,160 | −2,287,332 | 0.0000000000000% |
| −2,287,332 | −2,278,504 | 0.0000000000000% |
| −2,278,505 | −2,269,677 | 0.0000000000000% |
| −2,269,677 | −2,260,849 | 0.0000000000000% |
| −2,260,849 | −2,252,021 | 0.0000000000000% |
| −2,252,021 | −2,243,193 | 0.0000000000000% |
| −2,243,193 | −2,234,365 | 0.0000000000000% |
| −2,234,366 | −2,225,538 | 0.0000000000000% |
| −2,225,538 | −2,216,710 | 0.0000000000000% |
| −2,216,710 | −2,207,882 | 0.0000000000000% |
| −2,207,882 | −2,199,054 | 0.0000000000000% |
| −2,199,054 | −2,190,226 | 0.0000000000000% |
| −2,190,227 | −2,181,399 | 0.0000000000000% |
| −2,181,399 | −2,172,571 | 0.0000000000000% |
| −2,172,571 | −2,163,743 | 0.0000000000000% |
| −2,163,743 | −2,154,915 | 0.0000000000000% |
| −2,154,915 | −2,146,087 | 0.0000000000000% |
| −2,146,088 | −2,137,260 | 0.0000000000000% |
| −2,137,260 | −2,128,432 | 0.0000000000000% |
| −2,128,432 | −2,119,604 | 0.0000000000000% |
| −2,119,604 | −2,110,776 | 0.0000000000000% |
| −2,110,776 | −2,101,948 | 0.0000000000000% |
| −2,101,949 | −2,093,121 | 0.0000000000000% |
| −2,093,121 | −2,084,293 | 0.0000000000000% |
| −2,084,293 | −2,075,465 | 0.0000000000000% |
| −2,075,465 | −2,066,637 | 0.0000000000000% |
| −2,066,637 | −2,057,809 | 0.0000000000000% |
| −2,057,810 | −2,048,982 | 0.0000000000000% |
| −2,048,982 | −2,040,154 | 0.0000000000000% |
| −2,040,154 | −2,031,326 | 0.0000000000000% |
| −2,031,326 | −2,022,498 | 0.0000000000000% |
| −2,022,498 | −2,013,670 | 0.0000000000000% |
| −2,013,671 | −2,004,843 | 0.0000000000000% |
| −2,004,843 | −1,996,015 | 0.0000000000000% |
| −1,996,015 | −1,987,187 | 0.0000000000000% |
| −1,987,187 | −1,978,359 | 0.0000000000000% |
| −1,978,359 | −1,969,531 | 0.0000000000000% |
| −1,969,532 | −1,960,704 | 0.0000000000000% |
| −1,960,704 | −1,951,876 | 0.0000000000000% |
| −1,951,876 | −1,943,048 | 0.0000000000000% |
| −1,943,048 | −1,934,220 | 0.0000000000000% |
| −1,934,220 | −1,925,392 | 0.0000000000000% |
| −1,925,393 | −1,916,565 | 0.0000000000000% |
| −1,916,565 | −1,907,737 | 0.0000000000000% |
| −1,907,737 | −1,898,909 | 0.0000000000000% |
| −1,898,909 | −1,890,081 | 0.0000000000000% |
| −1,890,081 | −1,881,253 | 0.0000000000000% |
| −1,881,254 | −1,872,426 | 0.0000000000000% |
| −1,872,426 | −1,863,598 | 0.0000000000000% |
| −1,863,598 | −1,854,770 | 0.0000000000000% |
| −1,854,770 | −1,845,942 | 0.0000000000000% |
| −1,845,942 | −1,837,114 | 0.0000000000000% |
| −1,837,115 | −1,828,287 | 0.0000000000000% |
| −1,828,287 | −1,819,459 | 0.0000000000000% |
| −1,819,459 | −1,810,631 | 0.0000000000000% |
| −1,810,631 | −1,801,803 | 0.0000000000000% |
| −1,801,803 | −1,792,975 | 0.0000000000000% |
| −1,792,976 | −1,784,148 | 0.0000000000000% |
| −1,784,148 | −1,775,320 | 0.0000000000000% |
| −1,775,320 | −1,766,492 | 0.0000000000000% |
| −1,766,492 | −1,757,664 | 0.0000000000000% |
| −1,757,664 | −1,748,836 | 0.0000000000000% |
| −1,748,837 | −1,740,009 | 0.0000000000000% |
| −1,740,009 | −1,731,181 | 0.0000000000000% |
| −1,731,181 | −1,722,353 | 0.0000000000000% |
| −1,722,353 | −1,713,525 | 0.0000000000000% |
| −1,713,525 | −1,704,697 | 0.0000000000000% |
| −1,704,698 | −1,695,870 | 0.0000000000000% |
| −1,695,870 | −1,687,042 | 0.0000000000000% |
| −1,687,042 | −1,678,214 | 0.0000000000000% |
| −1,678,214 | −1,669,386 | 0.0000000000000% |
| −1,669,387 | −1,660,559 | 0.0000000000000% |
| −1,660,559 | −1,651,731 | 0.0000000000000% |
| −1,651,731 | −1,642,903 | 0.0000000000000% |
| −1,642,903 | −1,634,075 | 0.0000000000000% |
| −1,634,075 | −1,625,247 | 0.0000000000000% |
| −1,625,248 | −1,616,420 | 0.0000000000000% |
| −1,616,420 | −1,607,592 | 0.0000000000000% |
| −1,607,592 | −1,598,764 | 0.0000000000000% |
| −1,598,764 | −1,589,936 | 0.0000000000000% |
| −1,589,936 | −1,581,108 | 0.0000000000000% |
| −1,581,109 | −1,572,281 | 0.0000000000000% |
| −1,572,281 | −1,563,453 | 0.0000000000000% |
| −1,563,453 | −1,554,625 | 0.0000000000000% |
| −1,554,625 | −1,545,797 | 0.0000000000000% |
| −1,545,797 | −1,536,969 | 0.0000000000000% |
| −1,536,970 | −1,528,142 | 0.0000000000000% |
| −1,528,142 | −1,519,314 | 0.0000000000000% |
| −1,519,314 | −1,510,486 | 0.0000000000000% |
| −1,510,486 | −1,501,658 | 0.0000000000000% |
| −1,501,658 | −1,492,830 | 0.0000000000000% |
| −1,492,831 | −1,484,003 | 0.0000000000000% |
| −1,484,003 | −1,475,175 | 0.0000000000000% |
| −1,475,175 | −1,466,347 | 0.0000000000000% |
| −1,466,347 | −1,457,519 | 0.0000000000000% |
| −1,457,519 | −1,448,691 | 0.0000000000000% |
| −1,448,692 | −1,439,864 | 0.0000000000000% |
| −1,439,864 | −1,431,036 | 0.0000000000000% |
| −1,431,036 | −1,422,208 | 0.0000000000000% |
| −1,422,208 | −1,413,380 | 0.0000000000000% |
| −1,413,380 | −1,404,552 | 0.0000000000000% |
| −1,404,553 | −1,395,725 | 0.0000000000000% |
| −1,395,725 | −1,386,897 | 0.0000000000000% |
| −1,386,897 | −1,378,069 | 0.0000000000000% |
| −1,378,069 | −1,369,241 | 0.0000000000000% |
| −1,369,241 | −1,360,413 | 0.0000000000000% |
| −1,360,414 | −1,351,586 | 0.0000000000000% |
| −1,351,586 | −1,342,758 | 0.0000000000000% |
| −1,342,758 | −1,333,930 | 0.0000000000000% |
| −1,333,930 | −1,325,102 | 0.0000000000000% |
| −1,325,102 | −1,316,274 | 0.0000000000000% |
| −1,316,275 | −1,307,447 | 0.0000000000000% |
| −1,307,447 | −1,298,619 | 0.0000000000000% |
| −1,298,619 | −1,289,791 | 0.0000000000000% |
| −1,289,791 | −1,280,963 | 0.0000000000000% |
| −1,280,963 | −1,272,135 | 0.0000000000000% |
| −1,272,136 | −1,263,308 | 0.0000000000000% |
| −1,263,308 | −1,254,480 | 0.0000000000000% |
| −1,254,480 | −1,245,652 | 0.0000000000000% |
| −1,245,652 | −1,236,824 | 0.0000000000000% |
| −1,236,824 | −1,227,996 | 0.0000000000000% |
| −1,227,997 | −1,219,169 | 0.0000000000000% |
| −1,219,169 | −1,210,341 | 0.0000000000000% |
| −1,210,341 | −1,201,513 | 0.0000000000000% |
| −1,201,513 | −1,192,685 | 0.0000000000000% |
| −1,192,685 | −1,183,857 | 0.0000000000000% |
| −1,183,858 | −1,175,030 | 0.0000000000000% |
| −1,175,030 | −1,166,202 | 0.0000000000000% |
| −1,166,202 | −1,157,374 | 0.0000000000000% |
| −1,157,374 | −1,148,546 | 0.0000000000000% |
| −1,148,546 | −1,139,718 | 0.0000000000000% |
| −1,139,719 | −1,130,891 | 0.0000000000000% |
| −1,130,891 | −1,122,063 | 0.0000000000000% |
| −1,122,063 | −1,113,235 | 0.0000000000000% |
| −1,113,235 | −1,104,407 | 0.0000000000000% |
| −1,104,407 | −1,095,579 | 0.0000000000000% |
| −1,095,580 | −1,086,752 | 0.0000000000000% |
| −1,086,752 | −1,077,924 | 0.0000000000000% |
| −1,077,924 | −1,069,096 | 0.0000000000000% |
| −1,069,096 | −1,060,268 | 0.0000000000000% |
| −1,060,268 | −1,051,440 | 0.0000000000000% |
| −1,051,441 | −1,042,613 | 0.0000000000000% |
| −1,042,613 | −1,033,785 | 0.0000000000000% |
| −1,033,785 | −1,024,957 | 0.0000000000000% |
| −1,024,957 | −1,016,129 | 0.0000000000000% |
| −1,016,129 | −1,007,301 | 0.0000000000000% |
| −1,007,302 | −998,474 | 0.0000000000000% |
| −998,474 | −989,646 | 0.0000000000000% |
| −989,646 | −980,818 | 0.0000000000000% |
| −980,818 | −971,990 | 0.0000000000000% |
| −971,990 | −963,162 | 0.0000000000000% |
| −963,163 | −954,335 | 0.0000000000000% |
| −954,335 | −945,507 | 0.0000000000000% |
| −945,507 | −936,679 | 0.0000000000000% |
| −936,679 | −927,851 | 0.0000000000000% |
| −927,851 | −919,023 | 0.0000000000000% |
| −919,024 | −910,196 | 0.0000000000000% |
| −910,196 | −901,368 | 0.0000000000000% |
| −901,368 | −892,540 | 0.0000000000000% |
| −892,540 | −883,712 | 0.0000000000000% |
| −883,712 | −874,884 | 0.0000000000000% |
| −874,885 | −866,057 | 0.0000000000000% |
| −866,057 | −857,229 | 0.0000000000000% |
| −857,229 | −848,401 | 0.0000000000000% |
| −848,401 | −839,573 | 0.0000000000000% |
| −839,574 | −830,746 | 0.0000000000000% |
| −830,746 | −821,918 | 0.0000000000000% |
| −821,918 | −813,090 | 0.0000000000000% |
| −813,090 | −804,262 | 0.0000000000000% |
| −804,262 | −795,434 | 0.0000000000000% |
| −795,435 | −786,607 | 0.0000000000000% |
| −786,607 | −777,779 | 0.0000000000000% |
| −777,779 | −768,951 | 0.0000000000000% |
| −768,951 | −760,123 | 0.0000000000000% |
| −760,123 | −751,295 | 0.0000000000000% |
| −751,296 | −742,468 | 0.0000000000000% |
| −742,468 | −733,640 | 0.0000000000000% |
| −733,640 | −724,812 | 0.0000000000000% |
| −724,812 | −715,984 | 0.0000000000000% |
| −715,984 | −707,156 | 0.0000000000000% |
| −707,157 | −698,329 | 0.0000000000000% |
| −698,329 | −689,501 | 0.0000000000000% |
| −689,501 | −680,673 | 0.0000000000000% |
| −680,673 | −671,845 | 0.0000000000000% |
| −671,845 | −663,017 | 0.0000000000000% |
| −663,018 | −654,190 | 0.0000000000000% |
| −654,190 | −645,362 | 0.0000000000000% |
| −645,362 | −636,534 | 0.0000000000000% |
| −636,534 | −627,706 | 0.0000000000000% |
| −627,706 | −618,878 | 0.0000000000000% |
| −618,879 | −610,051 | 0.0000000000000% |
| −610,051 | −601,223 | 0.0000000000000% |
| −601,223 | −592,395 | 0.0000000000000% |
| −592,395 | −583,567 | 0.0000000000000% |
| −583,567 | −574,739 | 0.0000000000000% |
| −574,740 | −565,912 | 0.0000000000000% |
| −565,912 | −557,084 | 0.0000000000000% |
| −557,084 | −548,256 | 0.0000000000000% |
| −548,256 | −539,428 | 0.0000000000000% |
| −539,428 | −530,600 | 0.0000000000000% |
| −530,601 | −521,773 | 0.0000000000000% |
| −521,773 | −512,945 | 0.0000000000000% |
| −512,945 | −504,117 | 0.0000000000000% |
| −504,117 | −495,289 | 0.0000000000001% |
| −495,289 | −486,461 | 0.0000000000007% |
| −486,462 | −477,634 | 0.0000000000080% |
| −477,634 | −468,806 | 0.0000000000215% |
| −468,806 | −459,978 | 0.0000000000526% |
| −459,978 | −451,150 | 0.0000000002367% |
| −451,150 | −442,322 | 0.0000000005766% |
| −442,323 | −433,495 | 0.0000000012502% |
| −433,495 | −424,667 | 0.0000000026532% |
| −424,667 | −415,839 | 0.0000000069811% |
| −415,839 | −407,011 | 0.0000000382621% |
| −407,011 | −398,183 | 0.0000000955150% |
| −398,184 | −389,356 | 0.0000001776600% |
| −389,356 | −380,528 | 0.0000003333478% |
| −380,528 | −371,700 | 0.0000006193601% |
| −371,700 | −362,872 | 0.0000010675688% |
| −362,872 | −354,044 | 0.0000018090927% |
| −354,045 | −345,217 | 0.0000030180916% |
| −345,217 | −336,389 | 0.0000049063663% |
| −336,389 | −327,561 | 0.0000132730137% |
| −327,561 | −318,733 | 0.0000224489192% |
| −318,733 | −309,905 | 0.0000389421556% |
| −309,906 | −301,078 | 0.0000619736978% |
| −301,078 | −292,250 | 0.0000956361053% |
| −292,250 | −283,422 | 0.0001458439548% |
| −283,422 | −274,594 | 0.0002221033379% |
| −274,594 | −265,766 | 0.0003252785855% |
| −265,767 | −256,939 | 0.0006973384165% |
| −256,939 | −248,111 | 0.0012751213721% |
| −248,111 | −239,283 | 0.0017564544399% |
| −239,283 | −230,455 | 0.0024855885061% |
| −230,455 | −221,627 | 0.0039250567759% |
| −221,628 | −212,800 | 0.0051959441993% |
| −212,800 | −203,972 | 0.0068185924142% |
| −203,972 | −195,144 | 0.0089988277583% |
| −195,144 | −186,316 | 0.0147185952440% |
| −186,316 | −177,488 | 0.0187484401847% |
| −177,489 | −168,661 | 0.0241651279932% |
| −168,661 | −159,833 | 0.0304627471953% |
| −159,833 | −151,005 | 0.0403304055130% |
| −151,005 | −142,177 | 0.0508759426073% |
| −142,177 | −133,349 | 0.0645974057505% |
| −133,350 | −124,522 | 0.0870506620900% |
| −124,522 | −115,694 | 0.1054104719504% |
| −115,694 | −106,866 | 0.1555767881557% |
| −106,866 | −98,038 | 0.1851122181753% |
| −98,038 | −89,210 | 0.2189290989404% |
| −89,211 | −80,383 | 0.2573999160345% |
| −80,383 | −71,555 | 0.3008073799226% |
| −71,555 | −62,727 | 0.3615810472425% |
| −62,727 | −53,899 | 0.4315118187350% |
| −53,899 | −45,071 | 0.6006192013624% |
| −45,072 | −36,244 | 0.8199224717418% |
| −36,244 | −27,416 | 0.9679577274128% |
| −27,416 | −18,588 | 1.1151954941523% |
| −18,588 | −9,760 | 1.2603153274849% |
| −9,760 | −932 | 1.4218854821856% |
| −933 | 7,895 | 1.6012880388348% |
| 7,895 | 16,723 | 1.8006993784328% |
| 16,723 | 25,551 | 2.0707679909958% |
| 25,551 | 34,379 | 2.5798044892689% |
| 34,378 | 43,206 | 2.9778015631600% |
| 43,206 | 52,034 | 3.2783897547515% |
| 52,034 | 60,862 | 3.6161442395000% |
| 60,862 | 69,690 | 4.0121507164442% |
| 69,690 | 78,518 | 4.4317192511575% |
| 78,517 | 87,345 | 4.8620295708883% |
| 87,345 | 96,173 | 5.3227757643496% |
| 96,173 | 105,001 | 5.9201079178989% |
| 105,001 | 113,829 | 7.0200666288558% |
| 113,829 | 122,657 | 7.6771709610899% |
| 122,656 | 131,484 | 8.5197218917224% |
| 131,484 | 140,312 | 9.2739644382429% |
| 140,312 | 149,140 | 10.4220567986609% |
| 149,140 | 157,968 | 11.2026975791171% |
| 157,968 | 166,796 | 11.9636698324646% |
| 166,795 | 175,623 | 12.8994221640359% |
| 175,623 | 184,451 | 14.5591526657690% |
| 184,451 | 193,279 | 15.7527468505712% |
| 193,279 | 202,107 | 16.7066541951429% |
| 202,107 | 210,935 | 17.8352104858872% |
| 210,934 | 219,762 | 19.3619355129900% |
| 219,762 | 228,590 | 20.4719997581447% |
| 228,590 | 237,418 | 21.5752574788502% |
| 237,418 | 246,246 | 22.7616879111725% |
| 246,246 | 255,074 | 25.0250574227471% |
| 255,073 | 263,901 | 26.1738774322370% |
| 263,901 | 272,729 | 27.3342108574833% |
| 272,729 | 281,557 | 28.4974928602907% |
| 281,557 | 290,385 | 29.9710838300900% |
| 290,385 | 299,213 | 31.2715008713569% |
| 299,212 | 308,040 | 32.5624227981239% |
| 308,040 | 316,868 | 34.3661080347948% |
| 316,868 | 325,696 | 37.1901192430042% |
| 325,696 | 334,524 | 38.6944177806645% |
| 334,524 | 343,352 | 41.1261490772473% |
| 343,351 | 352,179 | 42.4970517110926% |
| 352,179 | 361,007 | 43.8439742004818% |
| 361,007 | 369,835 | 45.7646119773856% |
| 369,835 | 378,663 | 47.1170087038107% |
| 378,663 | 387,491 | 48.6189759297485% |
| 387,490 | 396,318 | 50.4074353851961% |
| 396,318 | 405,146 | 53.0631749379326% |
| 405,146 | 413,974 | 54.4501025847708% |
| 413,974 | 422,802 | 55.7196116070101% |
| 422,802 | 431,630 | 56.9861500234953% |
| 431,629 | 440,457 | 58.3248083103937% |
| 440,457 | 449,285 | 59.5598368417797% |
| 449,285 | 458,113 | 60.8313804154635% |
| 458,113 | 466,941 | 62.4692034262420% |
| 466,941 | 475,769 | 65.1336992940237% |
| 475,768 | 484,596 | 66.8047945442478% |
| 484,596 | 493,424 | 67.9116366812887% |
| 493,424 | 502,252 | 69.0547528228996% |
| 502,252 | 511,080 | 70.2423967415646% |
| 511,080 | 519,908 | 71.2800770724535% |
| 519,907 | 528,735 | 72.2940241863967% |
| 528,735 | 537,563 | 73.2808090297395% |
| 537,563 | 546,391 | 76.1210300178199% |
| 546,391 | 555,219 | 77.1619840597711% |
| 555,219 | 564,047 | 78.7298841516823% |
| 564,046 | 572,874 | 79.7025751752425% |
| 572,874 | 581,702 | 80.5962971065439% |
| 581,702 | 590,530 | 81.4312257181555% |
| 590,530 | 599,358 | 82.2876181186992% |
| 599,358 | 608,186 | 83.0465289766277% |
| 608,185 | 617,013 | 83.7883879998699% |
| 617,013 | 625,841 | 85.2008070244174% |
| 625,841 | 634,669 | 86.0267757062123% |
| 634,669 | 643,497 | 86.6344298631061% |
| 643,497 | 652,325 | 87.2962831344475% |
| 652,324 | 661,152 | 88.1100871645139% |
| 661,152 | 669,980 | 88.6744814390339% |
| 669,980 | 678,808 | 89.2329968395081% |
| 678,808 | 687,636 | 89.8370818689095% |
| 687,636 | 696,464 | 90.8264404017443% |
| 696,463 | 705,291 | 91.3004754060173% |
| 705,291 | 714,119 | 91.7568123881555% |
| 714,119 | 722,947 | 92.1954993684822% |
| 722,947 | 731,775 | 92.7085439720014% |
| 731,775 | 740,603 | 93.5009567022676% |
| 740,602 | 749,430 | 93.8972918046852% |
| 749,430 | 758,258 | 94.2251917390744% |
| 758,258 | 767,086 | 94.9135684384200% |
| 767,086 | 775,914 | 95.1851783783244% |
| 775,914 | 784,742 | 95.4400832024829% |
| 784,741 | 793,569 | 95.6855612340689% |
| 793,569 | 802,397 | 95.9240463782977% |
| 802,397 | 811,225 | 96.2393422447117% |
| 811,225 | 820,053 | 96.4667929615409% |
| 820,053 | 828,881 | 96.7015694209675% |
| 828,880 | 837,708 | 97.0184083126487% |
| 837,708 | 846,536 | 97.3446509419694% |
| 846,536 | 855,364 | 97.5172975593502% |
| 855,364 | 864,192 | 97.6666441867764% |
| 864,191 | 873,019 | 97.8098514235311% |
| 873,019 | 881,847 | 97.9422637945395% |
| 881,847 | 890,675 | 98.0665222997669% |
| 890,675 | 899,503 | 98.1812497688883% |
| 899,503 | 908,331 | 98.3177744072223% |
| 908,330 | 917,158 | 98.5366951926678% |
| 917,158 | 925,986 | 98.6716389616476% |
| 925,986 | 934,814 | 98.8295770262078% |
| 934,814 | 943,642 | 98.9153351587665% |
| 943,642 | 952,470 | 98.9904929019223% |
| 952,469 | 961,297 | 99.0745476915369% |
| 961,297 | 970,125 | 99.1373768010056% |
| 970,125 | 978,953 | 99.1962422068002% |
| 978,953 | 987,781 | 99.3150171289429% |
| 987,781 | 996,609 | 99.3659767489186% |
| 996,608 | 1,005,436 | 99.4237261195182% |
| 1,005,436 | 1,014,264 | 99.4656510384189% |
| 1,014,264 | 1,023,092 | 99.5032386574159% |
| 1,023,092 | 1,031,920 | 99.5380642769567% |
| 1,031,920 | 1,040,748 | 99.5725822463177% |
| 1,040,747 | 1,049,575 | 99.6026384320762% |
| 1,049,575 | 1,058,403 | 99.6600704973477% |
| 1,058,403 | 1,067,231 | 99.6863732068944% |
| 1,067,231 | 1,076,059 | 99.7176987469655% |
| 1,076,059 | 1,084,887 | 99.7392007669498% |
| 1,084,886 | 1,093,714 | 99.7611893510610% |
| 1,093,714 | 1,102,542 | 99.7867158364390% |
| 1,102,542 | 1,111,370 | 99.8026403958946% |
| 1,111,370 | 1,120,198 | 99.8182945822592% |
| 1,120,198 | 1,129,026 | 99.8335879704217% |
| 1,129,025 | 1,137,853 | 99.8662893783230% |
| 1,137,853 | 1,146,681 | 99.8762876291834% |
| 1,146,681 | 1,155,509 | 99.8876961075898% |
| 1,155,509 | 1,164,337 | 99.8986580532362% |
| 1,164,337 | 1,173,165 | 99.9084014493729% |
| 1,173,164 | 1,181,992 | 99.9189121766062% |
| 1,181,992 | 1,190,820 | 99.9263113815090% |
| 1,190,820 | 1,199,648 | 99.9325875922218% |
| 1,199,648 | 1,208,476 | 99.9440771598048% |
| 1,208,476 | 1,217,304 | 99.9488326313787% |
| 1,217,303 | 1,226,131 | 99.9531501238360% |
| 1,226,131 | 1,234,959 | 99.9572135667362% |
| 1,234,959 | 1,243,787 | 99.9607771221150% |
| 1,243,787 | 1,252,615 | 99.9648885992668% |
| 1,252,615 | 1,261,443 | 99.9677993372639% |
| 1,261,442 | 1,270,270 | 99.9708277833101% |
| 1,270,270 | 1,279,098 | 99.9766768471747% |
| 1,279,098 | 1,287,926 | 99.9788027574589% |
| 1,287,926 | 1,296,754 | 99.9809915975477% |
| 1,296,754 | 1,305,582 | 99.9827315011345% |
| 1,305,581 | 1,314,409 | 99.9843591057442% |
| 1,314,409 | 1,323,237 | 99.9858822416518% |
| 1,323,237 | 1,332,065 | 99.9882130049427% |
| 1,332,065 | 1,340,893 | 99.9895674869626% |
| 1,340,893 | 1,349,721 | 99.9906811254479% |
| 1,349,720 | 1,358,548 | 99.9928632490326% |
| 1,358,548 | 1,367,376 | 99.9935505961091% |
| 1,367,376 | 1,376,204 | 99.9941852572087% |
| 1,376,204 | 1,385,032 | 99.9947919034920% |
| 1,385,032 | 1,393,860 | 99.9952843268296% |
| 1,393,859 | 1,402,687 | 99.9957372772911% |
| 1,402,687 | 1,411,515 | 99.9961548559623% |
| 1,411,515 | 1,420,343 | 99.9965647646795% |
| 1,420,343 | 1,429,171 | 99.9973429142186% |
| 1,429,171 | 1,437,999 | 99.9976648553721% |
| 1,437,998 | 1,446,826 | 99.9980023800821% |
| 1,446,826 | 1,455,654 | 99.9982262654528% |
| 1,455,654 | 1,464,482 | 99.9984182208428% |
| 1,464,482 | 1,473,310 | 99.9986030275837% |
| 1,473,310 | 1,482,138 | 99.9987569518289% |
| 1,482,137 | 1,490,965 | 99.9988902475917% |
| 1,490,965 | 1,499,793 | 99.9991126173635% |
| 1,499,793 | 1,508,621 | 99.9992062669317% |
| 1,508,621 | 1,517,449 | 99.9993128170879% |
| 1,517,449 | 1,526,277 | 99.9994497585909% |
| 1,526,276 | 1,535,104 | 99.9995363858439% |
| 1,535,104 | 1,543,932 | 99.9995966401987% |
| 1,543,932 | 1,552,760 | 99.9996557201233% |
| 1,552,760 | 1,561,588 | 99.9997014806982% |
| 1,561,588 | 1,570,416 | 99.9997375844423% |
| 1,570,415 | 1,579,243 | 99.9997978471211% |
| 1,579,243 | 1,588,071 | 99.9998219917365% |
| 1,588,071 | 1,596,899 | 99.9998458196008% |
| 1,596,899 | 1,605,727 | 99.9998669063356% |
| 1,605,727 | 1,614,555 | 99.9998843414189% |
| 1,614,554 | 1,623,382 | 99.9999033158913% |
| 1,623,382 | 1,632,210 | 99.9999159546760% |
| 1,632,210 | 1,641,038 | 99.9999264783932% |
| 1,641,038 | 1,649,866 | 99.9999442205832% |
| 1,649,866 | 1,658,694 | 99.9999516213197% |
| 1,658,693 | 1,667,521 | 99.9999579611379% |
| 1,667,521 | 1,676,349 | 99.9999637070581% |
| 1,676,349 | 1,685,177 | 99.9999687437232% |
| 1,685,177 | 1,694,005 | 99.9999742397635% |
| 1,694,005 | 1,702,833 | 99.9999777439142% |
| 1,702,832 | 1,711,660 | 99.9999809476015% |
| 1,711,660 | 1,720,488 | 99.9999882392160% |
| 1,720,488 | 1,729,316 | 99.9999899706132% |
| 1,729,316 | 1,738,144 | 99.9999913478751% |
| 1,738,143 | 1,746,971 | 99.9999927239400% |
| 1,746,971 | 1,755,799 | 99.9999936952880% |
| 1,755,799 | 1,764,627 | 99.9999945428090% |
| 1,764,627 | 1,773,455 | 99.9999953218466% |
| 1,773,455 | 1,782,283 | 99.9999961692339% |
| 1,782,282 | 1,791,110 | 99.9999969541865% |
| 1,791,110 | 1,799,938 | 99.9999978939964% |
| 1,799,938 | 1,808,766 | 99.9999982148805% |
| 1,808,766 | 1,817,594 | 99.9999984975014% |
| 1,817,594 | 1,826,422 | 99.9999987493247% |
| 1,826,421 | 1,835,249 | 99.9999989407763% |
| 1,835,249 | 1,844,077 | 99.9999991028866% |
| 1,844,077 | 1,852,905 | 99.9999992409604% |
| 1,852,905 | 1,861,733 | 99.9999993560209% |
| 1,861,733 | 1,870,561 | 99.9999995616141% |
| 1,870,560 | 1,879,388 | 99.9999996375787% |
| 1,879,388 | 1,888,216 | 99.9999997141931% |
| 1,888,216 | 1,897,044 | 99.9999997626810% |
| 1,897,044 | 1,905,872 | 99.9999998031043% |
| 1,905,872 | 1,914,700 | 99.9999998388010% |
| 1,914,699 | 1,923,527 | 99.9999998854099% |
| 1,923,527 | 1,932,355 | 99.9999999057941% |
| 1,932,355 | 1,941,183 | 99.9999999386142% |
| 1,941,183 | 1,950,011 | 99.9999999520031% |
| 1,950,011 | 1,958,839 | 99.9999999607930% |
| 1,958,838 | 1,967,666 | 99.9999999682489% |
| 1,967,666 | 1,976,494 | 99.9999999758635% |
| 1,976,494 | 1,985,322 | 99.9999999801048% |
| 1,985,322 | 1,994,150 | 99.9999999836841% |
| 1,994,150 | 2,002,978 | 99.9999999867806% |
| 2,002,977 | 2,011,805 | 99.9999999910593% |
| 2,011,805 | 2,020,633 | 99.9999999927231% |
| 2,020,633 | 2,029,461 | 99.9999999942139% |
| 2,029,461 | 2,038,289 | 99.9999999956640% |
| 2,038,289 | 2,047,117 | 99.9999999965226% |
| 2,047,116 | 2,055,944 | 99.9999999972914% |
| 2,055,944 | 2,064,772 | 99.9999999979954% |
| 2,064,772 | 2,073,600 | 99.9999999984245% |
| 2,073,600 | 2,082,428 | 99.9999999987502% |
| 2,082,428 | 2,091,256 | 99.9999999992291% |
| 2,091,255 | 2,100,083 | 99.9999999993852% |
| 2,100,083 | 2,108,911 | 99.9999999995092% |
| 2,108,911 | 2,117,739 | 99.9999999996716% |
| 2,117,739 | 2,126,567 | 99.9999999997533% |
| 2,126,567 | 2,135,395 | 99.9999999998092% |
| 2,135,394 | 2,144,222 | 99.9999999998609% |
| 2,144,222 | 2,153,050 | 99.9999999999035% |
| 2,153,050 | 2,161,878 | 99.9999999999439% |
| 2,161,878 | 2,170,706 | 99.9999999999585% |
| 2,170,706 | 2,179,534 | 99.9999999999686% |
| 2,179,533 | 2,188,361 | 99.9999999999760% |
| 2,188,361 | 2,197,189 | 99.9999999999816% |
| 2,197,189 | 2,206,017 | 99.9999999999859% |
| 2,206,017 | 2,214,845 | 99.9999999999893% |
| 2,214,845 | 2,223,673 | 99.9999999999925% |
| 2,223,672 | 2,232,500 | 99.9999999999962% |
| 2,232,500 | 2,241,328 | 99.9999999999972% |
| 2,241,328 | 2,250,156 | 99.9999999999979% |
| 2,250,156 | 2,258,984 | 99.9999999999984% |
| 2,258,984 | 2,267,812 | 99.9999999999989% |
| 2,267,811 | 2,276,639 | 99.9999999999992% |
| 2,276,639 | 2,285,467 | 99.9999999999994% |
| 2,285,467 | 2,294,295 | 99.9999999999996% |
| 2,294,295 | 2,303,123 | 99.9999999999997% |
| 2,303,123 | 2,311,951 | 99.9999999999999% |
| 2,311,950 | 2,320,778 | 100.0000000000000% |
| 2,320,778 | 2,329,606 | 100.0000000000000% |
| 2,329,606 | 2,338,434 | 100.0000000000000% |
| 2,338,434 | 2,347,262 | 100.0000000000000% |
| 2,347,262 | 2,356,090 | 100.0000000000000% |
| 2,356,089 | 2,364,917 | 100.0000000000000% |
| 2,364,917 | 2,373,745 | 100.0000000000000% |
| 2,373,745 | 2,382,573 | 100.0000000000000% |
| 2,382,573 | 2,391,401 | 100.0000000000000% |
| 2,391,401 | 2,400,229 | 100.0000000000000% |
| 2,400,228 | 2,409,056 | 100.0000000000000% |
| 2,409,056 | 2,417,884 | 100.0000000000000% |
| 2,417,884 | 2,426,712 | 100.0000000000000% |
| 2,426,712 | 2,435,540 | 100.0000000000000% |
| 2,435,540 | 2,444,368 | 100.0000000000000% |
| 2,444,367 | 2,453,195 | 100.0000000000000% |
| 2,453,195 | 2,462,023 | 100.0000000000000% |
| 2,462,023 | 2,470,851 | 100.0000000000000% |
| 2,470,851 | 2,479,679 | 100.0000000000000% |
| 2,479,679 | 2,488,507 | 100.0000000000000% |
| 2,488,506 | 2,497,334 | 100.0000000000000% |
| 2,497,334 | 2,506,162 | 100.0000000000000% |
| 2,506,162 | 2,514,990 | 100.0000000000000% |
| 2,514,990 | 2,523,818 | 100.0000000000000% |
| 2,523,818 | 2,532,646 | 100.0000000000000% |
| 2,532,645 | 2,541,473 | 100.0000000000000% |
| 2,541,473 | 2,550,301 | 100.0000000000000% |
| 2,550,301 | 2,559,129 | 100.0000000000000% |
| 2,559,129 | 2,567,957 | 100.0000000000000% |
| 2,567,956 | 2,576,784 | 100.0000000000000% |
| 2,576,784 | 2,585,612 | 100.0000000000000% |
| 2,585,612 | 2,594,440 | 100.0000000000000% |
| 2,594,440 | 2,603,268 | 100.0000000000000% |
| 2,603,268 | 2,612,096 | 100.0000000000000% |
| 2,612,095 | 2,620,923 | 100.0000000000000% |
| 2,620,923 | 2,629,751 | 100.0000000000000% |
| 2,629,751 | 2,638,579 | 100.0000000000000% |

Sample Data Sets A & B
Table of Convolution Distributions Outcomes

| | |
|---|---|
| Outcome Intervals | Outcome Intervals |

| From | To | As % of All Outcomes |
|---|---|---|
| −46,788,367 | −46,734,937 | 0.0000000000000% |
| −46,734,938 | −46,681,508 | 0.0000000000000% |
| −46,681,508 | −46,628,078 | 0.0000000000000% |
| −46,628,079 | −46,574,649 | 0.0000000000000% |
| −46,574,649 | −46,521,219 | 0.0000000000000% |
| −46,521,220 | −46,467,790 | 0.0000000000000% |
| −46,467,790 | −46,414,360 | 0.0000000000000% |
| −46,414,361 | −46,360,931 | 0.0000000000000% |
| −46,360,931 | −46,307,501 | 0.0000000000000% |
| −46,307,502 | −46,254,072 | 0.0000000000000% |
| −46,254,072 | −46,200,642 | 0.0000000000000% |
| −46,200,643 | −46,147,213 | 0.0000000000000% |
| −46,147,213 | −46,093,783 | 0.0000000000000% |
| −46,093,784 | −46,040,354 | 0.0000000000000% |
| −46,040,355 | −45,986,925 | 0.0000000000000% |
| −45,986,925 | −45,933,495 | 0.0000000000000% |
| −45,933,496 | −45,880,066 | 0.0000000000000% |
| −45,880,066 | −45,826,636 | 0.0000000000000% |
| −45,826,637 | −45,773,207 | 0.0000000000000% |
| −45,773,207 | −45,719,777 | 0.0000000000000% |
| −45,719,778 | −45,666,348 | 0.0000000000000% |
| −45,666,348 | −45,612,918 | 0.0000000000000% |
| −45,612,919 | −45,559,489 | 0.0000000000000% |
| −45,559,489 | −45,506,059 | 0.0000000000000% |
| −45,506,060 | −45,452,630 | 0.0000000000000% |
| −45,452,630 | −45,399,200 | 0.0000000000000% |
| −45,399,201 | −45,345,771 | 0.0000000000000% |
| −45,345,771 | −45,292,341 | 0.0000000000000% |
| −45,292,342 | −45,238,912 | 0.0000000000000% |
| −45,238,912 | −45,185,482 | 0.0000000000000% |
| −45,185,483 | −45,132,053 | 0.0000000000000% |
| −45,132,053 | −45,078,623 | 0.0000000000000% |
| −45,078,624 | −45,025,194 | 0.0000000000000% |
| −45,025,195 | −44,971,765 | 0.0000000000000% |
| −44,971,765 | −44,918,335 | 0.0000000000000% |
| −44,918,336 | −44,864,906 | 0.0000000000000% |
| −44,864,906 | −44,811,476 | 0.0000000000000% |
| −44,811,477 | −44,758,047 | 0.0000000000000% |
| −44,758,047 | −44,704,617 | 0.0000000000000% |
| −44,704,618 | −44,651,188 | 0.0000000000000% |
| −44,651,188 | −44,597,758 | 0.0000000000000% |
| −44,597,759 | −44,544,329 | 0.0000000000000% |
| −44,544,329 | −44,490,899 | 0.0000000000000% |
| −44,490,900 | −44,437,470 | 0.0000000000000% |
| −44,437,470 | −44,384,040 | 0.0000000000000% |
| −44,384,041 | −44,330,611 | 0.0000000000000% |
| −44,330,611 | −44,277,181 | 0.0000000000000% |
| −44,277,182 | −44,223,752 | 0.0000000000000% |
| −44,223,752 | −44,170,322 | 0.0000000000000% |
| −44,170,323 | −44,116,893 | 0.0000000000000% |
| −44,116,894 | −44,063,464 | 0.0000000000000% |
| −44,063,464 | −44,010,034 | 0.0000000000000% |
| −44,010,035 | −43,956,605 | 0.0000000000000% |
| −43,956,605 | −43,903,175 | 0.0000000000000% |
| −43,903,176 | −43,849,746 | 0.0000000000000% |
| −43,849,746 | −43,796,316 | 0.0000000000000% |
| −43,796,317 | −43,742,887 | 0.0000000000000% |
| −43,742,887 | −43,689,457 | 0.0000000000000% |
| −43,689,458 | −43,636,028 | 0.0000000000000% |
| −43,636,028 | −43,582,598 | 0.0000000000000% |
| −43,582,599 | −43,529,169 | 0.0000000000000% |
| −43,529,169 | −43,475,739 | 0.0000000000000% |
| −43,475,740 | −43,422,310 | 0.0000000000000% |
| −43,422,310 | −43,368,880 | 0.0000000000000% |
| −43,368,881 | −43,315,451 | 0.0000000000000% |
| −43,315,451 | −43,262,021 | 0.0000000000000% |
| −43,262,022 | −43,208,592 | 0.0000000000000% |
| −43,208,592 | −43,155,162 | 0.0000000000000% |
| −43,155,163 | −43,101,733 | 0.0000000000000% |
| −43,101,734 | −43,048,304 | 0.0000000000000% |
| −43,048,304 | −42,994,874 | 0.0000000000000% |
| −42,994,875 | −42,941,445 | 0.0000000000000% |
| −42,941,445 | −42,888,015 | 0.0000000000000% |
| −42,888,016 | −42,834,586 | 0.0000000000000% |
| −42,834,586 | −42,781,156 | 0.0000000000000% |
| −42,781,157 | −42,727,727 | 0.0000000000000% |
| −42,727,727 | −42,674,297 | 0.0000000000000% |
| −42,674,298 | −42,620,868 | 0.0000000000000% |
| −42,620,868 | −42,567,438 | 0.0000000000000% |
| −42,567,439 | −42,514,009 | 0.0000000000000% |
| −42,514,009 | −42,460,579 | 0.0000000000000% |
| −42,460,580 | −42,407,150 | 0.0000000000000% |
| −42,407,150 | −42,353,720 | 0.0000000000000% |
| −42,353,721 | −42,300,291 | 0.0000000000000% |
| −42,300,291 | −42,246,861 | 0.0000000000000% |
| −42,246,862 | −42,193,432 | 0.0000000000000% |
| −42,193,433 | −42,140,003 | 0.0000000000000% |
| −42,140,003 | −42,086,573 | 0.0000000000000% |
| −42,086,574 | −42,033,144 | 0.0000000000000% |
| −42,033,144 | −41,979,714 | 0.0000000000000% |
| −41,979,715 | −41,926,285 | 0.0000000000000% |
| −41,926,285 | −41,872,855 | 0.0000000000000% |
| −41,872,856 | −41,819,426 | 0.0000000000000% |
| −41,819,426 | −41,765,996 | 0.0000000000000% |
| −41,765,997 | −41,712,567 | 0.0000000000000% |
| −41,712,567 | −41,659,137 | 0.0000000000000% |
| −41,659,138 | −41,605,708 | 0.0000000000000% |
| −41,605,708 | −41,552,278 | 0.0000000000000% |
| −41,552,279 | −41,498,849 | 0.0000000000000% |
| −41,498,849 | −41,445,419 | 0.0000000000000% |
| −41,445,420 | −41,391,990 | 0.0000000000000% |
| −41,391,990 | −41,338,560 | 0.0000000000000% |
| −41,338,561 | −41,285,131 | 0.0000000000000% |
| −41,285,132 | −41,231,702 | 0.0000000000000% |
| −41,231,702 | −41,178,272 | 0.0000000000000% |
| −41,178,273 | −41,124,843 | 0.0000000000000% |
| −41,124,843 | −41,071,413 | 0.0000000000000% |
| −41,071,414 | −41,017,984 | 0.0000000000000% |
| −41,017,984 | −40,964,554 | 0.0000000000000% |
| −40,964,555 | −40,911,125 | 0.0000000000000% |
| −40,911,125 | −40,857,695 | 0.0000000000000% |
| −40,857,696 | −40,804,266 | 0.0000000000000% |
| −40,804,266 | −40,750,836 | 0.0000000000000% |
| −40,750,837 | −40,697,407 | 0.0000000000000% |
| −40,697,407 | −40,643,977 | 0.0000000000000% |
| −40,643,978 | −40,590,548 | 0.0000000000000% |
| −40,590,548 | −40,537,118 | 0.0000000000000% |
| −40,537,119 | −40,483,689 | 0.0000000000000% |
| −40,483,689 | −40,430,259 | 0.0000000000000% |
| −40,430,260 | −40,376,830 | 0.0000000000000% |
| −40,376,830 | −40,323,400 | 0.0000000000000% |
| −40,323,401 | −40,269,971 | 0.0000000000000% |
| −40,269,972 | −40,216,542 | 0.0000000000000% |
| −40,216,542 | −40,163,112 | 0.0000000000000% |
| −40,163,113 | −40,109,683 | 0.0000000000000% |
| −40,109,683 | −40,056,253 | 0.0000000000000% |
| −40,056,254 | −40,002,824 | 0.0000000000000% |
| −40,002,824 | −39,949,394 | 0.0000000000000% |
| −39,949,395 | −39,895,965 | 0.0000000000000% |
| −39,895,965 | −39,842,535 | 0.0000000000000% |
| −39,842,536 | −39,789,106 | 0.0000000000000% |
| −39,789,106 | −39,735,676 | 0.0000000000000% |
| −39,735,677 | −39,682,247 | 0.0000000000000% |
| −39,682,247 | −39,628,817 | 0.0000000000000% |
| −39,628,818 | −39,575,388 | 0.0000000000000% |
| −39,575,388 | −39,521,958 | 0.0000000000000% |
| −39,521,959 | −39,468,529 | 0.0000000000000% |
| −39,468,529 | −39,415,099 | 0.0000000000000% |
| −39,415,100 | −39,361,670 | 0.0000000000000% |
| −39,361,671 | −39,308,241 | 0.0000000000000% |
| −39,308,241 | −39,254,811 | 0.0000000000000% |
| −39,254,812 | −39,201,382 | 0.0000000000000% |
| −39,201,382 | −39,147,952 | 0.0000000000000% |
| −39,147,953 | −39,094,523 | 0.0000000000000% |
| −39,094,523 | −39,041,093 | 0.0000000000000% |
| −39,041,094 | −38,987,664 | 0.0000000000000% |
| −38,987,664 | −38,934,234 | 0.0000000000000% |
| −38,934,235 | −38,880,805 | 0.0000000000000% |
| −38,880,805 | −38,827,375 | 0.0000000000000% |
| −38,827,376 | −38,773,946 | 0.0000000000000% |
| −38,773,946 | −38,720,516 | 0.0000000000000% |
| −38,720,517 | −38,667,087 | 0.0000000000000% |
| −38,667,087 | −38,613,657 | 0.0000000000000% |
| −38,613,658 | −38,560,228 | 0.0000000000000% |
| −38,560,228 | −38,506,798 | 0.0000000000000% |
| −38,506,799 | −38,453,369 | 0.0000000000000% |
| −38,453,370 | −38,399,940 | 0.0000000000000% |
| −38,399,940 | −38,346,510 | 0.0000000000000% |
| −38,346,511 | −38,293,081 | 0.0000000000000% |
| −38,293,081 | −38,239,651 | 0.0000000000000% |
| −38,239,652 | −38,186,222 | 0.0000000000000% |
| −38,186,222 | −38,132,792 | 0.0000000000000% |
| −38,132,793 | −38,079,363 | 0.0000000000000% |
| −38,079,363 | −38,025,933 | 0.0000000000000% |
| −38,025,934 | −37,972,504 | 0.0000000000000% |
| −37,972,504 | −37,919,074 | 0.0000000000000% |
| −37,919,075 | −37,865,645 | 0.0000000000000% |
| −37,865,645 | −37,812,215 | 0.0000000000000% |
| −37,812,216 | −37,758,786 | 0.0000000000000% |
| −37,758,786 | −37,705,356 | 0.0000000000000% |
| −37,705,357 | −37,651,927 | 0.0000000000000% |
| −37,651,927 | −37,598,497 | 0.0000000000000% |
| −37,598,498 | −37,545,068 | 0.0000000000000% |
| −37,545,068 | −37,491,638 | 0.0000000000000% |
| −37,491,639 | −37,438,209 | 0.0000000000000% |
| −37,438,210 | −37,384,780 | 0.0000000000000% |
| −37,384,780 | −37,331,350 | 0.0000000000000% |
| −37,331,351 | −37,277,921 | 0.0000000000000% |
| −37,277,921 | −37,224,491 | 0.0000000000000% |
| −37,224,492 | −37,171,062 | 0.0000000000000% |
| −37,171,062 | −37,117,632 | 0.0000000000000% |
| −37,117,633 | −37,064,203 | 0.0000000000000% |
| −37,064,203 | −37,010,773 | 0.0000000000000% |
| −37,010,774 | −36,957,344 | 0.0000000000000% |
| −36,957,344 | −36,903,914 | 0.0000000000000% |
| −36,903,915 | −36,850,485 | 0.0000000000000% |
| −36,850,485 | −36,797,055 | 0.0000000000000% |
| −36,797,056 | −36,743,626 | 0.0000000000000% |
| −36,743,626 | −36,690,196 | 0.0000000000000% |
| −36,690,197 | −36,636,767 | 0.0000000000000% |
| −36,636,767 | −36,583,337 | 0.0000000000000% |
| −36,583,338 | −36,529,908 | 0.0000000000000% |
| −36,529,909 | −36,476,479 | 0.0000000000000% |
| −36,476,479 | −36,423,049 | 0.0000000000000% |
| −36,423,050 | −36,369,620 | 0.0000000000000% |
| −36,369,620 | −36,316,190 | 0.0000000000000% |
| −36,316,191 | −36,262,761 | 0.0000000000000% |
| −36,262,761 | −36,209,331 | 0.0000000000000% |
| −36,209,332 | −36,155,902 | 0.0000000000000% |
| −36,155,902 | −36,102,472 | 0.0000000000000% |
| −36,102,473 | −36,049,043 | 0.0000000000000% |
| −36,049,043 | −35,995,613 | 0.0000000000000% |
| −35,995,614 | −35,942,184 | 0.0000000000000% |
| −35,942,184 | −35,888,754 | 0.0000000000000% |
| −35,888,755 | −35,835,325 | 0.0000000000000% |
| −35,835,325 | −35,781,895 | 0.0000000000000% |
| −35,781,896 | −35,728,466 | 0.0000000000000% |
| −35,728,466 | −35,675,036 | 0.0000000000000% |
| −35,675,037 | −35,621,607 | 0.0000000000000% |
| −35,621,607 | −35,568,177 | 0.0000000000000% |
| −35,568,178 | −35,514,748 | 0.0000000000000% |
| −35,514,749 | −35,461,319 | 0.0000000000000% |
| −35,461,319 | −35,407,889 | 0.0000000000000% |
| −35,407,890 | −35,354,460 | 0.0000000000000% |
| −35,354,460 | −35,301,030 | 0.0000000000000% |
| −35,301,031 | −35,247,601 | 0.0000000000000% |
| −35,247,601 | −35,194,171 | 0.0000000000000% |
| −35,194,172 | −35,140,742 | 0.0000000000000% |
| −35,140,742 | −35,087,312 | 0.0000000000000% |
| −35,087,313 | −35,033,883 | 0.0000000000000% |
| −35,033,883 | −34,980,453 | 0.0000000000000% |
| −34,980,454 | −34,927,024 | 0.0000000000000% |
| −34,927,024 | −34,873,594 | 0.0000000000000% |
| −34,873,595 | −34,820,165 | 0.0000000000000% |
| −34,820,165 | −34,766,735 | 0.0000000000000% |
| −34,766,736 | −34,713,306 | 0.0000000000000% |
| −34,713,306 | −34,659,876 | 0.0000000000000% |
| −34,659,877 | −34,606,447 | 0.0000000000000% |
| −34,606,448 | −34,553,018 | 0.0000000000000% |
| −34,553,018 | −34,499,588 | 0.0000000000000% |
| −34,499,589 | −34,446,159 | 0.0000000000000% |
| −34,446,159 | −34,392,729 | 0.0000000000000% |
| −34,392,730 | −34,339,300 | 0.0000000000000% |
| −34,339,300 | −34,285,870 | 0.0000000000000% |
| −34,285,871 | −34,232,441 | 0.0000000000000% |
| −34,232,441 | −34,179,011 | 0.0000000000000% |
| −34,179,012 | −34,125,582 | 0.0000000000000% |
| −34,125,582 | −34,072,152 | 0.0000000000000% |
| −34,072,153 | −34,018,723 | 0.0000000000000% |
| −34,018,723 | −33,965,293 | 0.0000000000000% |
| −33,965,294 | −33,911,864 | 0.0000000000000% |
| −33,911,864 | −33,858,434 | 0.0000000000000% |
| −33,858,435 | −33,805,005 | 0.0000000000000% |
| −33,805,005 | −33,751,575 | 0.0000000000000% |
| −33,751,576 | −33,698,146 | 0.0000000000000% |
| −33,698,147 | −33,644,717 | 0.0000000000000% |
| −33,644,717 | −33,591,287 | 0.0000000000000% |
| −33,591,288 | −33,537,858 | 0.0000000000000% |
| −33,537,858 | −33,484,428 | 0.0000000000000% |
| −33,484,429 | −33,430,999 | 0.0000000000000% |
| −33,430,999 | −33,377,569 | 0.0000000000000% |
| −33,377,570 | −33,324,140 | 0.0000000000000% |
| −33,324,140 | −33,270,710 | 0.0000000000000% |
| −33,270,711 | −33,217,281 | 0.0000000000000% |
| −33,217,281 | −33,163,851 | 0.0000000000000% |
| −33,163,852 | −33,110,422 | 0.0000000000000% |
| −33,110,422 | −33,056,992 | 0.0000000000000% |
| −33,056,993 | −33,003,563 | 0.0000000000000% |
| −33,003,563 | −32,950,133 | 0.0000000000000% |
| −32,950,134 | −32,896,704 | 0.0000000000000% |
| −32,896,704 | −32,843,274 | 0.0000000000000% |
| −32,843,275 | −32,789,845 | 0.0000000000000% |
| −32,789,845 | −32,736,415 | 0.0000000000000% |
| −32,736,416 | −32,682,986 | 0.0000000000000% |
| −32,682,987 | −32,629,557 | 0.0000000000000% |
| −32,629,557 | −32,576,127 | 0.0000000000000% |
| −32,576,128 | −32,522,698 | 0.0000000000000% |
| −32,522,698 | −32,469,268 | 0.0000000000000% |
| −32,469,269 | −32,415,839 | 0.0000000000000% |
| −32,415,839 | −32,362,409 | 0.0000000000000% |
| −32,362,410 | −32,308,980 | 0.0000000000000% |
| −32,308,980 | −32,255,550 | 0.0000000000000% |
| −32,255,551 | −32,202,121 | 0.0000000000000% |
| −32,202,121 | −32,148,691 | 0.0000000000000% |
| −32,148,692 | −32,095,262 | 0.0000000000000% |
| −32,095,262 | −32,041,832 | 0.0000000000000% |
| −32,041,833 | −31,988,403 | 0.0000000000000% |
| −31,988,403 | −31,934,973 | 0.0000000000000% |
| −31,934,974 | −31,881,544 | 0.0000000000000% |
| −31,881,544 | −31,828,114 | 0.0000000000000% |
| −31,828,115 | −31,774,685 | 0.0000000000000% |
| −31,774,686 | −31,721,256 | 0.0000000000000% |
| −31,721,256 | −31,667,826 | 0.0000000000000% |
| −31,667,827 | −31,614,397 | 0.0000000000000% |
| −31,614,397 | −31,560,967 | 0.0000000000000% |
| −31,560,968 | −31,507,538 | 0.0000000000000% |
| −31,507,538 | −31,454,108 | 0.0000000000000% |
| −31,454,109 | −31,400,679 | 0.0000000000000% |
| −31,400,679 | −31,347,249 | 0.0000000000000% |
| −31,347,250 | −31,293,820 | 0.0000000000000% |
| −31,293,820 | −31,240,390 | 0.0000000000000% |
| −31,240,391 | −31,186,961 | 0.0000000000000% |
| −31,186,961 | −31,133,531 | 0.0000000000000% |
| −31,133,532 | −31,080,102 | 0.0000000000000% |
| −31,080,102 | −31,026,672 | 0.0000000000000% |
| −31,026,673 | −30,973,243 | 0.0000000000000% |
| −30,973,243 | −30,919,813 | 0.0000000000000% |
| −30,919,814 | −30,866,384 | 0.0000000000000% |
| −30,866,384 | −30,812,954 | 0.0000000000000% |
| −30,812,955 | −30,759,525 | 0.0000000000000% |
| −30,759,526 | −30,706,096 | 0.0000000000000% |
| −30,706,096 | −30,652,666 | 0.0000000000000% |
| −30,652,667 | −30,599,237 | 0.0000000000000% |
| −30,599,237 | −30,545,807 | 0.0000000000000% |
| −30,545,808 | −30,492,378 | 0.0000000000000% |
| −30,492,378 | −30,438,948 | 0.0000000000000% |
| −30,438,949 | −30,385,519 | 0.0000000000000% |
| −30,385,519 | −30,332,089 | 0.0000000000000% |
| −30,332,090 | −30,278,660 | 0.0000000000000% |
| −30,278,660 | −30,225,230 | 0.0000000000000% |
| −30,225,231 | −30,171,801 | 0.0000000000000% |
| −30,171,801 | −30,118,371 | 0.0000000000000% |
| −30,118,372 | −30,064,942 | 0.0000000000000% |
| −30,064,942 | −30,011,512 | 0.0000000000000% |
| −30,011,513 | −29,958,083 | 0.0000000000000% |
| −29,958,083 | −29,904,653 | 0.0000000000000% |
| −29,904,654 | −29,851,224 | 0.0000000000000% |
| −29,851,225 | −29,797,795 | 0.0000000000000% |
| −29,797,795 | −29,744,365 | 0.0000000000000% |
| −29,744,366 | −29,690,936 | 0.0000000000000% |
| −29,690,936 | −29,637,506 | 0.0000000000000% |
| −29,637,507 | −29,584,077 | 0.0000000000000% |
| −29,584,077 | −29,530,647 | 0.0000000000000% |
| −29,530,648 | −29,477,218 | 0.0000000000000% |
| −29,477,218 | −29,423,788 | 0.0000000000000% |
| −29,423,789 | −29,370,359 | 0.0000000000000% |
| −29,370,359 | −29,316,929 | 0.0000000000000% |
| −29,316,930 | −29,263,500 | 0.0000000000000% |
| −29,263,500 | −29,210,070 | 0.0000000000000% |
| −29,210,071 | −29,156,641 | 0.0000000000000% |
| −29,156,641 | −29,103,211 | 0.0000000000000% |
| −29,103,212 | −29,049,782 | 0.0000000000000% |
| −29,049,782 | −28,996,352 | 0.0000000000000% |
| −28,996,353 | −28,942,923 | 0.0000000000000% |
| −28,942,924 | −28,889,494 | 0.0000000000000% |
| −28,889,494 | −28,836,064 | 0.0000000000000% |
| −28,836,065 | −28,782,635 | 0.0000000000000% |
| −28,782,635 | −28,729,205 | 0.0000000000000% |
| −28,729,206 | −28,675,776 | 0.0000000000000% |
| −28,675,776 | −28,622,346 | 0.0000000000000% |
| −28,622,347 | −28,568,917 | 0.0000000000000% |
| −28,568,917 | −28,515,487 | 0.0000000000000% |
| −28,515,488 | −28,462,058 | 0.0000000000000% |
| −28,462,058 | −28,408,628 | 0.0000000000000% |
| −28,408,629 | −28,355,199 | 0.0000000000000% |
| −28,355,199 | −28,301,769 | 0.0000000000000% |
| −28,301,770 | −28,248,340 | 0.0000000000000% |
| −28,248,340 | −28,194,910 | 0.0000000000000% |
| −28,194,911 | −28,141,481 | 0.0000000000000% |
| −28,141,481 | −28,088,051 | 0.0000000000000% |
| −28,088,052 | −28,034,622 | 0.0000000000000% |
| −28,034,622 | −27,981,192 | 0.0000000000000% |
| −27,981,193 | −27,927,763 | 0.0000000000000% |
| −27,927,764 | −27,874,334 | 0.0000000000000% |
| −27,874,334 | −27,820,904 | 0.0000000000000% |
| −27,820,905 | −27,767,475 | 0.0000000000000% |
| −27,767,475 | −27,714,045 | 0.0000000000000% |
| −27,714,046 | −27,660,616 | 0.0000000000000% |
| −27,660,616 | −27,607,186 | 0.0000000000000% |
| −27,607,187 | −27,553,757 | 0.0000000000000% |
| −27,553,757 | −27,500,327 | 0.0000000000000% |
| −27,500,328 | −27,446,898 | 0.0000000000000% |
| −27,446,898 | −27,393,468 | 0.0000000000000% |
| −27,393,469 | −27,340,039 | 0.0000000000000% |
| −27,340,039 | −27,286,609 | 0.0000000000000% |
| −27,286,610 | −27,233,180 | 0.0000000000000% |
| −27,233,180 | −27,179,750 | 0.0000000000000% |
| −27,179,751 | −27,126,321 | 0.0000000000000% |
| −27,126,321 | −27,072,891 | 0.0000000000000% |
| −27,072,892 | −27,019,462 | 0.0000000000000% |
| −27,019,463 | −26,966,033 | 0.0000000000000% |
| −26,966,033 | −26,912,603 | 0.0000000000000% |
| −26,912,604 | −26,859,174 | 0.0000000000000% |
| −26,859,174 | −26,805,744 | 0.0000000000000% |
| −26,805,745 | −26,752,315 | 0.0000000000000% |
| −26,752,315 | −26,698,885 | 0.0000000000000% |
| −26,698,886 | −26,645,456 | 0.0000000000000% |
| −26,645,456 | −26,592,026 | 0.0000000000000% |
| −26,592,027 | −26,538,597 | 0.0000000000000% |
| −26,538,597 | −26,485,167 | 0.0000000000000% |
| −26,485,168 | −26,431,738 | 0.0000000000000% |
| −26,431,738 | −26,378,308 | 0.0000000000000% |
| −26,378,309 | −26,324,879 | 0.0000000000000% |
| −26,324,879 | −26,271,449 | 0.0000000000000% |
| −26,271,450 | −26,218,020 | 0.0000000000000% |
| −26,218,020 | −26,164,590 | 0.0000000000000% |
| −26,164,591 | −26,111,161 | 0.0000000000000% |
| −26,111,162 | −26,057,732 | 0.0000000000000% |
| −26,057,732 | −26,004,302 | 0.0000000000000% |
| −26,004,303 | −25,950,873 | 0.0000000000000% |
| −25,950,873 | −25,897,443 | 0.0000000000000% |
| −25,897,444 | −25,844,014 | 0.0000000000000% |
| −25,844,014 | −25,790,584 | 0.0000000000000% |
| −25,790,585 | −25,737,155 | 0.0000000000000% |
| −25,737,155 | −25,683,725 | 0.0000000000000% |
| −25,683,726 | −25,630,296 | 0.0000000000000% |
| −25,630,296 | −25,576,866 | 0.0000000000000% |
| −25,576,867 | −25,523,437 | 0.0000000000000% |
| −25,523,437 | −25,470,007 | 0.0000000000000% |
| −25,470,008 | −25,416,578 | 0.0000000000000% |
| −25,416,578 | −25,363,148 | 0.0000000000000% |
| −25,363,149 | −25,309,719 | 0.0000000000000% |
| −25,309,719 | −25,256,289 | 0.0000000000000% |
| −25,256,290 | −25,202,860 | 0.0000000000000% |
| −25,202,860 | −25,149,430 | 0.0000000000000% |
| −25,149,431 | −25,096,001 | 0.0000000000000% |
| −25,096,002 | −25,042,572 | 0.0000000000000% |
| −25,042,572 | −24,989,142 | 0.0000000000000% |
| −24,989,143 | −24,935,713 | 0.0000000000000% |
| −24,935,713 | −24,882,283 | 0.0000000000000% |
| −24,882,284 | −24,828,854 | 0.0000000000000% |
| −24,828,854 | −24,775,424 | 0.0000000000000% |
| −24,775,425 | −24,721,995 | 0.0000000000000% |
| −24,721,995 | −24,668,565 | 0.0000000000000% |
| −24,668,566 | −24,615,136 | 0.0000000000000% |
| −24,615,136 | −24,561,706 | 0.0000000000000% |
| −24,561,707 | −24,508,277 | 0.0000000000000% |
| −24,508,277 | −24,454,847 | 0.0000000000000% |
| −24,454,848 | −24,401,418 | 0.0000000000000% |
| −24,401,418 | −24,347,988 | 0.0000000000000% |
| −24,347,989 | −24,294,559 | 0.0000000000000% |
| −24,294,559 | −24,241,129 | 0.0000000000000% |
| −24,241,130 | −24,187,700 | 0.0000000000000% |
| −24,187,701 | −24,134,271 | 0.0000000000000% |
| −24,134,271 | −24,080,841 | 0.0000000000000% |
| −24,080,842 | −24,027,412 | 0.0000000000000% |
| −24,027,412 | −23,973,982 | 0.0000000000000% |
| −23,973,983 | −23,920,553 | 0.0000000000000% |
| −23,920,553 | −23,867,123 | 0.0000000000000% |
| −23,867,124 | −23,813,694 | 0.0000000000000% |
| −23,813,694 | −23,760,264 | 0.0000000000000% |
| −23,760,265 | −23,706,835 | 0.0000000000000% |
| −23,706,835 | −23,653,405 | 0.0000000000000% |
| −23,653,406 | −23,599,976 | 0.0000000000000% |
| −23,599,976 | −23,546,546 | 0.0000000000000% |
| −23,546,547 | −23,493,117 | 0.0000000000000% |
| −23,493,117 | −23,439,687 | 0.0000000000000% |
| −23,439,688 | −23,386,258 | 0.0000000000000% |
| −23,386,258 | −23,332,828 | 0.0000000000000% |
| −23,332,829 | −23,279,399 | 0.0000000000000% |
| −23,279,399 | −23,225,969 | 0.0000000000000% |
| −23,225,970 | −23,172,540 | 0.0000000000000% |
| −23,172,541 | −23,119,111 | 0.0000000000000% |
| −23,119,111 | −23,065,681 | 0.0000000000000% |
| −23,065,682 | −23,012,252 | 0.0000000000000% |
| −23,012,252 | −22,958,822 | 0.0000000000000% |
| −22,958,823 | −22,905,393 | 0.0000000000000% |
| −22,905,393 | −22,851,963 | 0.0000000000000% |
| −22,851,964 | −22,798,534 | 0.0000000000000% |
| −22,798,534 | −22,745,104 | 0.0000000000000% |
| −22,745,105 | −22,691,675 | 0.0000000000000% |
| −22,691,675 | −22,638,245 | 0.0000000000000% |
| −22,638,246 | −22,584,816 | 0.0000000000000% |
| −22,584,816 | −22,531,386 | 0.0000000000000% |
| −22,531,387 | −22,477,957 | 0.0000000000000% |
| −22,477,957 | −22,424,527 | 0.0000000000000% |
| −22,424,528 | −22,371,098 | 0.0000000000000% |
| −22,371,098 | −22,317,668 | 0.0000000000000% |
| −22,317,669 | −22,264,239 | 0.0000000000000% |
| −22,264,240 | −22,210,810 | 0.0000000000000% |
| −22,210,810 | −22,157,380 | 0.0000000000000% |
| −22,157,381 | −22,103,951 | 0.0000000000000% |
| −22,103,951 | −22,050,521 | 0.0000000000000% |
| −22,050,522 | −21,997,092 | 0.0000000000000% |
| −21,997,092 | −21,943,662 | 0.0000000000000% |
| −21,943,663 | −21,890,233 | 0.0000000000000% |
| −21,890,233 | −21,836,803 | 0.0000000000000% |
| −21,836,804 | −21,783,374 | 0.0000000000000% |
| −21,783,374 | −21,729,944 | 0.0000000000000% |
| −21,729,945 | −21,676,515 | 0.0000000000000% |
| −21,676,515 | −21,623,085 | 0.0000000000000% |
| −21,623,086 | −21,569,656 | 0.0000000000000% |
| −21,569,656 | −21,516,226 | 0.0000000000000% |
| −21,516,227 | −21,462,797 | 0.0000000000000% |
| −21,462,797 | −21,409,367 | 0.0000000000000% |
| −21,409,368 | −21,355,938 | 0.0000000000000% |
| −21,355,939 | −21,302,509 | 0.0000000000000% |
| −21,302,509 | −21,249,079 | 0.0000000000000% |
| −21,249,080 | −21,195,650 | 0.0000000000000% |
| −21,195,650 | −21,142,220 | 0.0000000000000% |
| −21,142,221 | −21,088,791 | 0.0000000000000% |
| −21,088,791 | −21,035,361 | 0.0000000000000% |
| −21,035,362 | −20,981,932 | 0.0000000000000% |
| −20,981,932 | −20,928,502 | 0.0000000000000% |
| −20,928,503 | −20,875,073 | 0.0000000000000% |
| −20,875,073 | −20,821,643 | 0.0000000000000% |
| −20,821,644 | −20,768,214 | 0.0000000000000% |
| −20,768,214 | −20,714,784 | 0.0000000000000% |
| −20,714,785 | −20,661,355 | 0.0000000000000% |
| −20,661,355 | −20,607,925 | 0.0000000000000% |
| −20,607,926 | −20,554,496 | 0.0000000000000% |
| −20,554,496 | −20,501,066 | 0.0000000000000% |
| −20,501,067 | −20,447,637 | 0.0000000000000% |
| −20,447,637 | −20,394,207 | 0.0000000000000% |
| −20,394,208 | −20,340,778 | 0.0000000000000% |
| −20,340,779 | −20,287,349 | 0.0000000000000% |
| −20,287,349 | −20,233,919 | 0.0000000000000% |
| −20,233,920 | −20,180,490 | 0.0000000000000% |
| −20,180,490 | −20,127,060 | 0.0000000000000% |
| −20,127,061 | −20,073,631 | 0.0000000000000% |
| −20,073,631 | −20,020,201 | 0.0000000000000% |
| −20,020,202 | −19,966,772 | 0.0000000000000% |
| −19,966,772 | −19,913,342 | 0.0000000000000% |
| −19,913,343 | −19,859,913 | 0.0000000000000% |
| −19,859,913 | −19,806,483 | 0.0000000000000% |
| −19,806,484 | −19,753,054 | 0.0000000000000% |
| −19,753,054 | −19,699,624 | 0.0000000000000% |
| −19,699,625 | −19,646,195 | 0.0000000000000% |
| −19,646,195 | −19,592,765 | 0.0000000000000% |
| −19,592,766 | −19,539,336 | 0.0000000000000% |
| −19,539,336 | −19,485,906 | 0.0000000000000% |
| −19,485,907 | −19,432,477 | 0.0000000000000% |
| −19,432,478 | −19,379,048 | 0.0000000000000% |
| −19,379,048 | −19,325,618 | 0.0000000000000% |
| −19,325,619 | −19,272,189 | 0.0000000000000% |
| −19,272,189 | −19,218,759 | 0.0000000000000% |
| −19,218,760 | −19,165,330 | 0.0000000000000% |
| −19,165,330 | −19,111,900 | 0.0000000000000% |
| −19,111,901 | −19,058,471 | 0.0000000000000% |
| −19,058,471 | −19,005,041 | 0.0000000000000% |
| −19,005,042 | −18,951,612 | 0.0000000000000% |
| −18,951,612 | −18,898,182 | 0.0000000000000% |
| −18,898,183 | −18,844,753 | 0.0000000000000% |
| −18,844,753 | −18,791,323 | 0.0000000000000% |
| −18,791,324 | −18,737,894 | 0.0000000000000% |
| −18,737,894 | −18,684,464 | 0.0000000000000% |
| −18,684,465 | −18,631,035 | 0.0000000000000% |
| −18,631,035 | −18,577,605 | 0.0000000000000% |
| −18,577,606 | −18,524,176 | 0.0000000000000% |
| −18,524,176 | −18,470,746 | 0.0000000000000% |
| −18,470,747 | −18,417,317 | 0.0000000000000% |
| −18,417,318 | −18,363,888 | 0.0000000000000% |
| −18,363,888 | −18,310,458 | 0.0000000000000% |
| −18,310,459 | −18,257,029 | 0.0000000000000% |
| −18,257,029 | −18,203,599 | 0.0000000000000% |
| −18,203,600 | −18,150,170 | 0.0000000000000% |
| −18,150,170 | −18,096,740 | 0.0000000000000% |
| −18,096,741 | −18,043,311 | 0.0000000000000% |
| −18,043,311 | −17,989,881 | 0.0000000000000% |
| −17,989,882 | −17,936,452 | 0.0000000000000% |
| −17,936,452 | −17,883,022 | 0.0000000000000% |
| −17,883,023 | −17,829,593 | 0.0000000000000% |
| −17,829,593 | −17,776,163 | 0.0000000000000% |
| −17,776,164 | −17,722,734 | 0.0000000000000% |
| −17,722,734 | −17,669,304 | 0.0000000000000% |
| −17,669,305 | −17,615,875 | 0.0000000000000% |
| −17,615,875 | −17,562,445 | 0.0000000000000% |
| −17,562,446 | −17,509,016 | 0.0000000000000% |
| −17,509,017 | −17,455,587 | 0.0000000000000% |
| −17,455,587 | −17,402,157 | 0.0000000000000% |
| −17,402,158 | −17,348,728 | 0.0000000000000% |
| −17,348,728 | −17,295,298 | 0.0000000000000% |
| −17,295,299 | −17,241,869 | 0.0000000000000% |
| −17,241,869 | −17,188,439 | 0.0000000000000% |
| −17,188,440 | −17,135,010 | 0.0000000000000% |
| −17,135,010 | −17,081,580 | 0.0000000000000% |
| −17,081,581 | −17,028,151 | 0.0000000000000% |
| −17,028,151 | −16,974,721 | 0.0000000000000% |
| −16,974,722 | −16,921,292 | 0.0000000000000% |
| −16,921,292 | −16,867,862 | 0.0000000000000% |
| −16,867,863 | −16,814,433 | 0.0000000000000% |
| −16,814,433 | −16,761,003 | 0.0000000000000% |
| −16,761,004 | −16,707,574 | 0.0000000000000% |
| −16,707,574 | −16,654,144 | 0.0000000000000% |
| −16,654,145 | −16,600,715 | 0.0000000000000% |
| −16,600,716 | −16,547,286 | 0.0000000000000% |
| −16,547,286 | −16,493,856 | 0.0000000000000% |
| −16,493,857 | −16,440,427 | 0.0000000000000% |
| −16,440,427 | −16,386,997 | 0.0000000000000% |
| −16,386,998 | −16,333,568 | 0.0000000000000% |
| −16,333,568 | −16,280,138 | 0.0000000000000% |
| −16,280,139 | −16,226,709 | 0.0000000000000% |
| −16,226,709 | −16,173,279 | 0.0000000000000% |
| −16,173,280 | −16,119,850 | 0.0000000000000% |
| −16,119,850 | −16,066,420 | 0.0000000000000% |
| −16,066,421 | −16,012,991 | 0.0000000000000% |
| −16,012,991 | −15,959,561 | 0.0000000000000% |
| −15,959,562 | −15,906,132 | 0.0000000000000% |
| −15,906,132 | −15,852,702 | 0.0000000000000% |
| −15,852,703 | −15,799,273 | 0.0000000000000% |
| −13,394,947 | −13,341,517 | 0.0000000000000% |
| −13,341,518 | −13,288,088 | 0.0000000000000% |
| −13,288,088 | −13,234,658 | 0.0000000000000% |
| −13,234,659 | −13,181,229 | 0.0000000000000% |
| −13,181,229 | −13,127,799 | 0.0000000000000% |
| −13,127,800 | −13,074,370 | 0.0000000000000% |
| −13,074,370 | −13,020,940 | 0.0000000000000% |
| −13,020,941 | −12,967,511 | 0.0000000000000% |
| −12,967,511 | −12,914,081 | 0.0000000000000% |
| −12,914,082 | −12,860,652 | 0.0000000000000% |
| −12,860,652 | −12,807,222 | 0.0000000000000% |
| −12,807,223 | −12,753,793 | 0.0000000000000% |
| −12,753,794 | −12,700,364 | 0.0000000000000% |
| −12,700,364 | −12,646,934 | 0.0000000000000% |
| −12,646,935 | −12,593,505 | 0.0000000000000% |
| −12,593,505 | −12,540,075 | 0.0000000000000% |
| −12,540,076 | −12,486,646 | 0.0000000000000% |
| −12,486,646 | −12,433,216 | 0.0000000000000% |
| −12,433,217 | −12,379,787 | 0.0000000000000% |
| −12,379,787 | −12,326,357 | 0.0000000000000% |
| −12,326,358 | −12,272,928 | 0.0000000000000% |
| −12,272,928 | −12,219,498 | 0.0000000000000% |
| −12,219,499 | −12,166,069 | 0.0000000000000% |
| −12,166,069 | −12,112,639 | 0.0000000000000% |
| −12,112,640 | −12,059,210 | 0.0000000000000% |
| −12,059,210 | −12,005,780 | 0.0000000000000% |
| −12,005,781 | −11,952,351 | 0.0000000000000% |
| −11,952,351 | −11,898,921 | 0.0000000000000% |
| −11,898,922 | −11,845,492 | 0.0000000000000% |
| −11,845,493 | −11,792,063 | 0.0000000000000% |
| −11,792,063 | −11,738,633 | 0.0000000000000% |
| −11,738,634 | −11,685,204 | 0.0000000000000% |
| −11,685,204 | −11,631,774 | 0.0000000000000% |
| −11,631,775 | −11,578,345 | 0.0000000000000% |
| −11,578,345 | −11,524,915 | 0.0000000000000% |
| −11,524,916 | −11,471,486 | 0.0000000000000% |
| −11,471,486 | −11,418,056 | 0.0000000000000% |
| −11,418,057 | −11,364,627 | 0.0000000000000% |
| −11,364,627 | −11,311,197 | 0.0000000000000% |
| −11,311,198 | −11,257,768 | 0.0000000000000% |
| −11,257,768 | −11,204,338 | 0.0000000000000% |
| −11,204,339 | −11,150,909 | 0.0000000000000% |
| −11,150,909 | −11,097,479 | 0.0000000000000% |
| −11,097,480 | −11,044,050 | 0.0000000000000% |
| −11,044,050 | −10,990,620 | 0.0000000000000% |
| −10,990,621 | −10,937,191 | 0.0000000000000% |
| −10,937,191 | −10,883,761 | 0.0000000000000% |
| −10,883,762 | −10,830,332 | 0.0000000000000% |
| −10,830,333 | −10,776,903 | 0.0000000000000% |
| −10,776,903 | −10,723,473 | 0.0000000000000% |
| −10,723,474 | −10,670,044 | 0.0000000000000% |
| −10,670,044 | −10,616,614 | 0.0000000000000% |
| −10,616,615 | −10,563,185 | 0.0000000000000% |
| −10,563,185 | −10,509,755 | 0.0000000000000% |
| −10,509,756 | −10,456,326 | 0.0000000000000% |
| −10,456,326 | −10,402,896 | 0.0000000000000% |
| −10,402,897 | −10,349,467 | 0.0000000000000% |
| −10,349,467 | −10,296,037 | 0.0000000000000% |
| −10,296,038 | −10,242,608 | 0.0000000000000% |
| −10,242,608 | −10,189,178 | 0.0000000000000% |
| −10,189,179 | −10,135,749 | 0.0000000000000% |
| −10,135,749 | −10,082,319 | 0.0000000000000% |
| −10,082,320 | −10,028,890 | 0.0000000000000% |
| −10,028,890 | −9,975,460 | 0.0000000000000% |
| −9,975,461 | −9,922,031 | 0.0000000000000% |
| −9,922,032 | −9,868,602 | 0.0000000000000% |
| −9,868,602 | −9,815,172 | 0.0000000000000% |
| −9,815,173 | −9,761,743 | 0.0000000000000% |
| −9,761,743 | −9,708,313 | 0.0000000000000% |
| −9,708,314 | −9,654,884 | 0.0000000000000% |
| −9,654,884 | −9,601,454 | 0.0000000000000% |
| −9,601,455 | −9,548,025 | 0.0000000000000% |
| −9,548,025 | −9,494,595 | 0.0000000000000% |
| −9,494,596 | −9,441,166 | 0.0000000000000% |
| −9,441,166 | −9,387,736 | 0.0000000000000% |
| −9,387,737 | −9,334,307 | 0.0000000000000% |
| −9,334,307 | −9,280,877 | 0.0000000000000% |
| −9,280,878 | −9,227,448 | 0.0000000000000% |
| −9,227,448 | −9,174,018 | 0.0000000000000% |
| −9,174,019 | −9,120,589 | 0.0000000000000% |
| −9,120,589 | −9,067,159 | 0.0000000000000% |
| −9,067,160 | −9,013,730 | 0.0000000000000% |
| −9,013,731 | −8,960,301 | 0.0000000000000% |
| −8,960,301 | −8,906,871 | 0.0000000000000% |
| −8,906,872 | −8,853,442 | 0.0000000000000% |
| −8,853,442 | −8,800,012 | 0.0000000000000% |
| −8,800,013 | −8,746,583 | 0.0000000000000% |
| −8,746,583 | −8,693,153 | 0.0000000000000% |
| −8,693,154 | −8,639,724 | 0.0000000000000% |
| −8,639,724 | −8,586,294 | 0.0000000000000% |
| −8,586,295 | −8,532,865 | 0.0000000000000% |
| −8,532,865 | −8,479,435 | 0.0000000000000% |
| −8,479,436 | −8,426,006 | 0.0000000000000% |
| −8,426,006 | −8,372,576 | 0.0000000000000% |
| −8,372,577 | −8,319,147 | 0.0000000000000% |
| −8,319,147 | −8,265,717 | 0.0000000000000% |
| −8,265,718 | −8,212,288 | 0.0000000000000% |
| −8,212,288 | −8,158,858 | 0.0000000000000% |
| −8,158,859 | −8,105,429 | 0.0000000000000% |
| −8,105,429 | −8,051,999 | 0.0000000000000% |
| −8,052,000 | −7,998,570 | 0.0000000000000% |
| −7,998,571 | −7,945,141 | 0.0000000000000% |
| −7,945,141 | −7,891,711 | 0.0000000000000% |
| −7,891,712 | −7,838,282 | 0.0000000000000% |
| −7,838,282 | −7,784,852 | 0.0000000000000% |
| −7,784,853 | −7,731,423 | 0.0000000000000% |
| −7,731,423 | −7,677,993 | 0.0000000000000% |
| −7,677,994 | −7,624,564 | 0.0000000000000% |
| −7,624,564 | −7,571,134 | 0.0000000000000% |
| −7,571,135 | −7,517,705 | 0.0000000000000% |
| −7,517,705 | −7,464,275 | 0.0000000000000% |
| −7,464,276 | −7,410,846 | 0.0000000000000% |
| −7,410,846 | −7,357,416 | 0.0000000000000% |
| −7,357,417 | −7,303,987 | 0.0000000000000% |
| −7,303,987 | −7,250,557 | 0.0000000000000% |
| −7,250,558 | −7,197,128 | 0.0000000000000% |
| −7,197,128 | −7,143,698 | 0.0000000000000% |
| −7,143,699 | −7,090,269 | 0.0000000000000% |
| −7,090,270 | −7,036,840 | 0.0000000000000% |
| −7,036,840 | −6,983,410 | 0.0000000000000% |
| −6,983,411 | −6,929,981 | 0.0000000000000% |
| −6,929,981 | −6,876,551 | 0.0000000000000% |
| −6,876,552 | −6,823,122 | 0.0000000000000% |
| −6,823,122 | −6,769,692 | 0.0000000000000% |
| −6,769,693 | −6,716,263 | 0.0000000000000% |
| −6,716,263 | −6,662,833 | 0.0000000000000% |
| −6,662,834 | −6,609,404 | 0.0000000000000% |
| −6,609,404 | −6,555,974 | 0.0000000000000% |
| −6,555,975 | −6,502,545 | 0.0000000000000% |
| −6,502,545 | −6,449,115 | 0.0000000000000% |
| −6,449,116 | −6,395,686 | 0.0000000000000% |
| −6,395,686 | −6,342,256 | 0.0000000000000% |
| −6,342,257 | −6,288,827 | 0.0000000000000% |
| −6,288,827 | −6,235,397 | 0.0000000000000% |
| −6,235,398 | −6,181,968 | 0.0000000000000% |
| −6,181,968 | −6,128,538 | 0.0000000000000% |
| −6,128,539 | −6,075,109 | 0.0000000000000% |
| −6,075,110 | −6,021,680 | 0.0000000000000% |
| −6,021,680 | −5,968,250 | 0.0000000000000% |
| −5,968,251 | −5,914,821 | 0.0000000000000% |
| −5,914,821 | −5,861,391 | 0.0000000000000% |
| −5,861,392 | −5,807,962 | 0.0000000000000% |
| −5,807,962 | −5,754,532 | 0.0000000000000% |
| −5,754,533 | −5,701,103 | 0.0000000000000% |
| −5,701,103 | −5,647,673 | 0.0000000000000% |
| −5,647,674 | −5,594,244 | 0.0000000000000% |
| −5,594,244 | −5,540,814 | 0.0000000000000% |
| −5,540,815 | −5,487,385 | 0.0000000000000% |
| −5,487,385 | −5,433,955 | 0.0000000000000% |
| −5,433,956 | −5,380,526 | 0.0000000000000% |
| −5,380,526 | −5,327,096 | 0.0000000000000% |
| −5,327,097 | −5,273,667 | 0.0000000000000% |
| −5,273,667 | −5,220,237 | 0.0000000000000% |
| −5,220,238 | −5,166,808 | 0.0000000000000% |
| −5,166,809 | −5,113,379 | 0.0000000000000% |
| −5,113,379 | −5,059,949 | 0.0000000000000% |
| −5,059,950 | −5,006,520 | 0.0000000000000% |
| −5,006,520 | −4,953,090 | 0.0000000000000% |
| −4,953,091 | −4,899,661 | 0.0000000000000% |
| −4,899,661 | −4,846,231 | 0.0000000000000% |
| −4,846,232 | −4,792,802 | 0.0000000000000% |
| −4,792,802 | −4,739,372 | 0.0000000000000% |
| −4,739,373 | −4,685,943 | 0.0000000000000% |
| −4,685,943 | −4,632,513 | 0.0000000000000% |
| −4,632,514 | −4,579,084 | 0.0000000000000% |
| −4,579,084 | −4,525,654 | 0.0000000000000% |
| −4,525,655 | −4,472,225 | 0.0000000000000% |
| −4,472,225 | −4,418,795 | 0.0000000000000% |
| −4,418,796 | −4,365,366 | 0.0000000000000% |
| −4,365,366 | −4,311,936 | 0.0000000000000% |
| −4,311,937 | −4,258,507 | 0.0000000000000% |
| −4,258,508 | −4,205,078 | 0.0000000000000% |
| −4,205,078 | −4,151,648 | 0.0000000000000% |
| −4,151,649 | −4,098,219 | 0.0000000000000% |
| −4,098,219 | −4,044,789 | 0.0000000000000% |
| −4,044,790 | −3,991,360 | 0.0000000000000% |
| −3,991,360 | −3,937,930 | 0.0000000000000% |
| −3,937,931 | −3,884,501 | 0.0000000000000% |
| −3,884,501 | −3,831,071 | 0.0000000000000% |
| −3,831,072 | −3,777,642 | 0.0000000000000% |
| −3,777,642 | −3,724,212 | 0.0000000000000% |
| −3,724,213 | −3,670,783 | 0.0000000000000% |
| −3,670,783 | −3,617,353 | 0.0000000000000% |
| −3,617,354 | −3,563,924 | 0.0000000000000% |
| −3,563,924 | −3,510,494 | 0.0000000000000% |
| −3,510,495 | −3,457,065 | 0.0000000000000% |
| −3,457,065 | −3,403,635 | 0.0000000000000% |
| −3,403,636 | −3,350,206 | 0.0000000000000% |
| −3,350,206 | −3,296,776 | 0.0000000000000% |
| −3,296,777 | −3,243,347 | 0.0000000000000% |
| −3,243,348 | −3,189,918 | 0.0000000000000% |
| −3,189,918 | −3,136,488 | 0.0000000000000% |
| −3,136,489 | −3,083,059 | 0.0000000000000% |
| −3,083,059 | −3,029,629 | 0.0000000000000% |
| −3,029,630 | −2,976,200 | 0.0000000000000% |
| −2,976,200 | −2,922,770 | 0.0000000000000% |
| −2,922,771 | −2,869,341 | 0.0000000000000% |
| −2,869,341 | −2,815,911 | 0.0000000000000% |
| −2,815,912 | −2,762,482 | 0.0000000000002% |
| −2,762,482 | −2,709,052 | 0.0000000000008% |
| −2,709,053 | −2,655,623 | 0.0000000000033% |
| −2,655,623 | −2,602,193 | 0.0000000000125% |
| −2,602,194 | −2,548,764 | 0.0000000000475% |
| −2,548,764 | −2,495,334 | 0.0000000001747% |
| −2,495,335 | −2,441,905 | 0.0000000006651% |
| −2,441,905 | −2,388,475 | 0.0000000024238% |
| −2,388,476 | −2,335,046 | 0.0000000080978% |
| −2,335,047 | −2,281,617 | 0.0000000253481% |
| −2,281,617 | −2,228,187 | 0.0000000733211% |
| −2,228,188 | −2,174,758 | 0.0000001867159% |
| −2,174,758 | −2,121,328 | 0.0000004261562% |
| −2,121,329 | −2,067,899 | 0.0000009313194% |
| −2,067,899 | −2,014,469 | 0.0000019335706% |
| −2,014,470 | −1,961,040 | 0.0000038676092% |
| −1,961,040 | −1,907,610 | 0.0000074638267% |
| −1,907,611 | −1,854,181 | 0.0000141004062% |
| −1,854,181 | −1,800,751 | 0.0000257187458% |
| −1,800,752 | −1,747,322 | 0.0000458625286% |
| −1,747,322 | −1,693,892 | 0.0000795564894% |
| −1,693,893 | −1,640,463 | 0.0001345972909% |
| −1,640,463 | −1,587,033 | 0.0002246125068% |
| −1,587,034 | −1,533,604 | 0.0003644253615% |
| −1,533,604 | −1,480,174 | 0.0005839457471% |
| −1,480,175 | −1,426,745 | 0.0009214492554% |
| −1,426,746 | −1,373,316 | 0.0014287777387% |
| −1,373,316 | −1,319,886 | 0.0021861542251% |
| −1,319,887 | −1,266,457 | 0.0032501470111% |
| −1,266,457 | −1,213,027 | 0.0047862710163% |
| −1,213,028 | −1,159,598 | 0.0069321633908% |
| −1,159,598 | −1,106,168 | 0.0098108149165% |
| −1,106,169 | −1,052,739 | 0.0137710109755% |
| −1,052,739 | −999,309 | 0.0191361811519% |
| −999,310 | −945,880 | 0.0263632903599% |
| −945,880 | −892,450 | 0.0364035878949% |
| −892,451 | −839,021 | 0.0499307672471% |
| −839,021 | −785,591 | 0.0683278672882% |
| −785,592 | −732,162 | 0.0933978212063% |
| −732,162 | −678,732 | 0.1256591657555% |
| −678,733 | −625,303 | 0.1683302008600% |
| −625,303 | −571,873 | 0.2216802362905% |
| −571,874 | −518,444 | 0.2902420118881% |
| −518,444 | −465,014 | 0.3753515510399% |
| −465,015 | −411,585 | 0.4802162030795% |
| −411,586 | −358,156 | 0.6150651589033% |
| −358,156 | −304,726 | 0.7776280285252% |
| −304,727 | −251,297 | 0.9823703282698% |
| −251,297 | −197,867 | 1.2387139540238% |
| −197,868 | −144,438 | 1.5505610613359% |
| −144,438 | −91,008 | 1.9345467317144% |
| −91,009 | −37,579 | 2.3948077231803% |
| −37,579 | 15,851 | 2.9538798318203% |
| 15,850 | 69,280 | 3.6179091831141% |
| 69,280 | 122,710 | 4.3842791490843% |
| 122,709 | 176,139 | 5.2926808415697% |
| 176,139 | 229,569 | 6.3307564485749% |
| 229,568 | 282,998 | 7.4937256652527% |
| 282,998 | 336,428 | 8.8509768451619% |
| 336,427 | 389,857 | 10.3549745057132% |
| 389,857 | 443,287 | 12.1026820733734% |
| 443,286 | 496,716 | 13.9865965070720% |
| 496,715 | 550,145 | 16.1839804158823% |
| 550,145 | 603,575 | 18.6778992565306% |
| 603,574 | 657,004 | 21.3131673703113% |
| 657,004 | 710,434 | 24.2901947774939% |
| 710,433 | 763,863 | 27.4594989869027% |
| 763,863 | 817,293 | 30.8178257845057% |
| 817,292 | 870,722 | 34.3156494106901% |
| 870,722 | 924,152 | 37.8993836918944% |
| 924,151 | 977,581 | 41.7047034936096% |
| 977,581 | 1,031,011 | 45.4838918012672% |
| 1,031,010 | 1,084,440 | 49.3518510412647% |
| 1,084,440 | 1,137,870 | 53.3242640527161% |
| 1,137,869 | 1,191,299 | 57.2425970659684% |
| 1,191,299 | 1,244,729 | 61.2546072517691% |
| 1,244,728 | 1,298,158 | 65.0696980726194% |
| 1,298,158 | 1,351,588 | 68.7239632498141% |
| 1,351,587 | 1,405,017 | 72.4133312265365% |
| 1,405,017 | 1,458,447 | 75.7202577860827% |
| 1,458,446 | 1,511,876 | 78.8775420341887% |
| 1,511,875 | 1,565,305 | 81.6583654488451% |
| 1,565,305 | 1,618,735 | 84.2768550319979% |
| 1,618,734 | 1,672,164 | 86.6393038496071% |
| 1,672,164 | 1,725,594 | 88.6365901525135% |
| 1,725,593 | 1,779,023 | 90.5070476758832% |
| 1,779,023 | 1,832,453 | 92.0916604232132% |
| 1,832,452 | 1,885,882 | 93.4520913732819% |
| 1,885,882 | 1,939,312 | 94.6641437596668% |
| 1,939,311 | 1,992,741 | 95.6604823479376% |
| 1,992,741 | 2,046,171 | 96.5398453395601% |
| 2,046,170 | 2,099,600 | 97.2399787681478% |
| 2,099,600 | 2,153,030 | 97.8256265208915% |
| 2,153,029 | 2,206,459 | 98.3203924612396% |
| 2,206,459 | 2,259,889 | 98.7015365259410% |
| 2,259,888 | 2,313,318 | 99.0159661616815% |
| 2,313,318 | 2,366,748 | 99.2576908230848% |
| 2,366,747 | 2,420,177 | 99.4452148724730% |
| 2,420,176 | 2,473,606 | 99.5928985523235% |
| 2,473,606 | 2,527,036 | 99.6991870185069% |
| 2,527,035 | 2,580,465 | 99.7831157143216% |
| 2,580,465 | 2,633,895 | 99.8438233660748% |
| 2,633,894 | 2,687,324 | 99.8886319332064% |
| 2,687,324 | 2,740,754 | 99.9218006251294% |
| 2,740,753 | 2,794,183 | 99.9452612568851% |
| 2,794,183 | 2,847,613 | 99.9625774871492% |
| 2,847,612 | 2,901,042 | 99.9744035061454% |
| 2,901,042 | 2,954,472 | 99.9827838751501% |
| 2,954,471 | 3,007,901 | 99.9886010922153% |
| 3,007,901 | 3,061,331 | 99.9924671542066% |
| 3,061,330 | 3,114,760 | 99.9951488335340% |
| 3,114,760 | 3,168,190 | 99.9968908688022% |
| 3,168,189 | 3,221,619 | 99.9980405960304% |
| 3,221,619 | 3,275,049 | 99.9987797593890% |
| 3,275,048 | 3,328,478 | 99.9992410744171% |
| 3,328,477 | 3,381,907 | 99.9995434133531% |
| 3,381,907 | 3,435,337 | 99.9997257966347% |
| 3,435,336 | 3,488,766 | 99.9998370151959% |
| 3,488,766 | 3,542,196 | 99.9999052533947% |
| 3,542,195 | 3,595,625 | 99.9999451782640% |
| 3,595,625 | 3,649,055 | 99.9999689426822% |
| 3,649,054 | 3,702,484 | 99.9999826429842% |
| 3,702,484 | 3,755,914 | 99.9999903458163% |
| 3,755,913 | 3,809,343 | 99.9999947534083% |
| 3,809,343 | 3,862,773 | 99.9999971465665% |
| 3,862,772 | 3,916,202 | 99.9999985024046% |
| 3,916,202 | 3,969,632 | 99.9999992188081% |
| 3,969,631 | 4,023,061 | 99.9999995999997% |
| 4,023,061 | 4,076,491 | 99.9999997988438% |
| 4,076,490 | 4,129,920 | 99.9999998993262% |
| 4,129,920 | 4,183,350 | 99.9999999521190% |
| 4,183,349 | 4,236,779 | 99.9999999771398% |
| 4,236,779 | 4,290,209 | 99.9999999894436% |
| 4,290,208 | 4,343,638 | 99.9999999951710% |
| 4,343,637 | 4,397,067 | 99.9999999978285% |
| 4,397,067 | 4,450,497 | 99.9999999990703% |
| 4,450,496 | 4,503,926 | 99.9999999995951% |
| 4,503,926 | 4,557,356 | 99.9999999998311% |
| 4,557,355 | 4,610,785 | 99.9999999999319% |
| 4,610,785 | 4,664,215 | 99.9999999999728% |
| 4,664,214 | 4,717,644 | 99.9999999999896% |
| 4,717,644 | 4,771,074 | 99.9999999999959% |
| 4,771,073 | 4,824,503 | 99.9999999999985% |
| 4,824,503 | 4,877,933 | 99.9999999999995% |
| 4,877,932 | 4,931,362 | 99.9999999999998% |
| 4,931,362 | 4,984,792 | 100.0000000000000% |
| 4,984,791 | 5,038,221 | 100.0000000000000% |
| 5,038,221 | 5,091,651 | 100.0000000000000% |
| 5,091,650 | 5,145,080 | 100.0000000000000% |
| 5,145,080 | 5,198,510 | 100.0000000000000% |
| 5,198,509 | 5,251,939 | 100.0000000000000% |
| 5,251,938 | 5,305,368 | 100.0000000000000% |
| 5,305,368 | 5,358,798 | 100.0000000000000% |
| 5,358,797 | 5,412,227 | 100.0000000000000% |
| 5,412,227 | 5,465,657 | 100.0000000000000% |
| 5,465,656 | 5,519,086 | 100.0000000000000% |
| 5,519,086 | 5,572,516 | 100.0000000000000% |
| 5,572,515 | 5,625,945 | 100.0000000000000% |
| 5,625,945 | 5,679,375 | 100.0000000000000% |
| 5,679,374 | 5,732,804 | 100.0000000000000% |
| 5,732,804 | 5,786,234 | 100.0000000000000% |
| 5,786,233 | 5,839,663 | 100.0000000000000% |
| 5,839,663 | 5,893,093 | 100.0000000000000% |
| 5,893,092 | 5,946,522 | 100.0000000000000% |
| 5,946,522 | 5,999,952 | 100.0000000000000% |
| 5,999,951 | 6,053,381 | 100.0000000000000% |
| 6,053,381 | 6,106,811 | 100.0000000000000% |
| 6,106,810 | 6,160,240 | 100.0000000000000% |
| 6,160,240 | 6,213,670 | 100.0000000000000% |
| 6,213,669 | 6,267,099 | 100.0000000000000% |
| 6,267,098 | 6,320,528 | 100.0000000000000% |
| 6,320,528 | 6,373,958 | 100.0000000000000% |
| 6,373,957 | 6,427,387 | 100.0000000000000% |
| 6,427,387 | 6,480,817 | 100.0000000000000% |
| 6,480,816 | 6,534,246 | 100.0000000000000% |
| 6,534,246 | 6,587,676 | 100.0000000000000% |
| 6,587,675 | 6,641,105 | 100.0000000000000% |

What is claimed is:

1. A method for constructing a historically based frequency distribution of unknown ultimate outcomes in a data set, the method comprising the following acts:
A. collecting relevant data about a series of known cohorts, where a new group of the data emerges at regular time intervals, measuring a characteristic of each group of the data at regular time intervals, and entering each said characteristic into a data set having at least two dimensions;
B. determining a number of frequency intervals N to be used to construct said distribution of uown ultimate outcomes;
C. for each period I, constructing an aggregate distribution by:
(a) calculating period-to-period ratios of the data characteristics;
(b) identifing a range of ratio outcomes for cohort I;
(c) constructing subintervals for cohort I; and
(d) calculating all possible ratio outcomes for cohort I;
(e) inserting each outcome into the proper interval; and
D. constructing a convolution distribution of outcomes (said historically based frequency distribution of unknown ultimate outcomes) for all said possible ratio cohorts combined, by:
(a) selecting outcomes for any two cohorts A and B;
(b) constructing a new range of outcomes for the convolution distribution of cohorts A and B;
(c) constructing new subintervals for the convolution distribution of cohorts A and B;
(d) calculating the combined outcomes for the two cohorts A and B to provide a resulting convolution distribution; and
(e) combining the resulting convolution distribution with the distribution of outcomes for each remaining cohort by repeating each of the preceding acts D.(a) through D.(d) for each pair of cohorts.

2. The method of claim 1, in which N is a number of intervals required to meet a given level of error tolerance selected by a user.

3. The method of claim 1, in which N is a maximum number of intervals that can be calculated by a computer provided by a user in a given period of time.

4. The method of claim 1, futher comprising the acts of
(a) constructing convolution distributions for at least two separate groups of data using the method described in claim 1; and
(b) constructing a convolution distribution of such separate groups together.

5. A computer software system having a set of instructions for controlling a general purpose digital computer in performing a reserve measure function comprising: a set of instructions for:
A. receiving a set of data,
B. receiving a number of intervals N,
C. for each period I, constructing the aggregate distribution by:
(a) calculating the period-to-period ratios of the data;
(b) identifyg a range of ratio outcomes for cohort I;
(c) constructing subintervals for cohort I;
(d) calculating all possible ratio outcomes for cohort I;
(e) inserting each outcome into the proper interval; and
D. constructing a convolution distribution for all said possible ratio cohorts combined, by:
(a) selecting outcomes for any two cohorts A and B;
(b) constructing a new range of ratio outcomes for the convolution distribution of cohorts A and B;
(c) constructing new subintervals for the convolution distribution of cohorts A and B;
(d) calculating the combined possible ratio outcomes for the two cohorts A and B; and
(e) combining the resulting convolution distribution with the distribution of outcomes for each remaining cohort by repeating each of the preceding actions D.(a) through D.(d) for constructing a new convolution distribution.

6. The computer software system of claim 5, where N is a number of intervals required to meet a given level of error tolerance as determined by a user.

7. The computer software system of claim 5, further comprising a set of instructions for:
receiving an error tolerance ε selected by a user;
calculating the number of intervals N required to produce such level of error tolerance.

8. The computer software system of claim 5, in which N is a maximum number of intervals that can be calculated by the computer in a given period of time.

9. The computer software system of claim 5, in which a value for N is fixed in the instructions.

10. The computer software system of claim 5, in which N is a number selected by a user.

11. The computer software system of claim 5, in which the set of data is comprised of insured losses over a given period of years and for a given line of businesses.

12. A computer-readable medium storing instructions executable by a computer to cause the computer to perform a reserve measure process comprising:
A. receiving a set of data;
B. receiving a number of intervals N;
C. for each period I, constructing the aggregate distribution by:
(a) calculating the period-to-period ratios;
(b) identifying the range of outcomes for cohort I;
(c) constructing the subintervals for cohort I; and
(d) calculating all the different outcomes for cohort I
(e) inserting each outcome mto the proper interval; and
D. constructing a convolution distribution for all cohorts combined, by:
(a) selecting any two cohorts A and B
(b) constructing a new range of outcomes for the convolution distribution of cohorts A and B;
(c) constructing new subintervals for the convolution distribution of cohorts A and B;
(d) calculating the combined outcomes for the two cohorts A and B; and
(e) combining the resulting convolution distribution with the distribution of outcomes for each remaining cohort by repeating each of the preceding actions D.(a) through D.(d) for constructing a new convolution distribution.

13. The computer readable medium of instructions of claim 12, where N is the number of intervals required to meet a given level of error tolerance as determined by the user.

14. The computer readable medium of instructions of claim 12, further comprising a set of instructions for:
receiving an error tolerance ε selected by the user;
calculating the number of intervals N required to produce such level of error tolerance.

15. The computer readable medium of instructions of claim 12, in which N is the maximum number of intervals that can be calculated by the computer in a given period of time.

16. The computer readable medium of instructions of claim 12, in which a value for N is fixed in the instructions.

17. The computer readable medium of instructions of claim 12, in which N is a number selected by the user.

18. The computer readable medium of instructions of claim 12, in which the data set is comprised of insured losses over a given period of years and for a given line of businesses.

19. A method for constructing a historically based frequency distribution of insurance losses, the method comprising the following acts:
A. collection of relevant data about claims experience across a line of businesses, for a set of accident years;
B. determination of a number of intervals N to be used to construct said distribution of insurance losses;
C. for each accident year I in each line of business K, constructing the aggregate distribution by:
(a) calculating the period-to-period ratios;
(b) identifying the range of outcomes for accident year I;
(c) constructing the subintervals for accident year I;
(d) calculating all the different outcomes for accident year I
(e) inserting each outcome into the proper interval; and;
D. for each line of business K, constructing a convolution distribution for all accident years combined, by:
(a) selecting any two accident years A and B;
(b) constructing a new range of outcomes for the convolution distribution of accident years A and B;
(c) constructing new subintervals for the convolution distribution of accident years A and B;
(d) calculating the combined outcomes for the two accident years A and B;
(e) combining the resulting convolution distribution with the distribution of outcomes for each remaining accident year by repeating each of the preceding steps D.(a) through D.(d) for constructing a new convolution distribution; and
F. combining the resultant convolution distributions for all lines of business by
(a) selecting any two lines of business X and Y;
(b) constructing a new range of outcomes for the convolution distribution of lines of business X and Y;
(c) construcing new subintervals for the convolution distribution of lines of business X and Y;
(d) calculating the combined outcomes for the two lines of business X and Y; and
(e) combing the resulting convolution distribution with the disribution of outcomes for each remaining line of business by repeating each of the preceding steps F.(a) through F.(d) for constructing a new convolution distribution to produce a convolution distribution across all lines of business.

20. The method of claim 19, further comprising the following action: evaluating the actual insurance reserve based on the resulting convolution distribution.

21. The method of claim 20, further comprising the following action: adjusting the insurance reserve of the user based upon the comparison of the actual reserve to the convolution distribution.

22. The method of claim 19, further comprising the following action: selecting an insurance reserve based upon the resulting convolution distribution.
